(19) United States
(12) Patent Application Publication
(10) Pub. No.: US 2026/0304174 A1
(43) Pub. Date: Oct. 1, 2026

(54) Device Transmission for the Internet of Things

(71) Applicant: Comcast Cable Communications, LLC, Phiadelphia, PA (US)

(72) Inventors: Ryan Keating, Chicago, IL (US); Yunjung Yi, Vienna, VA (US); Esmael Hejazi Dinan, McLean, VA (US); Hyoungsuk Jeon, Centreville, VA (US); Muhammad Ali Kazmi, Reston, VA (US); Ali Cagatay Cirik, Chantilly, VA (US)

(21) Appl. No.: 19/629,498

(22) Filed: Mar. 26, 2026

Related U.S. Application Data
(60) Provisional application No. 63/777,873, filed on Mar. 26, 2025.

(51) Int. Cl. H04W 24/08

(52) U.S. Cl. CPC H04W 24/08

(57) ABSTRACT

An internet of things (IoT) device may communicate with a reader. The IoT device may transmit to the reader at or after a determined minimum time from an end of a received transmission from the reader. The IoT device may determine the minimum time between a reception and a transmission, for example, based on information received from the reader, such as message type, padding, and/or transmission size.

### CROSS-REFERENCE TO RELATED APPLICATIONS

This application claims the benefit of U.S. Provisional Application No. 63/777,873 filed on Mar. 26, 2025. The above-referenced application is hereby incorporated by reference in its entirety.

### BACKGROUND

An internet of things (IoT) device communicates with a reader. The IoT device receives information for communicating with the reader.

### SUMMARY

The following summary presents a simplified summary of certain features. The summary is not an extensive overview and is not intended to identify key or critical elements.

An IoT device may communicate with a reader. The IoT device may determine a minimum time duration for waiting to transmit to the reader after a reception from the reader. The IoT device may determine the minimum time duration, for example, based on an end of a payload, a number/quantity of padding chips, and/or a message type of the reception from the reader. For example, the IoT device may determine the number/quantity of padding chips based on a portion (e.g., clock acquisition part) of a preamble of the reception from the reader. For example, the IoT device may determine an end of the payload based on a size of the reception from the reader. The IoT device may transmit to the reader at or after the determined minimum time duration from an end of a transmission from the reader. By using a minimum time duration for transmission/reception between an IoT device and a reader in the manner described herein, advantages may be achieved such as reduced power consumption, reduced overhead, increased data rate, and/or increased efficiency in communications.

These and other features and advantages are described in greater detail below.

### BRIEF DESCRIPTION OF THE DRAWINGS

Examples of several of the various embodiments of the present disclosure are described herein with reference to the drawings.

FIG. 1A and FIG. 1B show example communication networks.

FIG. 2A shows an example user plane.

FIG. 2B shows an example control plane configuration.

FIG. 3 shows example of protocol layers.

FIG. 4A shows an example downlink data flow for a user plane configuration.

FIG. 4B shows an example format of a Medium Access Control (MAC) subheader in a MAC Protocol Data Unit (PDU).

FIG. 5A shows an example mapping for downlink channels.

FIG. 5B shows an example mapping for uplink channels.

FIG. 6 shows example radio resource control (RRC) states and RRC state transitions.

FIG. 7 shows an example configuration of a frame.

FIG. 8 shows an example resource configuration of one or more carriers.

FIG. 9 shows an example configuration of bandwidth parts (BWPs).

FIG. 10A shows example carrier aggregation configurations based on component carriers.

FIG. 10B shows example group of cells.

FIG. 11A shows an example mapping of one or more synchronization signal/physical broadcast channel (SS/PBCH) blocks.

FIG. 11B shows an example mapping of one or more channel state information reference signals (CSI-RSs).

FIG. 12A shows examples of downlink beam management procedures.

FIG. 12B shows examples of uplink beam management procedures.

FIG. 13A shows an example four-step random access procedure.

FIG. 13B shows an example two-step random access procedure.

FIG. 13C shows an example two-step random access procedure.

FIG. 14A shows an example of control resource set (CORESET) configurations.

FIG. 14B shows an example of a control channel element to resource element group (CCE-to-REG) mapping.

FIG. 15A shows an example of communications between a wireless device and a base station.

FIG. 15B shows example elements of a computing device that may be used to implement any of the various devices described herein

FIG. 16A, FIG. 16B, FIG. 16C, and FIG. 16D show examples of uplink and downlink signal transmission.

FIG. 17 shows an example of ambient internet-of-thing (A-IoT) communications.

FIG. 18 shows an example of A-IoT device architecture.

FIG. 19 shows an example of A-IoT device architecture.

FIG. 20 shows an example of A-IoT device architecture.

FIG. 21A shows an example of an A-IoT direct network communication.

FIG. 21B shows an example of an A-IoT device communication comprising an indirect link.

FIG. 21C shows an example of an A-IoT device communication comprising an indirect link.

FIG. 21D shows an example of an A-IoT device communication comprising an indirect link.

FIG. 21E shows an example of an A-IoT direct communication.

FIG. 22 shows an example procedure.

FIG. 23 shows an example procedure.

FIG. 24 shows an example procedure.

FIG. 25 shows an example of an A-IoT device switching between two modes.

FIG. 26 shows an example of an access procedure.

FIG. 27 shows an example of multiple options for A-IoT transmission.

FIG. 28 shows an example of a reader to device (R2D) transmission aligning with an OFDM symbol boundary.

FIG. 29 shows an example R2D transmission.

FIG. 30 shows an example of an R2D transmission and a subsequent a device to reader (D2R) transmission.

FIG. 31 shows an example of an R2D transmission and a subsequent D2R transmission.

FIG. 32 shows an example method of an D2R transmission.

FIG. 33 shows an example method of an D2R reception.

FIG. 34 shows an example method of an D2R transmission.

### DETAILED DESCRIPTION

The accompanying drawings and descriptions provide examples. It is to be understood that the examples shown in the drawings and/or described are non-exclusive, and that features shown and described may be practiced in other examples. Examples are provided for operation of wireless communication systems.

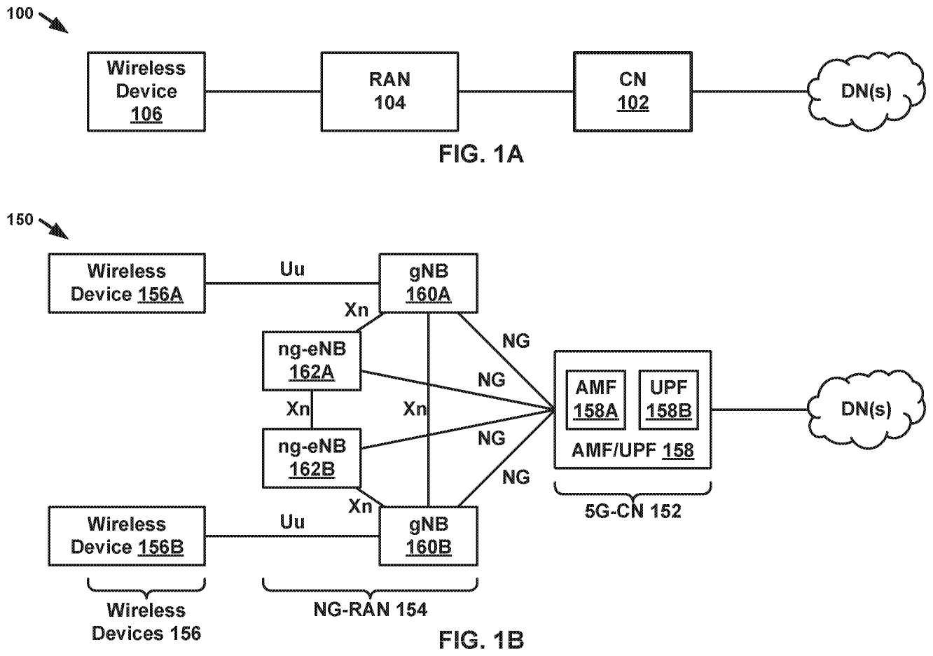

FIG. 1A shows an example communication network 100. The communication network 100 may comprise a mobile communication network). The communication network 100 may comprise, for example, a public land mobile network (PLMN) operated/managed/run by a network operator. The communication network 100 may comprise one or more of a core network (CN) 102, a radio access network (RAN) 104, and/or a wireless device 106. The communication network 100 may comprise, and/or a device within the communication network 100 may communicate with (e.g., via CN 102), one or more data networks (DN(s)) 108. The wireless device 106 may communicate with one or more DNs 108, such as public DNS (e.g., the Internet), private DNs, and/or intra-operator DNs. The wireless device 106 may communicate with the one or more DNs 108 via the RAN 104 and/or via the CN 102. The CN 102 may provide/configure the wireless device 106 with one or more interfaces to the one or more DNs 108. As part of the interface functionality, the CN 102 may set up end-to-end connections between the wireless device 106 and the one or more DNs 108, authenticate the wireless device 106, provide/configure charging functionality, etc.

The wireless device 106 may communicate with the RAN 104 via radio communications over an air interface. The RAN 104 may communicate with the CN 102 via various communications (e.g., wired communications and/or wireless communications). The wireless device 106 may establish a connection with the CN 102 via the RAN 104. The RAN 104 may provide/configure scheduling, radio resource management, and/or retransmission protocols, for example, as part of the radio communications. The communication direction from the RAN 104 to the wireless device 106 over/via the air interface may be referred to as the downlink and/or downlink communication direction. The communication direction from the wireless device 106 to the RAN 104 over/via the air interface may be referred to as the uplink and/or uplink communication direction. Downlink transmissions may be separated and/or distinguished from uplink transmissions, for example, based on at least one of: frequency division duplexing (FDD), time-division duplexing (TDD), any other duplexing schemes, and/or one or more combinations thereof.

As used throughout, the term “wireless device” may comprise one or more of: a mobile device, a fixed (e.g., non-mobile) device for which wireless communication is configured or usable, a computing device, a node, a device capable of wirelessly communicating, or any other device capable of sending and/or receiving signals. As non-limiting examples, a wireless device may comprise, for example: a telephone, a cellular phone, a Wi-Fi phone, a smartphone, a tablet, a computer, a laptop, a sensor, a meter, a wearable device, an Internet of Things (IoT) device, a hotspot, a cellular repeater, a vehicle roadside unit (RSU), a relay node, an automobile, a wireless user device (e.g., user equipment (UE), a user terminal (UT), etc.), an access terminal (AT), a mobile station, a handset, a wireless transmit and receive unit (WTRU), a wireless communication device, and/or any combination thereof.

The RAN 104 may comprise one or more base stations (not shown). As used throughout, the term “base station” may comprise one or more of: a base station, a node, a Node B (NB), an evolved NodeB (eNB), a gNB, an ng-eNB, a relay node (e.g., an integrated access and backhaul (IAB) node), a donor node (e.g., a donor eNB, a donor gNB, etc.), an access point (e.g., a Wi-Fi access point), a transmission and reception point (TRP), a computing device, a device capable of wirelessly communicating, or any other device capable of sending and/or receiving signals. A base station may comprise one or more of each element listed above. For example, a base station may comprise one or more TRPs. As other non-limiting examples, a base station may comprise for example, one or more of: a Node B (e.g., associated with Universal Mobile Telecommunications System (UMTS) and/or third-generation (3G) standards), an Evolved Node B (eNB) (e.g., associated with Evolved-Universal Terrestrial Radio Access (E-UTRA) and/or fourth-generation (4G) standards), a remote radio head (RRH), a baseband processing unit coupled to one or more remote radio heads (RRHs), a repeater node or relay node used to extend the coverage area of a donor node, a Next Generation Evolved Node B (ng-eNB), a Generation Node B (gNB) (e.g., associated with NR and/or fifth-generation (5G) standards), an access point (AP) (e.g., associated with, for example, Wi-Fi or any other suitable wireless communication standard), any other generation base station, and/or any combination thereof. A base station may comprise one or more devices, such as at least one base station central device (e.g., a gNB Central Unit (gNB-CU)) and at least one base station distributed device (e.g., a gNB Distributed Unit (gNB-DU)).

A base station (e.g., in the RAN 104) may comprise one or more sets of antennas for communicating with the wireless device 106 wirelessly (e.g., via an over the air interface). One or more base stations may comprise sets (e.g., three sets or any other quantity of sets) of antennas to respectively control multiple cells or sectors (e.g., three cells, three sectors, any other quantity of cells, or any other quantity of sectors). The size of a cell may be determined by a range at which a receiver (e.g., a base station receiver) may successfully receive transmissions from a transmitter (e.g., a wireless device transmitter) operating in the cell. One or more cells of base stations (e.g., by alone or in combination with other cells) may provide/configure a radio coverage to the wireless device 106 over a wide geographic area to support wireless device mobility. A base station comprising three sectors (e.g., or n-sector, where n refers to any quantity n) may be referred to as a three-sector site (e.g., or an n-sector site) or a three-sector base station (e.g., an n-sector base station).

One or more base stations (e.g., in the RAN 104) may be implemented as a sectored site with more or less than three sectors. One or more base stations of the RAN 104 may be implemented as an access point, as a baseband processing device/unit coupled to several RRHs, and/or as a repeater or relay node used to extend the coverage area of a node (e.g., a donor node). A baseband processing device/unit coupled to RRHs may be part of a centralized or cloud RAN architecture, for example, where the baseband processing device/unit may be centralized in a pool of baseband processing devices/units or virtualized. A repeater node may amplify and send (e.g., transmit, retransmit, rebroadcast, etc.) a radio signal received from a donor node. A relay node may perform the substantially the same/similar functions as a repeater node. The relay node may decode the radio signal received from the donor node, for example, to remove noise before amplifying and sending the radio signal.

The RAN 104 may be deployed as a homogenous network of base stations (e.g., macrocell base stations) that have similar antenna patterns and/or similar high-level transmit powers. The RAN 104 may be deployed as a heterogeneous network of base stations (e.g., different base stations that have different antenna patterns). In heterogeneous networks, small cell base stations may be used to provide/configure small coverage areas, for example, coverage areas that overlap with comparatively larger coverage areas provided/configured by other base stations (e.g., macrocell base stations). The small coverage areas may be provided/configured in areas with high data traffic (or so-called “hotspots”) or in areas with a weak macrocell coverage. Examples of small cell base stations may comprise, in order of decreasing coverage area, microcell base stations, picocell base stations, and femtocell base stations or home base stations.

Examples described herein may be used in a variety of types of communications. For example, communications may be in accordance with the Third-Generation Partnership Project (3GPP) (e.g., one or more network elements similar to those of the communication network 100), communications in accordance with Institute of Electrical and Electronics Engineers (IEEE), communications in accordance with International Telecommunication Union (ITU), communications in accordance with International Organization for Standardization (ISO), etc. The 3GPP has produced specifications for multiple generations of mobile networks: a 3G network known as UMTS, a 4G network known as Long-Term Evolution (LTE) and LTE Advanced (LTE-A), and a 5G network known as 5G System (5GS) and NR system. 3GPP may produce specifications for additional generations of communication networks (e.g., 6G and/or any other generation of communication network). Examples may be described with reference to one or more elements (e.g., the RAN) of a 3GPP 5G network, referred to as a next-generation RAN (NG-RAN), or any other communication network, such as a 3GPP network and/or a non-3GPP network. Examples described herein may be applicable to other communication networks, such as 3G and/or 4G networks, and communication networks that may not yet be finalized/specified (e.g., a 3GPP 6G network), satellite communication networks, and/or any other communication network. NG-RAN implements and updates 5G radio access technology referred to as NR and may be provisioned to implement 4G radio access technology and/or other radio access technologies, such as other 3GPP and/or non-3GPP radio access technologies.

FIG. 1B shows an example communication network 150. The communication network may comprise a mobile communication network. The communication network 150 may comprise, for example, a PLMN operated/managed/run by a network operator. The communication network 150 may comprise one or more of: a CN 152 (e.g., a 5G core network (5G-CN)), a RAN 154 (e.g., an NG-RAN), and/or wireless devices 156A and 156B (collectively wireless device(s) 156). The communication network 150 may comprise, and/or a device within the communication network 150 may communicate with (e.g., via CN 152), one or more data networks (DN(s)) 170. These components may be implemented and operate in substantially the same or similar manner as corresponding components described with respect to FIG. 1A.

The CN 152 (e.g., 5G-CN) may provide/configure the wireless device(s) 156 with one or more interfaces to one or more DNs 170, such as public DNS (e.g., the Internet), private DNS, and/or intra-operator DNs. As part of the interface functionality, the CN 152 (e.g., 5G-CN) may set up end-to-end connections between the wireless device(s) 156 and the one or more DNs, authenticate the wireless device(s) 156, and/or provide/configure charging functionality. The CN 152 (e.g., the 5G-CN) may be a service-based architecture, which may differ from other CNs (e.g., such as a 3GPP 4G CN). The architecture of nodes of the CN 152 (e.g., 5G-CN) may be defined as network functions that offer services via interfaces to other network functions. The network functions of the CN 152 (e.g., 5G CN) may be implemented in several ways, for example, as network elements on dedicated or shared hardware, as software instances running on dedicated or shared hardware, and/or as virtualized functions instantiated on a platform (e.g., a cloud-based platform).

The CN 152 (e.g., 5G-CN) may comprise an Access and Mobility Management Function (AMF) device 158A and/or a User Plane Function (UPF) device 158B, which may be separate components or one component AMF/UPF device 158. The UPF device 158B may serve as a gateway between a RAN 154 (e.g., NG-RAN) and the one or more DNs 170. The UPF device 158B may perform functions, such as: packet routing and forwarding, packet inspection and user plane policy rule enforcement, traffic usage reporting, uplink classification to support routing of traffic flows to the one or more DNs 170, quality of service (QoS) handling for the user plane (e.g., packet filtering, gating, uplink/downlink rate enforcement, and uplink traffic verification), downlink packet buffering, and/or downlink data notification triggering. The UPF device 158B may serve as an anchor point for intra-/inter-Radio Access Technology (RAT) mobility, an external protocol (or packet) data unit (PDU) session point of interconnect to the one or more DNs, and/or a branching point to support a multi-homed PDU session. The wireless device(s) 156 may be configured to receive services via a PDU session, which may be a logical connection between a wireless device and a DN.

The AMF device 158A may perform functions, such as: Non-Access Stratum (NAS) signaling termination, NAS signaling security, Access Stratum (AS) security control, inter-CN node signaling for mobility between access networks (e.g., 3GPP access networks and/or non-3GPP networks), idle mode wireless device reachability (e.g., idle mode user equipment (UE) reachability for control and execution of paging retransmission), registration area management, intra-system and inter-system mobility support, access authentication, access authorization including checking of roaming rights, mobility management control (e.g., subscription and policies), network slicing support, and/or session management function (SMF) selection. NAS may refer to the functionality operating between a CN and a wireless device, and AS may refer to the functionality operating between a wireless device and a RAN.

The CN 152 (e.g., 5G-CN) may comprise one or more additional network functions that may not be shown in FIG. 1B. The CN 152 (e.g., 5G-CN) may comprise one or more devices implementing at least one of: a Session Management Function (SMF), an NR Repository Function (NRF), a Policy Control Function (PCF), a Network Exposure Function (NEF), a Unified Data Management (UDM), an Application Function (AF), an Authentication Server Function (AUSF), and/or any other function.

The RAN 154 (e.g., NG-RAN) may communicate with the wireless device(s) 156 via radio communications (e.g., an over the air interface). The wireless device(s) 156 may communicate with the CN 152 via the RAN 154. The RAN 154 (e.g., NG-RAN) may comprise one or more first-type base stations (e.g., gNBs comprising a gNB 160A and a gNB 160B (collectively gNBs 160)) and/or one or more second-type base stations (e.g., ng eNBs comprising an ng-eNB 162A and an ng-eNB 162B (collectively ng eNBs 162)). The RAN 154 may comprise one or more of any quantity of types of base station. The gNBs 160 and ng eNBs 162 may be referred to as base stations. The base stations (e.g., the gNBs 160 and ng eNBs 162) may comprise one or more sets of antennas for communicating with the wireless device(s) 156 wirelessly (e.g., an over an air interface). One or more base stations (e.g., the gNBs 160 and/or the ng eNBs 162) may comprise multiple sets of antennas to respectively control multiple cells (or sectors). The cells of the base stations (e.g., the gNBs 160 and the ng-eNBs 162) may provide a radio coverage to the wireless device(s) 156 over a wide geographic area to support wireless device mobility.

The base stations (e.g., the gNBs 160 and/or the ng-eNBs 162) may be connected to the CN 152 (e.g., 5G CN) via a first interface (e.g., an NG interface) and to other base stations via a second interface (e.g., an Xn interface). The NG and Xn interfaces may be established using direct physical connections and/or indirect connections over an underlying transport network, such as an internet protocol (IP) transport network. The base stations (e.g., the gNBs 160 and/or the ng-eNBs 162) may communicate with the wireless device(s) 156 via a third interface (e.g., a Uu interface). A base station (e.g., the gNB 160A) may communicate with the wireless device 156A via a Uu interface. The NG, Xn, and Uu interfaces may be associated with a protocol stack. The protocol stacks associated with the interfaces may be used by the network elements shown in FIG. 1B to exchange data and signaling messages. The protocol stacks may comprise two planes: a user plane and a control plane. Any other quantity of planes may be used (e.g., in a protocol stack). The user plane may handle data of interest to a user. The control plane may handle signaling messages of interest to the network elements.

One or more base stations (e.g., the gNBs 160 and/or the ng-eNBs 162) may communicate with one or more AMF/UPF devices, such as the AMF/UPF 158, via one or more interfaces (e.g., NG interfaces). A base station (e.g., the gNB 160A) may be in communication with, and/or connected to, the UPF 158B of the AMF/UPF 158 via an NG-User plane (NG-U) interface. The NG-U interface may provide/perform delivery (e.g., non-guaranteed delivery) of user plane PDUs between a base station (e.g., the gNB 160A) and a UPF device (e.g., the UPF 158B). The base station (e.g., the gNB 160A) may be in communication with, and/or connected to, an AMF device (e.g., the AMF 158A) via an NG-Control plane (NG-C) interface. The NG-C interface may provide/perform, for example, NG interface management, wireless device context management (e.g., UE context management), wireless device mobility management (e.g., UE mobility management), transport of NAS messages, paging, PDU session management, configuration transfer, and/or warning message transmission.

A wireless device may access the base station, via an interface (e.g., Uu interface), for the user plane configuration and the control plane configuration. The base stations (e.g., gNBs 160) may provide user plane and control plane protocol terminations towards the wireless device(s) 156 via the Uu interface. A base station (e.g., the gNB 160A) may provide user plane and control plane protocol terminations toward the wireless device 156A over a Uu interface associated with a first protocol stack. A base station (e.g., the ng-eNBs 162) may provide Evolved UMTS Terrestrial Radio Access (E UTRA) user plane and control plane protocol terminations towards the wireless device(s) 156 via a Uu interface (e.g., where E UTRA may refer to the 3GPP 4G radio-access technology). A base station (e.g., the ng-eNB 162B) may provide E UTRA user plane and control plane protocol terminations towards the wireless device 156B via a Uu interface associated with a second protocol stack. The user plane and control plane protocol terminations may comprise, for example, NR user plane and control plane protocol terminations, 4G user plane and control plane protocol terminations, etc.

The CN 152 (e.g., 5G-CN) may be configured to handle one or more radio accesses (e.g., NR, 4G, and/or any other radio accesses). It may also be possible for an NR network/device (or any first network/device) to connect to a 4G core network/device (or any second network/device) in a non-standalone mode (e.g., non-standalone operation). In a non-standalone mode/operation, a 4G core network may be used to provide (or at least support) control-plane functionality (e.g., initial access, mobility, and/or paging). Although only one AMF/UPF 158 is shown in FIG. 1B, one or more base stations (e.g., one or more gNBs and/or one or more ng-eNBs) may be connected to multiple AMF/UPF nodes, for example, to provide redundancy and/or to load share across the multiple AMF/UPF nodes.

An interface (e.g., Uu, Xn, and/or NG interfaces) between network elements (e.g., the network elements shown in FIG. 1B) may be associated with a protocol stack that the network elements may use to exchange data and signaling messages. A protocol stack may comprise two planes: a user plane and a control plane. Any other quantity of planes may be used (e.g., in a protocol stack). The user plane may handle data associated with a user (e.g., data of interest to a user). The control plane may handle data associated with one or more network elements (e.g., signaling messages of interest to the network elements).

The communication network 100 in FIG. 1A and/or the communication network 150 in FIG. 1B may comprise any quantity/number and/or type of devices, such as, for example, computing devices, wireless devices, mobile devices, handsets, tablets, laptops, internet of things (IoT) devices, hotspots, cellular repeaters, computing devices, and/or, more generally, user equipment (e.g., UE). Although one or more of the above types of devices may be referenced herein (e.g., UE, wireless device, computing device, etc.), it should be understood that any device herein may comprise any one or more of the above types of devices or similar devices. The communication network, and any other network referenced herein, may comprise an LTE network, a 5G network, a satellite network, and/or any other network for wireless communications (e.g., any 3GPP network and/or any non-3GPP network). Apparatuses, systems, and/or methods described herein may generally be described as implemented on one or more devices (e.g., wireless device, base station, eNB, gNB, computing device, etc.), in one or more networks, but it will be understood that one or more features and steps may be implemented on any device and/or in any network.

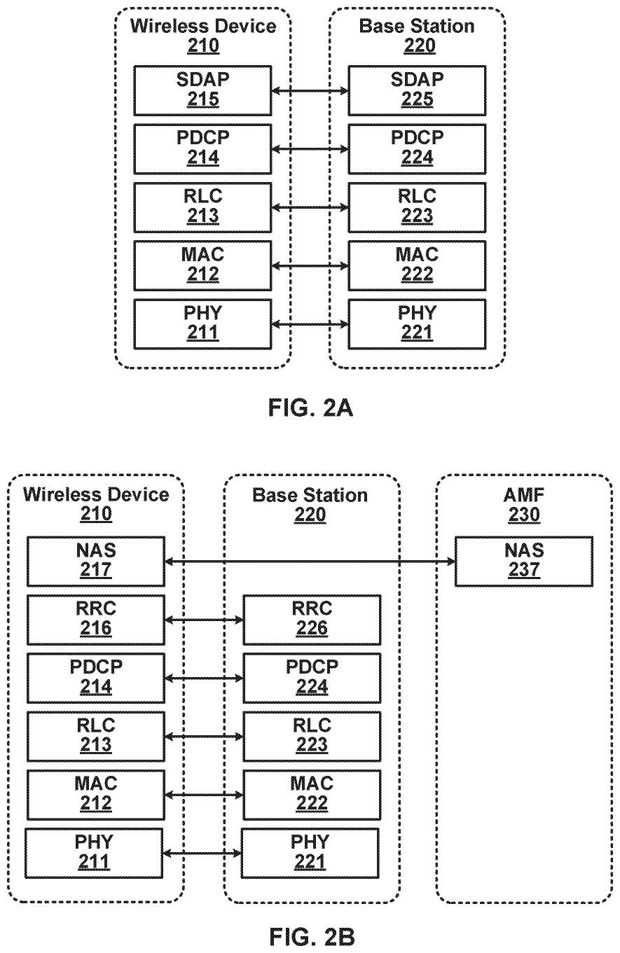

FIG. 2A shows an example user plane configuration. The user plane configuration may comprise, for example, an NR user plane protocol stack. FIG. 2B shows an example control plane configuration. The control plane configuration may comprise, for example, an NR control plane protocol stack. One or more of the user plane configuration and/or the control plane configuration may use a Uu interface that may be between a wireless device 210 and a base station 220. The protocol stacks shown in FIG. 2A and FIG. 2B may be substantially the same or similar to those used for the Uu interface between, for example, the wireless device 156A and the base station 160A shown in FIG. 1B.

A user plane configuration (e.g., an NR user plane protocol stack) may comprise multiple layers (e.g., five layers or any other quantity of layers) implemented in the wireless device 210 and the base station 220 (e.g., as shown in FIG. 2A). At the bottom of the protocol stack, physical layers (PHYs) 211 and 221 may provide transport services to the higher layers of the protocol stack and may correspond to layer 1 of the Open Systems Interconnection (OSI) model. The protocol layers above PHY 211 may comprise a medium access control layer (MAC) 212, a radio link control layer (RLC) 213, a packet data convergence protocol layer (PDCP) 214, and/or a service data application protocol layer (SDAP) 215. The protocol layers above PHY 221 may comprise a medium access control layer (MAC) 222, a radio link control layer (RLC) 223, a packet data convergence protocol layer (PDCP) 224, and/or a service data application protocol layer (SDAP) 225. One or more of the four protocol layers above PHY 211 may correspond to layer 2, or the data link layer, of the OSI model. One or more of the four protocol layers above PHY 221 may correspond to layer 2, or the data link layer, of the OSI model.

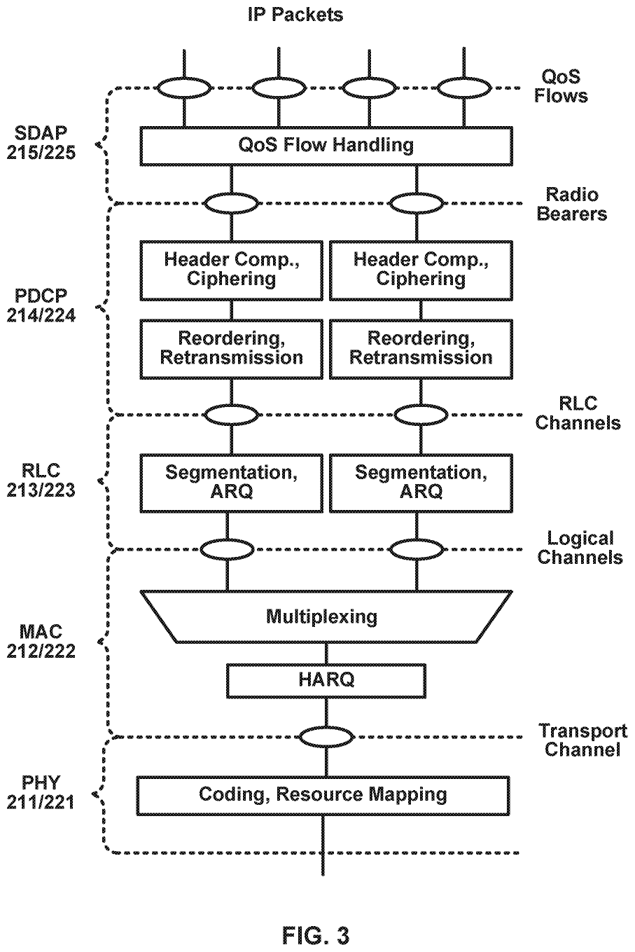

FIG. 3 shows an example of protocol layers. The protocol layers may comprise, for example, protocol layers of the NR user plane protocol stack. One or more services may be provided between protocol layers. SDAPs (e.g., SDAPS 215 and 225 shown in FIG. 2A and FIG. 3) may perform Quality of Service (QoS) flow handling. A wireless device (e.g., the wireless devices 106, 156A, 156B, and 210) may receive services through/via a PDU session, which may be a logical connection between the wireless device and a DN. The PDU session may have one or more QoS flows 310. A UPF (e.g., the UPF 158B) of a CN may map IP packets to the one or more QoS flows of the PDU session, for example, based on one or more QoS requirements (e.g., in terms of delay, data rate, error rate, and/or any other quality/service requirement). The SDAPs 215 and 225 may perform mapping/de-mapping between the one or more QoS flows 310 and one or more radio bearers 320 (e.g., data radio bearers). The mapping/de-mapping between the one or more QoS flows 310 and the radio bearers 320 may be determined by the SDAP 225 of the base station 220. The SDAP 215 of the wireless device 210 may be informed of the mapping between the QoS flows 310 and the radio bearers 320 via reflective mapping and/or control signaling received from the base station 220. For reflective mapping, the SDAP 225 of the base station 220 may mark the downlink packets with a QoS flow indicator (QFI), which may be monitored/detected/identified/indicated/observed by the SDAP 215 of the wireless device 210 to determine the mapping/de-mapping between the one or more QoS flows 310 and the radio bearers 320.

PDCPs (e.g., the PDCPs 214 and 224 shown in FIG. 2A and FIG. 3) may perform header compression/decompression, for example, to reduce the amount of data that may need to be transmitted (e.g., sent) over the air interface, ciphering/deciphering to prevent unauthorized decoding of data transmitted (e.g., sent) over the air interface, and/or integrity protection (e.g., to ensure control messages originate from intended sources). The PDCPs 214 and 224 may perform retransmissions of undelivered packets, in-sequence delivery and reordering of packets, and/or removal of packets received in duplicate due to, for example, a handover (e.g., an intra-gNB handover). The PDCPs 214 and 224 may perform packet duplication, for example, to improve the likelihood of the packet being received. A receiver may receive the packet in duplicate and may remove any duplicate packets. Packet duplication may be useful for certain services, such as services that require high reliability.

The PDCP layers (e.g., PDCPs 214 and 224) may perform mapping/de-mapping between a split radio bearer and RLC channels (e.g., RLC channels 330) (e.g., in a dual connectivity scenario/configuration). Dual connectivity may refer to a technique that allows a wireless device to communicate with multiple cells (e.g., two cells) or, more generally, multiple cell groups comprising: a master cell group (MCG) and a secondary cell group (SCG). A split bearer may be configured and/or used, for example, if a single radio bearer (e.g., such as one of the radio bearers provided/configured by the PDCPs 214 and 224 as a service to the SDAPs 215 and 225) is handled by cell groups in dual connectivity. The PDCPs 214 and 224 may map/de-map between the split radio bearer and RLC channels 330 belonging to the cell groups.

RLC layers (e.g., RLCs 213 and 223) may perform segmentation, retransmission via Automatic Repeat Request (ARQ), and/or removal of duplicate data units received from MAC layers (e.g., MACs 212 and 222, respectively). The RLC layers (e.g., RLCs 213 and 223) may support multiple transmission modes (e.g., three transmission modes: transparent mode (TM); unacknowledged mode (UM); and acknowledged mode (AM)). The RLC layers may perform one or more of the noted functions, for example, based on the transmission mode an RLC layer is operating. The RLC configuration may be per logical channel. The RLC configuration may not depend on numerologies and/or Transmission Time Interval (TTI) durations (or other durations). The RLC layers (e.g., RLCs 213 and 223) may provide/configure RLC channels as a service to the PDCP layers (e.g., PDCPs 214 and 224, respectively), such as shown in FIG. 3.

The MAC layers (e.g., MACs 212 and 222) may perform multiplexing/demultiplexing of logical channels and/or mapping between logical channels and transport channels. The multiplexing/demultiplexing may comprise multiplexing/demultiplexing of data units/data portions, belonging to the one or more logical channels, into/from Transport Blocks (TBs) delivered to/from the PHY layers (e.g., PHYs 211 and 221, respectively). The MAC layer of a base station (e.g., MAC 222) may be configured to perform scheduling, scheduling information reporting, and/or priority handling between wireless devices via dynamic scheduling. Scheduling may be performed by a base station (e.g., the base station 220 at the MAC 222) for downlink/or and uplink. The MAC layers (e.g., MACs 212 and 222) may be configured to perform error correction(s) via Hybrid Automatic Repeat Request (HARQ) (e.g., one HARQ entity per carrier in case of Carrier Aggregation (CA)), priority handling between logical channels of the wireless device 210 via logical channel prioritization and/or padding. The MAC layers (e.g., MACs 212 and 222) may support one or more numerologies and/or transmission timings. Mapping restrictions in a logical channel prioritization may control which numerology and/or transmission timing a logical channel may use. The MAC layers (e.g., the MACs 212 and 222) may provide/configure logical channels 340 as a service to the RLC layers (e.g., the RLCs 213 and 223).

The PHY layers (e.g., PHYs 211 and 221) may perform mapping of transport channels to physical channels and/or digital and analog signal processing functions, for example, for sending and/or receiving information (e.g., via an over the air interface). The digital and/or analog signal processing functions may comprise, for example, coding/decoding and/or modulation/demodulation. The PHY layers (e.g., PHYs 211 and 221) may perform multi-antenna mapping. The PHY layers (e.g., the PHYs 211 and 221) may provide/configure one or more transport channels (e.g., transport channels 350) as a service to the MAC layers (e.g., the MACs 212 and 222, respectively).

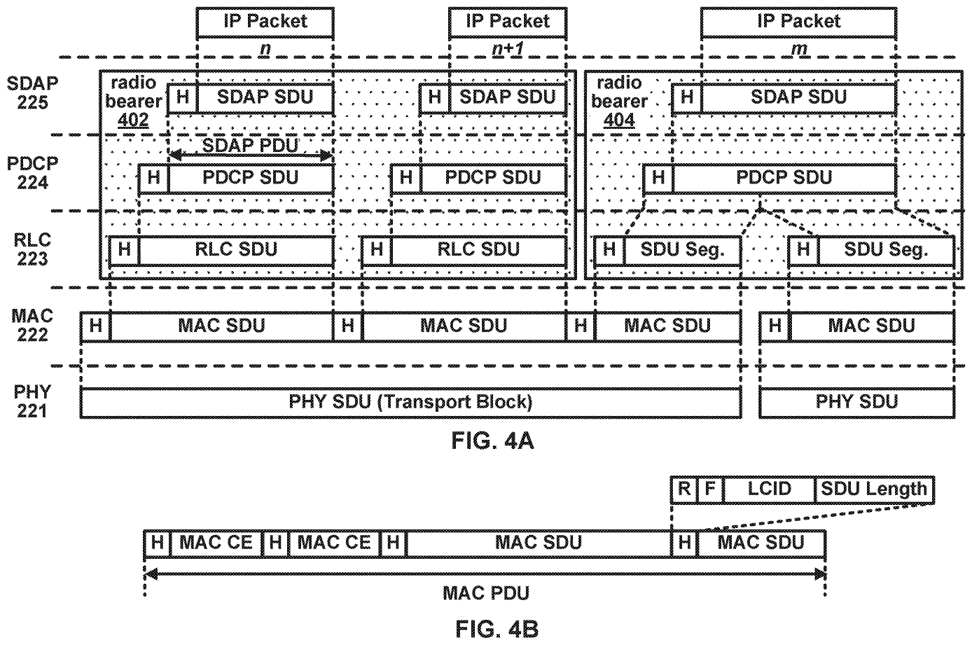

FIG. 4A shows an example downlink data flow for a user plane configuration. The user plane configuration may comprise, for example, the NR user plane protocol stack shown in FIG. 2A. One or more TBs may be generated, for example, based on a data flow via a user plane protocol stack. As shown in FIG. 4A, a downlink data flow of three IP packets (n, n+1, and m) via the NR user plane protocol stack may generate two TBs (e.g., at the base station 220). An uplink data flow via the NR user plane protocol stack may be similar to the downlink data flow shown in FIG. 4A. The three IP packets (n, n+1, and m) may be determined from the two TBs, for example, based on the uplink data flow via an NR user plane protocol stack. A first quantity of packets (e.g., three or any other quantity) may be determined from a second quantity of TBs (e.g., two or another quantity).

The downlink data flow may begin, for example, if the SDAP 225 receives the three IP packets (or other quantity of IP packets) from one or more QoS flows and maps the three packets (or other quantity of packets) to radio bearers (e.g., radio bearers 402 and 404). The SDAP 225 may map the IP packets n and n+1 to a first radio bearer 402 and map the IP packet m to a second radio bearer 404. An SDAP header (labeled with “H” preceding each SDAP SDU shown in FIG. 4A) may be added to an IP packet to generate an SDAP PDU, which may be referred to as a PDCP SDU. The data unit transferred from/to a higher protocol layer may be referred to as a service data unit (SDU) of the lower protocol layer, and the data unit transferred to/from a lower protocol layer may be referred to as a protocol data unit (PDU) of the higher protocol layer. As shown in FIG. 4A, the data unit from the SDAP 225 may be an SDU of lower protocol layer PDCP 224 (e.g., PDCP SDU) and may be a PDU of the SDAP 225 (e.g., SDAP PDU).

Each protocol layer (e.g., protocol layers shown in FIG. 4A) or at least some protocol layers may: perform its own function(s) (e.g., one or more functions of each protocol layer described with respect to FIG. 3), add a corresponding header, and/or forward a respective output to the next lower layer (e.g., its respective lower layer). The PDCP 224 may perform an IP-header compression and/or ciphering. The PDCP 224 may forward its output (e.g., a PDCP PDU, which is an RLC SDU) to the RLC 223. The RLC 223 may optionally perform segmentation (e.g., as shown for IP packet m in FIG. 4A). The RLC 223 may forward its outputs (e.g., two RLC PDUs, which are two MAC SDUs, generated by adding respective subheaders to two SDU segments (SDU Segs)) to the MAC 222. The MAC 222 may multiplex a quantity/number of RLC PDUs (MAC SDUs). The MAC 222 may attach a MAC subheader to an RLC PDU (MAC SDU) to form a TB. The MAC subheaders may be distributed across the MAC PDU (e.g., in an NR configuration as shown in FIG. 4A). The MAC subheaders may be entirely located at the beginning of a MAC PDU (e.g., in an LTE configuration). The NR MAC PDU structure may reduce a processing time and/or associated latency, for example, if the MAC PDU subheaders are computed before assembling the full MAC PDU.

FIG. 4B shows an example format of a MAC subheader in a MAC PDU. A MAC PDU may comprise a MAC subheader (H) and a MAC SDU. Each of one or more MAC subheaders may comprise an SDU length field for indicating the length (e.g., in bytes) of the MAC SDU to which the MAC subheader corresponds; a logical channel identifier (LCID) field for identifying/indicating the logical channel from which the MAC SDU originated to aid in the demultiplexing process; a flag (F) for indicating the size of the SDU length field; and a reserved bit (R) field for future use.

One or more MAC control elements (CEs) may be added to, or inserted into, the MAC PDU by a MAC layer, such as MAC 223 or MAC 222. As shown in FIG. 4B, two MAC CEs may be inserted/added before two MAC PDUs. The MAC CEs may be inserted/added at the beginning of a MAC PDU for downlink transmissions (as shown in FIG. 4B). One or more MAC CEs may be inserted/added at the end of a MAC PDU for uplink transmissions. MAC CEs may be used for in band control signaling. Example MAC CEs may comprise scheduling-related MAC CEs, such as buffer status reports and power headroom reports; activation/deactivation MAC CEs (e.g., MAC CEs for activation/deactivation of PDCP duplication detection, channel state information (CSI) reporting, sounding reference signal (SRS) transmission, and prior configured components); discontinuous reception (DRX)-related MAC CEs; timing advance MAC CEs; and random access-related MAC CEs. A MAC CE may be preceded by a MAC subheader with a similar format as described for the MAC subheader for MAC SDUs and may be identified with a reserved value in the LCID field that indicates the type of control information included in the corresponding MAC CE.

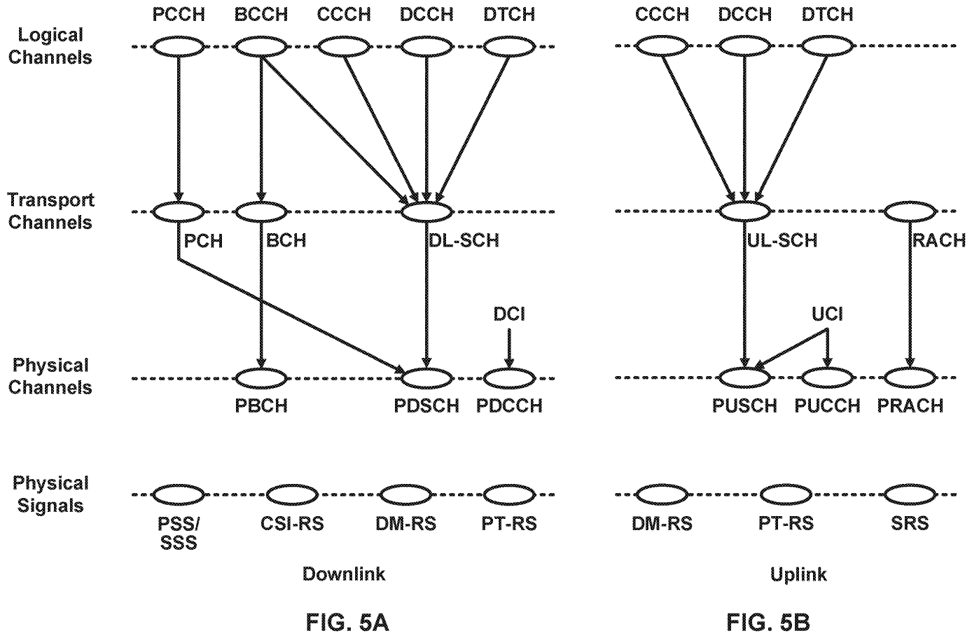

FIG. 5A shows an example mapping for downlink channels. The mapping for uplink channels may comprise mapping between channels (e.g., logical channels, transport channels, and physical channels) for downlink. FIG. 5B shows an example mapping for uplink channels. The mapping for uplink channels may comprise mapping between channels (e.g., logical channels, transport channels, and physical channels) for uplink. Information may be passed through/via channels between the RLC, the MAC, and the PHY layers of a protocol stack (e.g., the NR protocol stack). A logical channel may be used between the RLC and the MAC layers. The logical channel may be classified/indicated as a control channel that may carry control and/or configuration information (e.g., in the NR control plane), or as a traffic channel that may carry data (e.g., in the NR user plane). A logical channel may be classified/indicated as a dedicated logical channel that may be dedicated to a specific wireless device, and/or as a common logical channel that may be used by more than one wireless device (e.g., a group of wireless devices).

A logical channel may be defined by the type of information it carries. The set of logical channels (e.g., in an NR configuration) may comprise one or more channels described below. A paging control channel (PCCH) may comprise/carry one or more paging messages used to page a wireless device whose location is not known to the network on a cell level. A broadcast control channel (BCCH) may comprise/carry system information messages in the form of a master information block (MIB) and several system information blocks (SIBs). The system information messages may be used by wireless devices to obtain information about how a cell is configured and how to operate within the cell. A common control channel (CCCH) may comprise/carry control messages together with random access. A dedicated control channel (DCCH) may comprise/carry control messages to/from a specific wireless device to configure the wireless device with configuration information. A dedicated traffic channel (DTCH) may comprise/carry user data to/from a specific wireless device.

Transport channels may be used between the MAC and PHY layers. Transport channels may be defined by how the information they carry is sent/transmitted (e.g., via an over the air interface). The set of transport channels (e.g., that may be defined by an NR configuration or any other configuration) may comprise one or more of the following channels. A paging channel (PCH) may comprise/carry paging messages that originated from the PCCH. A broadcast channel (BCH) may comprise/carry the MIB from the BCCH. A downlink shared channel (DL-SCH) may comprise/carry downlink data and signaling messages, including the SIBs from the BCCH. An uplink shared channel (UL-SCH) may comprise/carry uplink data and signaling messages. A random access channel (RACH) may provide a wireless device with an access to the network without any prior scheduling.

The PHY layer may use physical channels to pass/transfer information between processing levels of the PHY layer. A physical channel may have an associated set of time-frequency resources for carrying the information of one or more transport channels. The PHY layer may generate control information to support the low-level operation of the PHY layer. The PHY layer may provide/transfer the control information to the lower levels of the PHY layer via physical control channels (e.g., referred to as L1/L2 control channels). The set of physical channels and physical control channels (e.g., that may be defined by an NR configuration or any other configuration) may comprise one or more of the following channels. A physical broadcast channel (PBCH) may comprise/carry the MIB from the BCH. A physical downlink shared channel (PDSCH) may comprise/carry downlink data and signaling messages from the DL-SCH, as well as paging messages from the PCH. A physical downlink control channel (PDCCH) may comprise/carry downlink control information (DCI), which may comprise downlink scheduling commands, uplink scheduling grants, and uplink power control commands. A physical uplink shared channel (PUSCH) may comprise/carry uplink data and signaling messages from the UL-SCH and in some instances uplink control information (UCI) as described below. A physical uplink control channel (PUCCH) may comprise/carry UCI, which may comprise HARQ acknowledgments, channel quality indicators (CQI), pre-coding matrix indicators (PMI), rank indicators (RI), and scheduling requests (SR). A physical random access channel (PRACH) may be used for random access.

The physical layer may generate physical signals to support the low-level operation of the physical layer, which may be similar to the physical control channels. As shown in FIG. 5A and FIG. 5B, the physical layer signals (e.g., that may be defined by an NR configuration or any other configuration) may comprise primary synchronization signals (PSS), secondary synchronization signals (SSS), channel state information reference signals (CSI-RS), demodulation reference signals (DM-RS), sounding reference signals (SRS), phase-tracking reference signals (PT-RS), and/or any other signals.

One or more of the channels (e.g., logical channels, transport channels, physical channels, etc.) may be used to carry out functions associated with the control plan protocol stack (e.g., NR control plane protocol stack). FIG. 2B shows an example control plane configuration (e.g., an NR control plane protocol stack). As shown in FIG. 2B, the control plane configuration (e.g., the NR control plane protocol stack) may use substantially the same/similar one or more protocol layers (e.g., PHY 211 and 221, MAC 212 and 222, RLC 213 and 223, and PDCP 214 and 224) as the example user plane configuration (e.g., the NR user plane protocol stack). Similar four protocol layers may comprise the PHYs 211 and 221, the MACs 212 and 222, the RLCs 213 and 223, and the PDCPs 214 and 224. The control plane configuration (e.g., the NR control plane stack) may have radio resource controls (RRCs) 216 and 226 and NAS protocols 217 and 237 at the top of the control plane configuration (e.g., the NR control plane protocol stack), for example, instead of having the SDAPs 215 and 225. The control plane configuration may comprise an AMF 230 comprising the NAS protocol 237.

The NAS protocols 217 and 237 may provide control plane functionality between the wireless device 210 and the AMF 230 (e.g., the AMF 158A or any other AMF) and/or, more generally, between the wireless device 210 and a CN (e.g., the CN 152 or any other CN). The NAS protocols 217 and 237 may provide control plane functionality between the wireless device 210 and the AMF 230 via signaling messages, referred to as NAS messages. There may be no direct path between the wireless device 210 and the AMF 230 via which the NAS messages may be transported. The NAS messages may be transported using the AS of the Uu and NG interfaces. The NAS protocols 217 and 237 may provide control plane functionality, such as authentication, security, a connection setup, mobility management, session management, and/or any other functionality.

The RRCs 216 and 226 may provide/configure control plane functionality between the wireless device 210 and the base station 220 and/or, more generally, between the wireless device 210 and the RAN (e.g., the base station 220). The RRC layers 216 and 226 may provide/configure control plane functionality between the wireless device 210 and the base station 220 via signaling messages, which may be referred to as RRC messages. The RRC messages may be sent/transmitted between the wireless device 210 and the RAN (e.g., the base station 220) using signaling radio bearers and the same/similar PDCP, RLC, MAC, and PHY protocol layers. The MAC layer may multiplex control-plane and user-plane data into the same TB. The RRC layers 216 and 226 may provide/configure control plane functionality, such as one or more of the following functionalities: broadcast of system information related to AS and NAS; paging initiated by the CN or the RAN; establishment, maintenance and release of an RRC connection between the wireless device 210 and the RAN (e.g., the base station 220); security functions including key management; establishment, configuration, maintenance and release of signaling radio bearers and data radio bearers; mobility functions; QoS management functions; wireless device measurement reporting (e.g., the wireless device measurement reporting) and control of the reporting; detection of and recovery from radio link failure (RLF); and/or NAS message transfer. As part of establishing an RRC connection, RRC layers 216 and 226 may establish an RRC context, which may involve configuring parameters for communication between the wireless device 210 and the RAN (e.g., the base station 220).

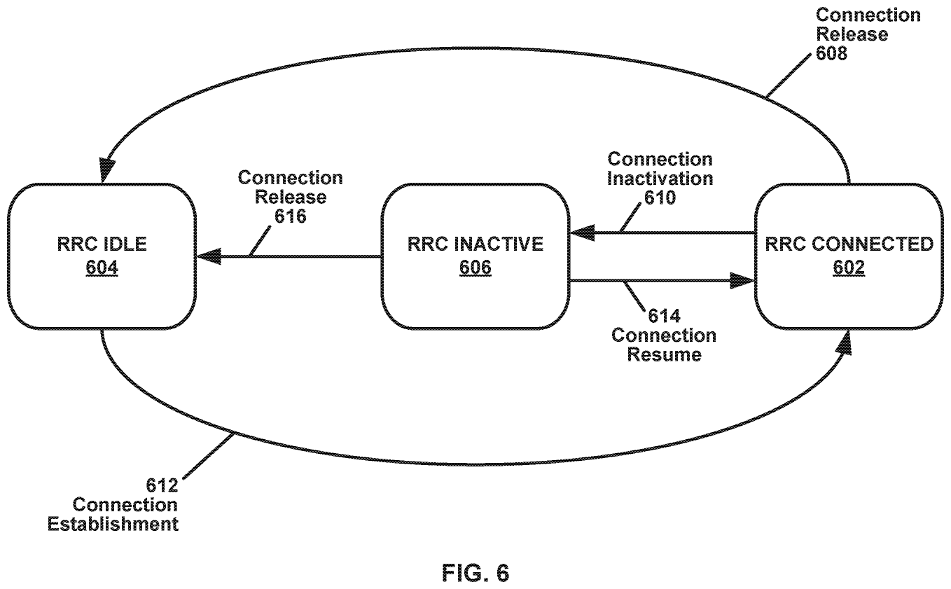

FIG. 6 shows example RRC states and RRC state transitions. An RRC state of a wireless device may be changed to another RRC state (e.g., RRC state transitions of a wireless device). The wireless device may be substantially the same or similar to the wireless device 106, 210, or any other wireless device. A wireless device may be in at least one of a plurality of states, such as three RRC states comprising RRC connected 602 (e.g., RRC_CONNECTED), RRC idle 604 (e.g., RRC_IDLE), and RRC inactive 606 (e.g., RRC_INACTIVE). The RRC inactive 606 may be RRC connected but inactive.

An RRC connection may be established for the wireless device. For example, this may be during an RRC connected state. During the RRC connected state (e.g., during the RRC connected 602), the wireless device may have an established RRC context and may have at least one RRC connection with a base station. The base station may be similar to one of the one or more base stations (e.g., one or more base stations of the RAN 104 shown in FIG. 1A, one of the gNBs 160 or ng-eNBs 162 shown in FIG. 1B, the base station 220 shown in FIG. 2A and FIG. 2B, or any other base stations). The base station with which the wireless device is connected (e.g., has established an RRC connection) may have the RRC context for the wireless device. The RRC context, which may be referred to as a wireless device context (e.g., the UE context), may comprise parameters for communication between the wireless device and the base station. These parameters may comprise, for example, one or more of: AS contexts; radio link configuration parameters; bearer configuration information (e.g., relating to a data radio bearer, a signaling radio bearer, a logical channel, a QoS flow, and/or a PDU session); security information; and/or layer configuration information (e.g., PHY, MAC, RLC, PDCP, and/or SDAP layer configuration information). During the RRC connected state (e.g., the RRC connected 602), mobility of the wireless device may be managed/controlled by an RAN (e.g., the RAN 104 or the NG RAN 154). The wireless device may measure received signal levels (e.g., reference signal levels, reference signal received power, reference signal received quality, received signal strength indicator, etc.) based on one or more signals sent from a serving cell and neighboring cells. The wireless device may report these measurements to a serving base station (e.g., the base station currently serving the wireless device). The serving base station of the wireless device may request a handover to a cell of one of the neighboring base stations, for example, based on the reported measurements. The RRC state may transition from the RRC connected state (e.g., RRC connected 602) to an RRC idle state (e.g., the RRC idle 604) via a connection release procedure 608. The RRC state may transition from the RRC connected state (e.g., RRC connected 602) to the RRC inactive state (e.g., RRC inactive 606) via a connection inactivation procedure 610.

An RRC context may not be established for the wireless device. For example, this may be during the RRC idle state. During the RRC idle state (e.g., the RRC idle 604), an RRC context may not be established for the wireless device. During the RRC idle state (e.g., the RRC idle 604), the wireless device may not have an RRC connection with the base station. During the RRC idle state (e.g., the RRC idle 604), the wireless device may be in a sleep state for the majority of the time (e.g., to conserve battery power). The wireless device may wake up periodically (e.g., once in every discontinuous reception (DRX) cycle) to monitor for paging messages (e.g., paging messages set from the RAN). Mobility of the wireless device may be managed by the wireless device via a procedure of a cell reselection. The RRC state may transition from the RRC idle state (e.g., the RRC idle 604) to the RRC connected state (e.g., the RRC connected 602) via a connection establishment procedure 612, which may involve a random access procedure.

A previously established RRC context may be maintained for the wireless device. For example, this may be during the RRC inactive state. During the RRC inactive state (e.g., the RRC inactive 606), the RRC context previously established may be maintained in the wireless device and the base station. The maintenance of the RRC context may enable/allow a fast transition to the RRC connected state (e.g., the RRC connected 602) with reduced signaling overhead as compared to the transition from the RRC idle state (e.g., the RRC idle 604) to the RRC connected state (e.g., the RRC connected 602). During the RRC inactive state (e.g., the RRC inactive 606), the wireless device may be in a sleep state and mobility of the wireless device may be managed/controlled by the wireless device via a cell reselection. The RRC state may transition from the RRC inactive state (e.g., the RRC inactive 606) to the RRC connected state (e.g., the RRC connected 602) via a connection resume procedure 614. The RRC state may transition from the RRC inactive state (e.g., the RRC inactive 606) to the RRC idle state (e.g., the RRC idle 604) via a connection release procedure 616 that may be the same as or similar to connection release procedure 608.

An RRC state may be associated with a mobility management mechanism. During the RRC idle state (e.g., RRC idle 604) and the RRC inactive state (e.g., the RRC inactive 606), mobility may be managed/controlled by the wireless device via a cell reselection. The purpose of mobility management during the RRC idle state (e.g., the RRC idle 604) or during the RRC inactive state (e.g., the RRC inactive 606) may be to enable/allow the network to be able to notify the wireless device of an event via a paging message without having to broadcast the paging message over the entire mobile communications network. The mobility management mechanism used during the RRC idle state (e.g., the RRC idle 604) or during the RRC idle state (e.g., the RRC inactive 606) may enable/allow the network to track the wireless device on a cell-group level, for example, so that the paging message may be broadcast over the cells of the cell group that the wireless device currently resides within (e.g. instead of sending the paging message over the entire mobile communication network). The mobility management mechanisms for the RRC idle state (e.g., the RRC idle 604) and the RRC inactive state (e.g., the RRC inactive 606) may track the wireless device on a cell-group level. The mobility management mechanisms may do the tracking, for example, using different granularities of grouping. There may be a plurality of levels of cell-grouping granularity (e.g., three levels of cell-grouping granularity: individual cells; cells within a RAN area identified by a RAN area identifier (RAI); and cells within a group of RAN areas, referred to as a tracking area and identified by a tracking area identifier (TAI)).

Tracking areas may be used to track the wireless device (e.g., tracking the location of the wireless device at the CN level). The CN (e.g., the CN 102, the 5G CN 152, or any other CN) may send to the wireless device a list of TAIs associated with a wireless device registration area (e.g., a UE registration area). A wireless device may perform a registration update with the CN to allow the CN to update the location of the wireless device and provide the wireless device with a new the UE registration area, for example, if the wireless device moves (e.g., via a cell reselection) to a cell associated with a TAI that may not be included in the list of TAIs associated with the UE registration area.

RAN areas may be used to track the wireless device (e.g., the location of the wireless device at the RAN level). For a wireless device in an RRC inactive state (e.g., the RRC inactive 606), the wireless device may be assigned/provided/configured with a RAN notification area. A RAN notification area may comprise one or more cell identities (e.g., a list of RAIs and/or a list of TAIs). A base station may belong to one or more RAN notification areas. A cell may belong to one or more RAN notification areas. A wireless device may perform a notification area update with the RAN to update the RAN notification area of the wireless device, for example, if the wireless device moves (e.g., via a cell reselection) to a cell not included in the RAN notification area assigned/provided/configured to the wireless device.

A base station storing an RRC context for a wireless device or a last serving base station of the wireless device may be referred to as an anchor base station. An anchor base station may maintain an RRC context for the wireless device at least during a period of time that the wireless device stays in a RAN notification area of the anchor base station and/or during a period of time that the wireless device stays in an RRC inactive state (e.g., RRC inactive 606).

A base station (e.g., gNBs 160 in FIG. 1B or any other base station) may be split into two parts: a central unit (e.g., a base station central unit, such as a gNB CU) and one or more distributed units (e.g., a base station distributed unit, such as a gNB DU). A base station central unit (CU) may be coupled to one or more base station distributed units (DUs) using an F1 interface (e.g., an F1 interface defined in an NR configuration). The base station CU may comprise the RRC, the PDCP, and the SDAP layers. A base station distributed unit (DU) may comprise the RLC, the MAC, and the PHY layers.

The physical signals and physical channels (e.g., described with respect to FIG. 5A and FIG. 5B) may be mapped onto one or more symbols (e.g., orthogonal frequency divisional multiplexing (OFDM) symbols in an NR configuration or any other symbols). OFDM is a multicarrier communication scheme that sends/transmits data over F orthogonal subcarriers (or tones). The data may be mapped to a series of complex symbols (e.g., M-quadrature amplitude modulation (M-QAM) symbols or M-phase shift keying (M PSK) symbols or any other modulated symbols), referred to as source symbols, and divided into F parallel symbol streams, for example, before transmission of the data. The F parallel symbol streams may be treated as if they are in the frequency domain. The F parallel symbols may be used as inputs to an Inverse Fast Fourier Transform (IFFT) block that transforms them into the time domain. The IFFT block may take in F source symbols at a time, one from each of the F parallel symbol streams. The IFFT block may use each source symbol to modulate the amplitude and phase of one of F sinusoidal basis functions that correspond to the F orthogonal subcarriers. The output of the IFFT block may be F time-domain samples that represent the summation of the F orthogonal subcarriers. The F time-domain samples may form a single OFDM symbol. An OFDM symbol provided/output by the IFFT block may be sent/transmitted over the air interface on a carrier frequency, for example, after one or more processes (e.g., addition of a cyclic prefix) and up-conversion. The F parallel symbol streams may be mixed, for example, using a Fast Fourier Transform (FFT) block before being processed by the IFFT block. This operation may produce Discrete Fourier Transform (DFT)-precoded OFDM symbols and may be used by one or more wireless devices in the uplink to reduce the peak to average power ratio (PAPR). Inverse processing may be performed on the OFDM symbol at a receiver using an FFT block to recover the data mapped to the source symbols.

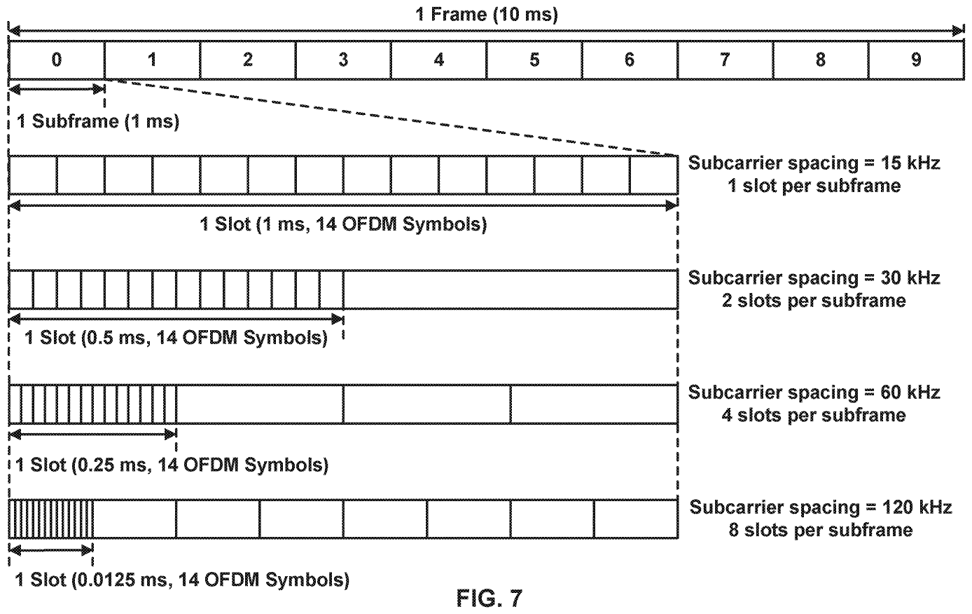

FIG. 7 shows an example configuration of a frame. The frame may comprise, for example, an NR radio frame into which OFDM symbols may be grouped. A frame (e.g., an NR radio frame) may be identified/indicated by a system frame quantity/number (SFN) or any other value. The SFN may repeat with a period of 1024 frames. One NR frame may be 10 milliseconds (ms) in duration and may comprise 10 subframes that are 1 ms in duration. A subframe may be divided into one or more slots (e.g., depending on numerologies and/or different subcarrier spacings). Each of the one or more slots may comprise, for example, 14 OFDM symbols per slot. Any quantity of symbols, slots, or duration may be used for any time interval.

The duration of a slot may depend on the numerology used for the OFDM symbols of the slot. A flexible numerology may be supported, for example, to accommodate different deployments (e.g., cells with carrier frequencies below 1 GHz up to cells with carrier frequencies in the mm-wave range). A flexible numerology may be supported, for example, in an NR configuration or any other radio configurations. A numerology may be defined in terms of subcarrier spacing and/or cyclic prefix duration. Subcarrier spacings may be scaled up by powers of two from a baseline subcarrier spacing of 15 kHz. Cyclic prefix durations may be scaled down by powers of two from a baseline cyclic prefix duration of 4.7 μs, for example, for a numerology in an NR configuration or any other radio configurations. Numerologies may be defined with the following subcarrier spacing/cyclic prefix duration combinations: 15 kHz/4.7 μs; 30 kHz/2.3 μs; 60 kHz/1.2 μs; 120 kHz/0.59 μs; 240 kHz/0.29 μs, and/or any other subcarrier spacing/cyclic prefix duration combinations.

A slot may have a fixed quantity/number of OFDM symbols (e.g., 14 OFDM symbols). A numerology with a higher subcarrier spacing may have a shorter slot duration and more slots per subframe. Examples of numerology-dependent slot duration and slots-per-subframe transmission structure are shown in FIG. 7 (the numerology with a subcarrier spacing of 240 kHz is not shown in FIG. 7). A subframe (e.g., in an NR configuration) may be used as a numerology-independent time reference. A slot may be used as the unit upon which uplink and downlink transmissions are scheduled. Scheduling (e.g., in an NR configuration) may be decoupled from the slot duration. Scheduling may start at any OFDM symbol. Scheduling may last for as many symbols as needed for a transmission, for example, to support low latency. These partial slot transmissions may be referred to as mini-slot or sub-slot transmissions.

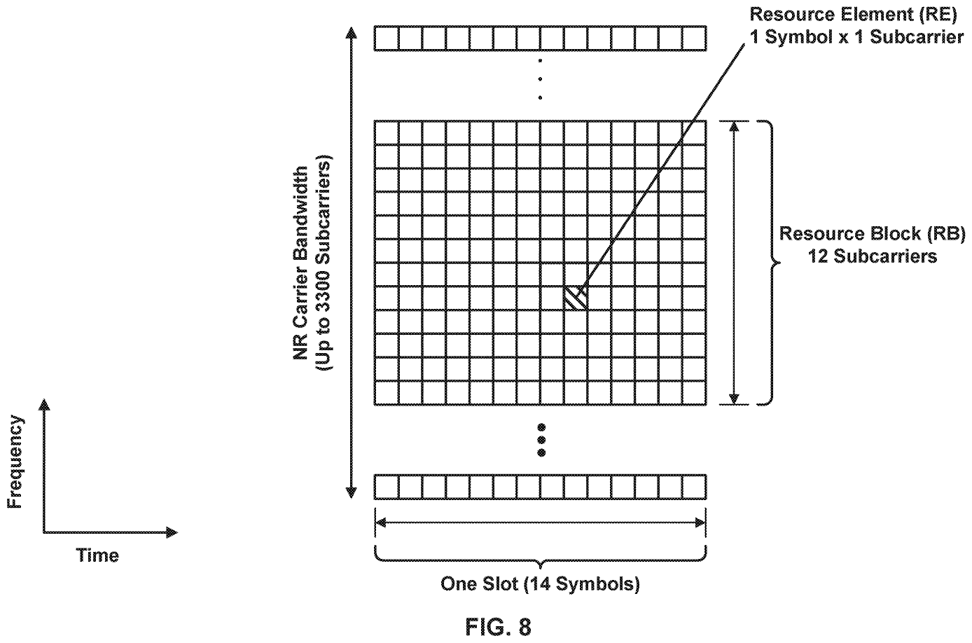

FIG. 8 shows an example resource configuration of one or more carriers. The resource configuration of may comprise a slot in the time and frequency domain for an NR carrier or any other carrier. The slot may comprise resource elements (REs) and resource blocks (RBs). A resource element (RE) may be the smallest physical resource (e.g., in an NR configuration). An RE may span one OFDM symbol in the time domain by one subcarrier in the frequency domain, such as shown in FIG. 8. An RB may span twelve consecutive REs in the frequency domain, such as shown in FIG. 8. A carrier (e.g., an NR carrier) may be limited to a width of a certain quantity of RBs and/or subcarriers (e.g., 275 RBs or 275×12=3300 subcarriers). Such limitation(s), if used, may limit the carrier (e.g., NR carrier) frequency based on subcarrier spacing (e.g., carrier frequency of 50, 100, 200, and 400 MHz for subcarrier spacings of 15, 30, 60, and 120 kHz, respectively). A 400 MHz bandwidth may be set based on a 400 MHz per carrier bandwidth limit. Any other bandwidth may be set based on a per carrier bandwidth limit.

A single numerology may be used across the entire bandwidth of a carrier (e.g., an NR such as shown in FIG. 8). In other example configurations, multiple numerologies may be supported on the same carrier. NR and/or other access technologies may support wide carrier bandwidths (e.g., up to 400 MHz for a subcarrier spacing of 120 kHz). Not all wireless devices may be able to receive the full carrier bandwidth (e.g., due to hardware limitations and/or different wireless device capabilities). Receiving and/or utilizing the full carrier bandwidth may be prohibitive, for example, in terms of wireless device power consumption. A wireless device may adapt the size of the receive bandwidth of the wireless device, for example, based on the amount of traffic the wireless device is scheduled to receive (e.g., to reduce power consumption and/or for other purposes). Such an adaptation may be referred to as bandwidth adaptation.

Configuration of one or more bandwidth parts (BWPs) may support one or more wireless devices not capable of receiving the full carrier bandwidth. BWPs may support bandwidth adaptation, for example, for such wireless devices not capable of receiving the full carrier bandwidth. A BWP (e.g., a BWP of an NR configuration) may be defined by a subset of contiguous RBs on a carrier. A wireless device may be configured (e.g., via an RRC layer) with one or more downlink BWPs per serving cell and one or more uplink BWPs per serving cell (e.g., up to four downlink BWPs per serving cell and up to four uplink BWPs per serving cell). One or more of the configured BWPs for a serving cell may be active, for example, at a given time. The one or more BWPs may be referred to as active BWPs of the serving cell. A serving cell may have one or more first active BWPs in the uplink carrier and one or more second active BWPs in the secondary uplink carrier, for example, if the serving cell is configured with a secondary uplink carrier.

A downlink BWP from a set of configured downlink BWPs may be linked with an uplink BWP from a set of configured uplink BWPs (e.g., for unpaired spectra). A downlink BWP and an uplink BWP may be linked, for example, if a downlink BWP index of the downlink BWP and an uplink BWP index of the uplink BWP are the same. A wireless device may expect that the center frequency for a downlink BWP is the same as the center frequency for an uplink BWP (e.g., for unpaired spectra).

A base station may configure a wireless device with one or more control resource sets (CORESETs) for at least one search space. The base station may configure the wireless device with one or more CORESETS, for example, for a downlink BWP in a set of configured downlink BWPs on a primary cell (PCell) or on a secondary cell (SCell). A search space may comprise a set of locations in the time and frequency domains where the wireless device may monitor/find/detect/identify control information. The search space may be a wireless device-specific search space (e.g., a UE-specific search space) or a common search space (e.g., potentially usable by a plurality of wireless devices or a group of wireless user devices). A base station may configure a group of wireless devices with a common search space, on a PCell or on a primary secondary cell (PSCell), in an active downlink BWP.

A base station may configure a wireless device with one or more resource sets for one or more PUCCH transmissions, for example, for an uplink BWP in a set of configured uplink BWPs. A wireless device may receive downlink receptions (e.g., PDCCH or PDSCH) in a downlink BWP, for example, according to a configured numerology (e.g., a configured subcarrier spacing and/or a configured cyclic prefix duration) for the downlink BWP. The wireless device may send/transmit uplink transmissions (e.g., PUCCH or PUSCH) in an uplink BWP, for example, according to a configured numerology (e.g., a configured subcarrier spacing and/or a configured cyclic prefix length for the uplink BWP).

One or more BWP indicator fields may be provided/comprised in Downlink Control Information (DCI). A value of a BWP indicator field may indicate which BWP in a set of configured BWPs is an active downlink BWP for one or more downlink receptions. The value of the one or more BWP indicator fields may indicate an active uplink BWP for one or more uplink transmissions.

A base station may semi-statically configure a wireless device with a default downlink BWP within a set of configured downlink BWPs associated with a PCell. A default downlink BWP may be an initial active downlink BWP, for example, if the base station does not provide/configure a default downlink BWP to/for the wireless device. The wireless device may determine which BWP is the initial active downlink BWP, for example, based on a CORESET configuration obtained using the PBCH.

A base station may configure a wireless device with a BWP inactivity timer value for a PCell. The wireless device may start or restart a BWP inactivity timer at any appropriate time. The wireless device may start or restart the BWP inactivity timer, for example, if one or more conditions are satisfied. The one or more conditions may comprise at least one of: the wireless device detects DCI indicating an active downlink BWP other than a default downlink BWP for a paired spectra operation; the wireless device detects DCI indicating an active downlink BWP other than a default downlink BWP for an unpaired spectra operation; and/or the wireless device detects DCI indicating an active uplink BWP other than a default uplink BWP for an unpaired spectra operation. The wireless device may start/run the BWP inactivity timer toward expiration (e.g., increment from zero to the BWP inactivity timer value, or decrement from the BWP inactivity timer value to zero), for example, if the wireless device does not detect DCI during a time interval (e.g., 1 ms or 0.5 ms). The wireless device may switch from the active downlink BWP to the default downlink BWP, for example, if the BWP inactivity timer expires.

A base station may semi-statically configure a wireless device with one or more BWPs. A wireless device may switch an active BWP from a first BWP to a second BWP, for example, based on (e.g., after or in response to) receiving DCI indicating the second BWP as an active BWP. A wireless device may switch an active BWP from a first BWP to a second BWP, for example, based on (e.g., after or in response to) an expiry of the BWP inactivity timer (e.g., if the second BWP is the default BWP).

A downlink BWP switching may refer to switching an active downlink BWP from a first downlink BWP to a second downlink BWP (e.g., the second downlink BWP is activated and the first downlink BWP is deactivated). An uplink BWP switching may refer to switching an active uplink BWP from a first uplink BWP to a second uplink BWP (e.g., the second uplink BWP is activated and the first uplink BWP is deactivated). Downlink and uplink BWP switching may be performed independently (e.g., in paired spectrum/spectra). Downlink and uplink BWP switching may be performed simultaneously (e.g., in unpaired spectrum/spectra). Switching between configured BWPs may occur, for example, based on RRC signaling, DCI signaling, expiration of a BWP inactivity timer, and/or an initiation of random access.

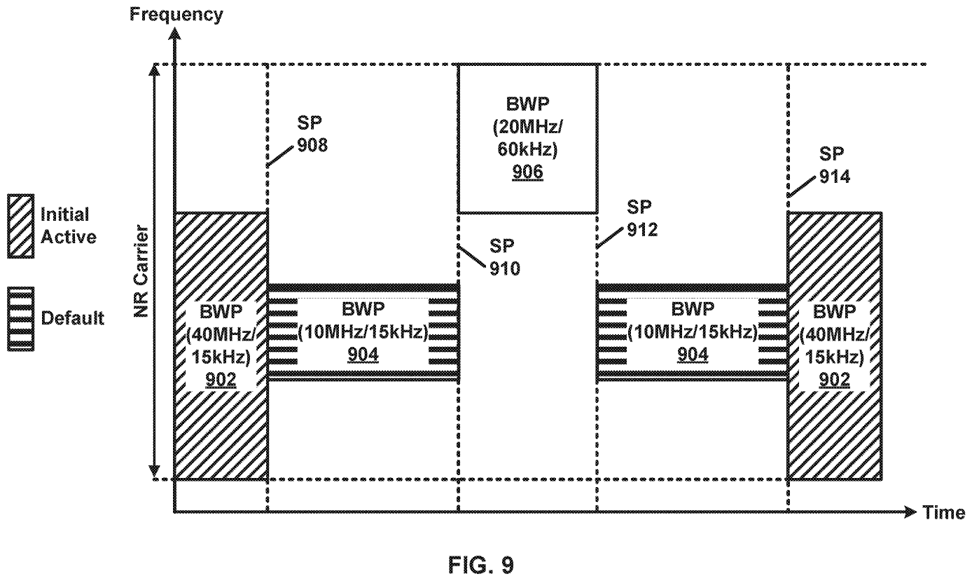

FIG. 9 shows an example of configured BWPs. Bandwidth adaptation using multiple BWPs (e.g., three configured BWPs for an NR carrier) may be available. A wireless device configured with multiple BWPs (e.g., the three BWPs) may switch from one BWP to another BWP at a switching point. The BWPs may comprise: a BWP 902 having a bandwidth of 40 MHz and a subcarrier spacing of 15 kHz; a BWP 904 having a bandwidth of 10 MHz and a subcarrier spacing of 15 kHz; and a BWP 906 having a bandwidth of 20 MHz and a subcarrier spacing of 60 kHz. The BWP 902 may be an initial active BWP, and the BWP 904 may be a default BWP. The wireless device may switch between BWPs at switching points. The wireless device may switch from the BWP 902 to the BWP 904 at a switching point 908. The switching at the switching point 908 may occur for any suitable reasons. The switching at a switching point 908 may occur, for example, based on (e.g., after or in response to) an expiry of a BWP inactivity timer (e.g., indicating switching to the default BWP). The switching at the switching point 908 may occur, for example, based on (e.g., after or in response to) receiving DCI indicating BWP 904 as the active BWP. The wireless device may switch at a switching point 910 from an active BWP 904 to the BWP 906, for example, after or in response to receiving DCI indicating BWP 906 as a new active BWP. The wireless device may switch at a switching point 912 from an active BWP 906 to the BWP 904, for example, a based on (e.g., after or in response to) an expiry of a BWP inactivity timer. The wireless device may switch at the switching point 912 from an active BWP 906 to the BWP 904, for example, after or in response to receiving DCI indicating BWP 904 as a new active BWP. The wireless device may switch at a switching point 914 from an active BWP 904 to the BWP 902, for example, after or in response to receiving DCI indicating the BWP 902 as a new active BWP.

Wireless device procedures for switching BWPs on a secondary cell may be the same/similar as those on a primary cell, for example, if the wireless device is configured for a secondary cell with a default downlink BWP in a set of configured downlink BWPs and a timer value. The wireless device may use the timer value and the default downlink BWP for the secondary cell in the same/similar manner as the wireless device uses the timer value and/or default BWPs for a primary cell. The timer value (e.g., the BWP inactivity timer) may be configured per cell (e.g., for one or more BWPs), for example, via RRC signaling or any other signaling. One or more active BWPs may switch to another BWP, for example, based on an expiration of the BWP inactivity timer.

Two or more carriers may be aggregated and data may be simultaneously sent/transmitted to/from the same wireless device using carrier aggregation (CA) (e.g., to increase data rates). The aggregated carriers in CA may be referred to as component carriers (CCs). There may be a quantity/number of serving cells for the wireless device (e.g., one serving cell for a CC), for example, if CA is configured/used. The CCs may have multiple configurations in the frequency domain.

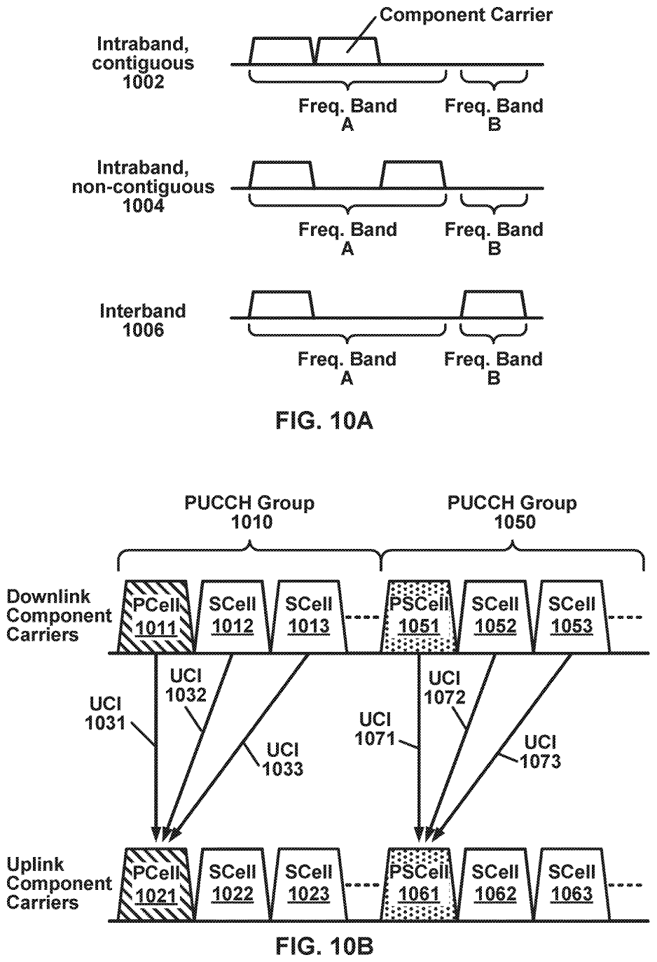

FIG. 10A shows example CA configurations based on CCs. As shown in FIG. 10A, three types of CA configurations may comprise an intraband (contiguous) configuration 1002, an intraband (non-contiguous) configuration 1004, and/or an interband configuration 1006. In the intraband (contiguous) configuration 1002, two CCs may be aggregated in the same frequency band (frequency band A) and may be located directly adjacent to each other within the frequency band. In the intraband (non-contiguous) configuration 1004, two CCs may be aggregated in the same frequency band (frequency band A) but may be separated from each other in the frequency band by a gap. In the interband configuration 1006, two CCs may be located in different frequency bands (e.g., frequency band A and frequency band B, respectively).

A network may set the maximum quantity of CCs that can be aggregated (e.g., up to 32 CCs may be aggregated in NR, or any other quantity may be aggregated in other systems). The aggregated CCs may have the same or different bandwidths, subcarrier spacing, and/or duplexing schemes (TDD, FDD, or any other duplexing schemes). A serving cell for a wireless device using CA may have a downlink CC. One or more uplink CCs may be optionally configured for a serving cell (e.g., for FDD). The ability to aggregate more downlink carriers than uplink carriers may be useful, for example, if the wireless device has more data traffic in the downlink than in the uplink.

One of the aggregated cells for a wireless device may be referred to as a primary cell (PCell), for example, if a CA is configured. The PCell may be the serving cell that the wireless initially connects to or access to, for example, during or at an RRC connection establishment, an RRC connection reestablishment, and/or a handover. The PCell may provide/configure the wireless device with NAS mobility information and the security input. Wireless device may have different PCells. For the downlink, the carrier corresponding to the PCell may be referred to as the downlink primary CC (DL PCC). For the uplink, the carrier corresponding to the PCell may be referred to as the uplink primary CC (UL PCC). The other aggregated cells (e.g., associated with CCs other than the DL PCC and UL PCC) for the wireless device may be referred to as secondary cells (SCells). The SCells may be configured, for example, after the PCell is configured for the wireless device. An SCell may be configured via an RRC connection reconfiguration procedure. For the downlink, the carrier corresponding to an SCell may be referred to as a downlink secondary CC (DL SCC). For the uplink, the carrier corresponding to the SCell may be referred to as the uplink secondary CC (UL SCC).

Configured SCells for a wireless device may be activated or deactivated, for example, based on traffic and channel conditions. Deactivation of an SCell may cause the wireless device to stop PDCCH and PDSCH reception on the SCell and PUSCH, SRS, and CQI transmissions on the SCell. Configured SCells may be activated or deactivated, for example, using a MAC CE (e.g., the MAC CE described with respect to FIG. 4B). A MAC CE may use a bitmap (e.g., one bit per SCell) to indicate which SCells (e.g., in a subset of configured SCells) for the wireless device are activated or deactivated. Configured SCells may be deactivated, for example, based on (e.g., after or in response to) an expiration of an SCell deactivation timer (e.g., one SCell deactivation timer per SCell may be configured).

DCI may comprise control information, such as scheduling assignments and scheduling grants, for a cell. DCI may be sent/transmitted via the cell corresponding to the scheduling assignments and/or scheduling grants, which may be referred to as a self-scheduling. DCI comprising control information for a cell may be sent/transmitted via another cell, which may be referred to as a cross-carrier scheduling. Uplink control information (UCI) may comprise control information, such as HARQ acknowledgments and channel state feedback (e.g., CQI, PMI, and/or RI) for aggregated cells. UCI may be sent/transmitted via an uplink control channel (e.g., a PUCCH) of the PCell or a certain SCell (e.g., an SCell configured with PUCCH). For a larger quantity/number of aggregated downlink CCs, the PUCCH of the PCell may become overloaded. Cells may be divided into multiple PUCCH groups.

FIG. 10B shows example group of cells. Aggregated cells may be configured into one or more PUCCH groups (e.g., as shown in FIG. 10B). One or more cell groups or one or more uplink control channel groups (e.g., a PUCCH group 1010 and a PUCCH group 1050) may comprise one or more downlink CCs, respectively. The PUCCH group 1010 may comprise one or more downlink CCs, for example, three downlink CCs: a PCell 1011 (e.g., a DL PCC), an SCell 1012 (e.g., a DL SCC), and an SCell 1013 (e.g., a DL SCC). The PUCCH group 1050 may comprise one or more downlink CCs, for example, three downlink CCs: a PUCCH SCell (or PSCell) 1051 (e.g., a DL SCC), an SCell 1052 (e.g., a DL SCC), and an SCell 1053 (e.g., a DL SCC). One or more uplink CCs of the PUCCH group 1010 may be configured as a PCell 1021 (e.g., a UL PCC), an SCell 1022 (e.g., a UL SCC), and an SCell 1023 (e.g., a UL SCC). One or more uplink CCs of the PUCCH group 1050 may be configured as a PUCCH SCell (or PSCell) 1061 (e.g., a UL SCC), an SCell 1062 (e.g., a UL SCC), and an SCell 1063 (e.g., a UL SCC). UCI related to the downlink CCs of the PUCCH group 1010, shown as UCI 1031, UCI 1032, and UCI 1033, may be sent/transmitted via the uplink of the PCell 1021 (e.g., via the PUCCH of the PCell 1021). UCI related to the downlink CCs of the PUCCH group 1050, shown as UCI 1071, UCI 1072, and UCI 1073, may be sent/transmitted via the uplink of the PUCCH SCell (or PSCell) 1061 (e.g., via the PUCCH of the PUCCH SCell 1061). A single uplink PCell may be configured to send/transmit UCI relating to the six downlink CCs, for example, if the aggregated cells shown in FIG. 10B are not divided into the PUCCH group 1010 and the PUCCH group 1050. The PCell 1021 may become overloaded, for example, if the UCIs 1031, 1032, 1033, 1071, 1072, and 1073 are sent/transmitted via the PCell 1021. By dividing transmissions of UCI between the PCell 1021 and the PUCCH SCell (or PSCell) 1061, overloading may be prevented and/or reduced.

A PCell may comprise a downlink carrier (e.g., the PCell 1011) and an uplink carrier (e.g., the PCell 1021). An SCell may comprise only a downlink carrier. A cell, comprising a downlink carrier and optionally an uplink carrier, may be assigned with a physical cell ID and a cell index. The physical cell ID or the cell index may indicate/identify a downlink carrier and/or an uplink carrier of the cell, for example, depending on the context in which the physical cell ID is used. A physical cell ID may be determined, for example, using a synchronization signal (e.g., PSS and/or SSS) sent/transmitted via a downlink component carrier. A cell index may be determined, for example, using one or more RRC messages. A physical cell ID may be referred to as a carrier ID, and a cell index may be referred to as a carrier index. A first physical cell ID for a first downlink carrier may refer to the first physical cell ID for a cell comprising the first downlink carrier. Substantially the same/similar concept may apply to, for example, a carrier activation. Activation of a first carrier may refer to activation of a cell comprising the first carrier.

A multi-carrier nature of a PHY layer may be exposed/indicated to a MAC layer (e.g., in a CA configuration). A HARQ entity may operate on a serving cell. A transport block may be generated per assignment/grant per serving cell. A transport block and potential HARQ retransmissions of the transport block may be mapped to a serving cell.

For the downlink, a base station may send/transmit (e.g., unicast, multicast, and/or broadcast), to one or more wireless devices, one or more reference signals (RSs) (e.g., PSS, SSS, CSI-RS, DM-RS, and/or PT-RS). For the uplink, the one or more wireless devices may send/transmit one or more RSs to the base station (e.g., DM-RS, PT-RS, and/or SRS). The PSS and the SSS may be sent/transmitted by the base station and used by the one or more wireless devices to synchronize the one or more wireless devices with the base station. A synchronization signal (SS)/physical broadcast channel (PBCH) block may comprise the PSS, the SSS, and the PBCH. The base station may periodically send/transmit a burst of SS/PBCH blocks, which may be referred to as SSBs.

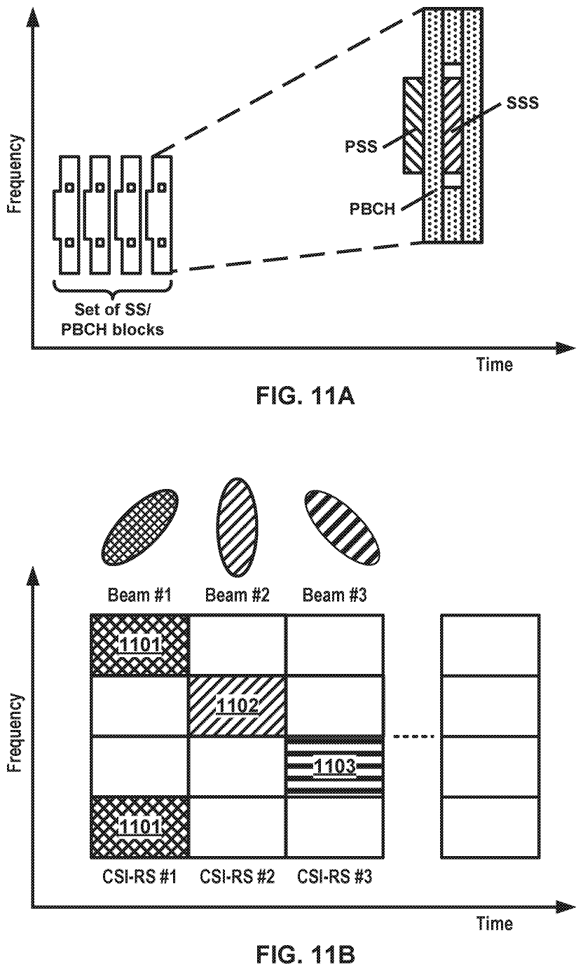

FIG. 11A shows an example mapping of one or more SS/PBCH blocks. A burst of SS/PBCH blocks may comprise one or more SS/PBCH blocks (e.g., 4 SS/PBCH blocks, as shown in FIG. 11A). Bursts may be sent/transmitted periodically (e.g., every 2 frames, 20 ms, or any other durations). A burst may be restricted to a half-frame (e.g., a first half-frame having a duration of 5 ms). Such parameters (e.g., the quantity/number of SS/PBCH blocks per burst, periodicity of bursts, position of the burst within the frame) may be configured, for example, based on at least one of: a carrier frequency of a cell in which the SS/PBCH block is sent/transmitted; a numerology or subcarrier spacing of the cell; a configuration by the network (e.g., using RRC signaling); and/or any other suitable factor(s). A wireless device may assume a subcarrier spacing for the SS/PBCH block based on the carrier frequency being monitored, for example, unless the radio network configured the wireless device to assume a different subcarrier spacing.

The SS/PBCH block may span one or more OFDM symbols in the time domain (e.g., 4 OFDM symbols, as shown in FIG. 11A or any other quantity/number of symbols) and may span one or more subcarriers in the frequency domain (e.g., 240 contiguous subcarriers or any other quantity/number of subcarriers). The PSS, the SSS, and the PBCH may have a common center frequency. The PSS may be sent/transmitted first and may span, for example, 1 OFDM symbol and 127 subcarriers. The SSS may be sent/transmitted after the PSS (e.g., two symbols later) and may span 1 OFDM symbol and 127 subcarriers. The PBCH may be sent/transmitted after the PSS (e.g., across the next 3 OFDM symbols) and may span 240 subcarriers (e.g., in the second and fourth OFDM symbols as shown in FIG. 11A) and/or may span fewer than 240 subcarriers (e.g., in the third OFDM symbols as shown in FIG. 11A).

The location of the SS/PBCH block in the time and frequency domains may not be known to the wireless device (e.g., if the wireless device is searching for the cell). The wireless device may monitor a carrier for the PSS, for example, to find and select the cell. The wireless device may monitor a frequency location within the carrier. The wireless device may search for the PSS at a different frequency location within the carrier, for example, if the PSS is not found after a certain duration (e.g., 20 ms). The wireless device may search for the PSS at a different frequency location within the carrier, for example, as indicated by a synchronization raster. The wireless device may determine the locations of the SSS and the PBCH, respectively, for example, based on a known structure of the SS/PBCH block if the PSS is found at a location in the time and frequency domains. The SS/PBCH block may be a cell-defining SS block (CD-SSB). A primary cell may be associated with a CD-SSB. The CD-SSB may be located on a synchronization raster. A cell selection/search and/or reselection may be based on the CD-SSB.

The SS/PBCH block may be used by the wireless device to determine one or more parameters of the cell. The wireless device may determine a physical cell identifier (PCI) of the cell, for example, based on the sequences of the PSS and the SSS, respectively. The wireless device may determine a location of a frame boundary of the cell, for example, based on the location of the SS/PBCH block. The SS/PBCH block may indicate that it has been sent/transmitted in accordance with a transmission pattern. An SS/PBCH block in the transmission pattern may be a known distance from the frame boundary (e.g., a predefined distance for a RAN configuration among one or more networks, one or more base stations, and one or more wireless devices).

The PBCH may use a QPSK modulation and/or forward error correction (FEC). The FEC may use polar coding. One or more symbols spanned by the PBCH may comprise/carry one or more DM-RSs for demodulation of the PBCH. The PBCH may comprise an indication of a current system frame quantity/number (SFN) of the cell and/or a SS/PBCH block timing index. These parameters may facilitate time synchronization of the wireless device to the base station. The PBCH may comprise a MIB used to send/transmit to the wireless device one or more parameters. The MIB may be used by the wireless device to locate remaining minimum system information (RMSI) associated with the cell. The RMSI may comprise a System Information Block Type 1 (SIB1). The SIB1 may comprise information for the wireless device to access the cell. The wireless device may use one or more parameters of the MIB to monitor a PDCCH, which may be used to schedule a PDSCH. The PDSCH may comprise the SIB1. The SIB1 may be decoded using parameters provided/comprised in the MIB. The PBCH may indicate an absence of SIB1. The wireless device may be pointed to a frequency, for example, based on the PBCH indicating the absence of SIB1. The wireless device may search for an SS/PBCH block at the frequency to which the wireless device is pointed.

The wireless device may assume that one or more SS/PBCH blocks sent/transmitted with a same SS/PBCH block index are quasi co-located (QCLed) (e.g., having substantially the same/similar Doppler spread, Doppler shift, average gain, average delay, and/or spatial Rx parameters). The wireless device may not assume QCL for SS/PBCH block transmissions having different SS/PBCH block indices. SS/PBCH blocks (e.g., those within a half-frame) may be sent/transmitted in spatial directions (e.g., using different beams that span a coverage area of the cell). A first SS/PBCH block may be sent/transmitted in a first spatial direction using a first beam, a second SS/PBCH block may be sent/transmitted in a second spatial direction using a second beam, a third SS/PBCH block may be sent/transmitted in a third spatial direction using a third beam, a fourth SS/PBCH block may be sent/transmitted in a fourth spatial direction using a fourth beam, etc.

A base station may send/transmit a plurality of SS/PBCH blocks, for example, within a frequency span of a carrier. A first PCI of a first SS/PBCH block of the plurality of SS/PBCH blocks may be different from a second PCI of a second SS/PBCH block of the plurality of SS/PBCH blocks. The PCIs of SS/PBCH blocks sent/transmitted in different frequency locations may be different or substantially the same.

The CSI-RS may be sent/transmitted by the base station and used by the wireless device to acquire/obtain/determine channel state information (CSI). The base station may configure the wireless device with one or more CSI-RSs for channel estimation or any other suitable purpose. The base station may configure a wireless device with one or more of the same/similar CSI-RSs. The wireless device may measure the one or more CSI-RSs. The wireless device may estimate a downlink channel state and/or generate a CSI report, for example, based on the measuring of the one or more downlink CSI-RSs. The wireless device may send/transmit the CSI report to the base station (e.g., based on periodic CSI reporting, semi-persistent CSI reporting, and/or aperiodic CSI reporting). The base station may use feedback provided by the wireless device (e.g., the estimated downlink channel state) to perform a link adaptation.

The base station may semi-statically configure the wireless device with one or more CSI-RS resource sets. A CSI-RS resource may be associated with a location in the time and frequency domains and a periodicity. The base station may selectively activate and/or deactivate a CSI-RS resource. The base station may indicate to the wireless device that a CSI-RS resource in the CSI-RS resource set is activated and/or deactivated.

The base station may configure the wireless device to report CSI measurements. The base station may configure the wireless device to provide CSI reports periodically, aperiodically, or semi-persistently. For periodic CSI reporting, the wireless device may be configured with a timing and/or periodicity of a plurality of CSI reports. For aperiodic CSI reporting, the base station may request a CSI report. The base station may command the wireless device to measure a configured CSI-RS resource and provide a CSI report relating to the measurement(s). For semi-persistent CSI reporting, the base station may configure the wireless device to send/transmit periodically, and selectively activate or deactivate the periodic reporting (e.g., via one or more activation/deactivation MAC CEs and/or one or more DCIs). The base station may configure the wireless device with a CSI-RS resource set and CSI reports, for example, using RRC signaling.

The CSI-RS configuration may comprise one or more parameters indicating, for example, up to 32 antenna ports (or any other quantity of antenna ports). The wireless device may be configured to use/employ the same OFDM symbols for a downlink CSI-RS and a CORESET, for example, if the downlink CSI-RS and CORESET are spatially QCLed and resource elements associated with the downlink CSI-RS are outside of the physical resource blocks (PRBs) configured for the CORESET. The wireless device may be configured to use/employ the same OFDM symbols for a downlink CSI-RS and SS/PBCH blocks, for example, if the downlink CSI-RS and SS/PBCH blocks are spatially QCLed and resource elements associated with the downlink CSI-RS are outside of PRBs configured for the SS/PBCH blocks.

Downlink DM-RSs may be sent/transmitted by a base station and received/used by a wireless device for a channel estimation. The downlink DM-RSs may be used for coherent demodulation of one or more downlink physical channels (e.g., PDSCH). A network (e.g., an NR network) may support one or more variable and/or configurable DM-RS patterns for data demodulation. At least one downlink DM-RS configuration may support a front-loaded DM-RS pattern. A front-loaded DM-RS may be mapped over one or more OFDM symbols (e.g., one or two adjacent OFDM symbols). A base station may semi-statically configure the wireless device with a quantity/number (e.g. a maximum quantity/number) of front-loaded DM-RS symbols for a PDSCH. A DM-RS configuration may support one or more DM-RS ports. A DM-RS configuration may support up to eight orthogonal downlink DM-RS ports per wireless device (e.g., for single user-MIMO).A DM-RS configuration may support up to 4 orthogonal downlink DM-RS ports per wireless device (e.g., for multiuser-MIMO). A radio network may support (e.g., at least for CP-OFDM) a common DM-RS structure for downlink and uplink. A DM-RS location, a DM-RS pattern, and/or a scrambling sequence may be the same or different. The base station may send/transmit a downlink DM-RS and a corresponding PDSCH, for example, using the same precoding matrix. The wireless device may use the one or more downlink DM-RSs for coherent demodulation/channel estimation of the PDSCH.

A transmitter (e.g., a transmitter of a base station) may use a precoder matrices for a part of a transmission bandwidth. The transmitter may use a first precoder matrix for a first bandwidth and a second precoder matrix for a second bandwidth. The first precoder matrix and the second precoder matrix may be different, for example, based on the first bandwidth being different from the second bandwidth. The wireless device may assume that a same precoding matrix is used across set of PRBs. The set of PRBs may a be determined/indicated/identified/denoted as a precoding resource block group (PRG).

A PDSCH may comprise one or more layers. The wireless device may assume that at least one symbol with DM-RS is present on a layer of the one or more layers of the PDSCH. A higher layer may configure one or more DM-RSs for a PDSCH (e.g., up to 3 DM-RSs for the PDSCH). Downlink PT-RS may be sent/transmitted by a base station and used by a wireless device, for example, for a phase-noise compensation. Whether a downlink PT-RS is present or not may depend on an RRC configuration. The presence and/or the pattern of the downlink PT-RS may be configured on a wireless device-specific basis, for example, using a combination of RRC signaling and/or an association with one or more parameters used/employed for other purposes (e.g., modulation and coding scheme (MCS)), which may be indicated by DCI. A dynamic presence of a downlink PT-RS, if configured, may be associated with one or more DCI parameters comprising at least MCS. A network (e.g., an NR network) may support a plurality of PT-RS densities defined in the time and/or frequency domains. A frequency domain density (if configured/present) may be associated with at least one configuration of a scheduled bandwidth. The wireless device may assume a same precoding for a DM-RS port and a PT-RS port. The quantity/number of PT-RS ports may be fewer than the quantity/number of DM-RS ports in a scheduled resource. Downlink PT-RS may be configured/allocated/confined in the scheduled time/frequency duration for the wireless device. Downlink PT-RS may be sent/transmitted via symbols, for example, to facilitate a phase tracking at the receiver.

The wireless device may send/transmit an uplink DM-RS to a base station, for example, for a channel estimation. The base station may use the uplink DM-RS for coherent demodulation of one or more uplink physical channels. The wireless device may send/transmit an uplink DM-RS with a PUSCH and/or a PUCCH. The uplink DM-RS may span a range of frequencies that is similar to a range of frequencies associated with the corresponding physical channel. The base station may configure the wireless device with one or more uplink DM-RS configurations. At least one DM-RS configuration may support a front-loaded DM-RS pattern. The front-loaded DM-RS may be mapped over one or more OFDM symbols (e.g., one or two adjacent OFDM symbols). One or more uplink DM-RSs may be configured to send/transmit at one or more symbols of a PUSCH and/or a PUCCH. The base station may semi-statically configure the wireless device with a quantity/number (e.g., the maximum quantity/number) of front-loaded DM-RS symbols for the PUSCH and/or the PUCCH, which the wireless device may use to schedule a single-symbol DM-RS and/or a double-symbol DM-RS. A network (e.g., an NR network) may support (e.g., for cyclic prefix orthogonal frequency division multiplexing (CP-OFDM)) a common DM-RS structure for downlink and uplink. A DM-RS location, a DM-RS pattern, and/or a scrambling sequence for the DM-RS may be substantially the same or different.

A PUSCH may comprise one or more layers. A wireless device may send/transmit at least one symbol with DM-RS present on a layer of the one or more layers of the PUSCH. A higher layer may configure one or more DM-RSs (e.g., up to three DM-RSs) for the PUSCH. Uplink PT-RS (which may be used by a base station for a phase tracking and/or a phase-noise compensation) may or may not be present, for example, depending on an RRC configuration of the wireless device. The presence and/or the pattern of an uplink PT-RS may be configured on a wireless device-specific basis (e.g., a UE-specific basis), for example, by a combination of RRC signaling and/or one or more parameters configured/employed for other purposes (e.g., MCS), which may be indicated by DCI. A dynamic presence of an uplink PT-RS, if configured, may be associated with one or more DCI parameters comprising at least MCS. A radio network may support a plurality of uplink PT-RS densities defined in time/frequency domain. A frequency domain density (if configured/present) may be associated with at least one configuration of a scheduled bandwidth. The wireless device may assume a same precoding for a DM-RS port and a PT-RS port. A quantity/number of PT-RS ports may be less than a quantity/number of DM-RS ports in a scheduled resource. An uplink PT-RS may be configured/allocated/confined in the scheduled time/frequency duration for the wireless device.

One or more SRSs may be sent/transmitted by a wireless device to a base station, for example, for a channel state estimation to support uplink channel dependent scheduling and/or a link adaptation. SRS sent/transmitted by the wireless device may enable/allow a base station to estimate an uplink channel state at one or more frequencies. A scheduler at the base station may use/employ the estimated uplink channel state to assign one or more resource blocks for an uplink PUSCH transmission for the wireless device. The base station may semi-statically configure the wireless device with one or more SRS resource sets. For an SRS resource set, the base station may configure the wireless device with one or more SRS resources. An SRS resource set applicability may be configured, for example, by a higher layer (e.g., RRC) parameter. An SRS resource in an SRS resource set of the one or more SRS resource sets (e.g., with the same/similar time domain behavior, periodic, aperiodic, and/or the like) may be sent/transmitted at a time instant (e.g., simultaneously), for example, if a higher layer parameter indicates beam management. The wireless device may send/transmit one or more SRS resources in SRS resource sets. A network (e.g., an NR network) may support aperiodic, periodic, and/or semi-persistent SRS transmissions. The wireless device may send/transmit SRS resources, for example, based on one or more trigger types. The one or more trigger types may comprise higher layer signaling (e.g., RRC) and/or one or more DCI formats. At least one DCI format may be used/employed for the wireless device to select at least one of one or more configured SRS resource sets. An SRS trigger type 0 may refer to an SRS triggered based on higher layer signaling. An SRS trigger type 1 may refer to an SRS triggered based on one or more DCI formats. The wireless device may be configured to send/transmit an SRS, for example, after a transmission of a PUSCH and a corresponding uplink DM-RS if a PUSCH and an SRS are sent/transmitted in a same slot. A base station may semi-statically configure a wireless device with one or more SRS configuration parameters indicating at least one of following: an SRS resource configuration identifier; a quantity/number of SRS ports; time domain behavior of an SRS resource configuration (e.g., an indication of periodic, semi-persistent, or aperiodic SRS); slot, mini-slot, and/or subframe level periodicity; an offset for a periodic and/or an aperiodic SRS resource; a quantity/number of OFDM symbols in an SRS resource; a starting OFDM symbol of an SRS resource; an SRS bandwidth; a frequency hopping bandwidth; a cyclic shift; and/or an SRS sequence ID.

An antenna port may be determined/defined such that the channel over which a symbol on the antenna port is conveyed can be inferred from the channel over which another symbol on the same antenna port is conveyed. The receiver may infer/determine the channel (e.g., fading gain, multipath delay, and/or the like) for conveying a second symbol on an antenna port, from the channel for conveying a first symbol on the antenna port, for example, if the first symbol and the second symbol are sent/transmitted on the same antenna port. A first antenna port and a second antenna port may be referred to as quasi co-located (QCLed), for example, if one or more large-scale properties of the channel over which a first symbol on the first antenna port is conveyed may be inferred from the channel over which a second symbol on a second antenna port is conveyed. The one or more large-scale properties may comprise at least one of: a delay spread; a Doppler spread; a Doppler shift; an average gain; an average delay; and/or spatial Receiving (Rx) parameters.

Channels that use beamforming may require beam management. Beam management may comprise a beam measurement, a beam selection, and/or a beam indication. A beam may be associated with one or more reference signals. A beam may be identified by one or more beamformed reference signals. The wireless device may perform a downlink beam measurement, for example, based on one or more downlink reference signals (e.g., a CSI-RS) and generate a beam measurement report. The wireless device may perform the downlink beam measurement procedure, for example, after an RRC connection is set up with a base station.

FIG. 11B shows an example mapping of one or more CSI-RSs. The CSI-RSs may be mapped in the time and frequency domains. Each rectangular block shown in FIG. 11B may correspond to a resource block (RB) within a bandwidth of a cell. A base station may send/transmit one or more RRC messages comprising CSI-RS resource configuration parameters indicating one or more CSI-RSs. One or more of parameters may be configured by higher layer signaling (e.g., RRC and/or MAC signaling) for a CSI-RS resource configuration. The one or more of the parameters may comprise at least one of: a CSI-RS resource configuration identity, a quantity/number of CSI-RS ports, a CSI-RS configuration (e.g., symbol and resource element (RE) locations in a subframe), a CSI-RS subframe configuration (e.g., a subframe location, an offset, and periodicity in a radio frame), a CSI-RS power parameter, a CSI-RS sequence parameter, a code division multiplexing (CDM) type parameter, a frequency density, a transmission comb, quasi co-location (QCL) parameters (e.g., QCL-scramblingidentity, crs-portscount, mbsfn-subframeconfiglist, csi-rs-configZPid, qcl-csi-rs-configNZPid), and/or other radio resource parameters.

One or more beams may be configured for a wireless device in a wireless device-specific configuration. Three beams are shown in FIG. 11B (beam #1, beam #2, and beam #3), but more or fewer beams may be configured. Beam #1 may be allocated with CSI-RS 1101 that may be sent/transmitted in one or more subcarriers in an RB of a first symbol. Beam #2 may be allocated with CSI-RS 1102 that may be sent/transmitted in one or more subcarriers in an RB of a second symbol. Beam #3 may be allocated with CSI-RS 1103 that may be sent/transmitted in one or more subcarriers in an RB of a third symbol. A base station may use other subcarriers in the same RB (e.g., those that are not used to send/transmit CSI-RS 1101) to transmit another CSI-RS associated with a beam for another wireless device, for example, by using frequency division multiplexing (FDM). Beams used for a wireless device may be configured such that beams for the wireless device use symbols different from symbols used by beams of other wireless devices, for example, by using time domain multiplexing (TDM). A wireless device may be served with beams in orthogonal symbols (e.g., no overlapping symbols), for example, by using the TDM.

CSI-RSs (e.g., CSI-RSs 1101, 1102, 1103) may be sent/transmitted by the base station and used by the wireless device for one or more measurements. The wireless device may measure an RSRP of configured CSI-RS resources. The base station may configure the wireless device with a reporting configuration, and the wireless device may report the RSRP measurements to a network (e.g., via one or more base stations) based on the reporting configuration. The base station may determine, based on the reported measurement results, one or more transmission configuration indication/indicator (TCI) states comprising a quantity/number of reference signals. The base station may indicate one or more TCI states to the wireless device (e.g., via RRC signaling, a MAC CE, and/or DCI). The wireless device may receive a downlink transmission with an Rx beam determined based on the one or more TCI states. The wireless device may or may not have a capability of beam correspondence. The wireless device may determine a spatial domain filter of a transmit (Tx) beam, for example, based on a spatial domain filter of the corresponding Rx beam, if the wireless device has the capability of beam correspondence. The wireless device may perform an uplink beam selection procedure to determine the spatial domain filter of the Tx beam, for example, if the wireless device does not have the capability of beam correspondence. The wireless device may perform the uplink beam selection procedure, for example, based on one or more sounding reference signal (SRS) resources configured to the wireless device by the base station. The base station may select and indicate uplink beams for the wireless device, for example, based on measurements of the one or more SRS resources sent/transmitted by the wireless device.

A wireless device may determine/assess (e.g., measure) a channel quality of one or more beam pair links, for example, in a beam management procedure. A beam pair link may comprise a Tx beam of a base station and an Rx beam of the wireless device. The Tx beam of the base station may send/transmit a downlink signal, and the Rx beam of the wireless device may receive the downlink signal. The wireless device may send/transmit a beam measurement report, for example, based on the assessment/determination. The beam measurement report may indicate one or more beam pair quality parameters comprising at least one of: one or more beam identifications (e.g., a beam index, a reference signal index, or the like), an RSRP, a precoding matrix indicator (PMI), a channel quality indicator (CQI), and/or a rank indicator (RI).

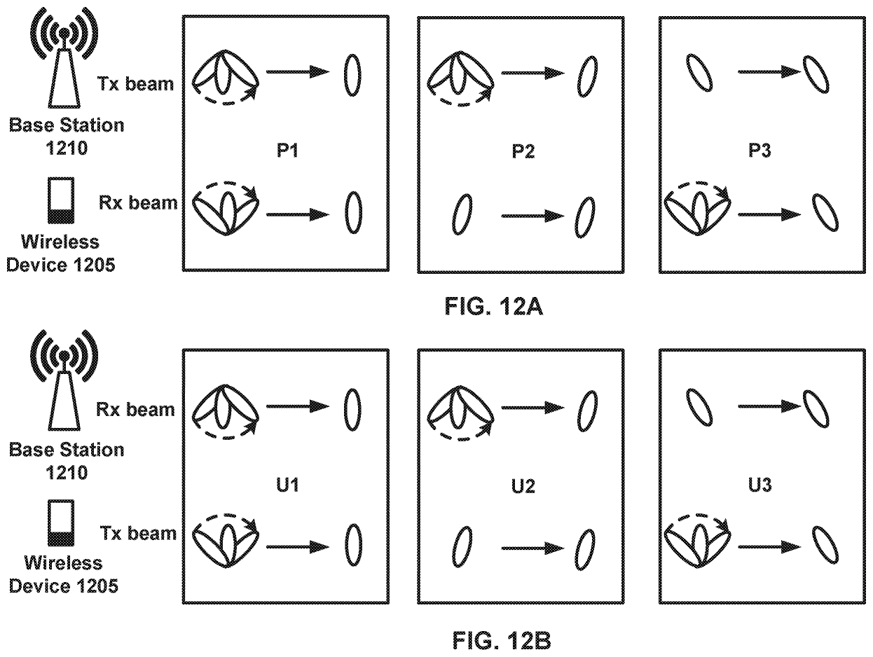

FIG. 12A shows examples of downlink beam management procedures. One or more downlink beam management procedures (e.g., downlink beam management procedures P1, P2, and P3) may be performed. Procedure P1 may enable a measurement (e.g., a wireless device measurement) on Tx beams of a TRP (or multiple TRPs) (e.g., to support a selection of one or more base station Tx beams and/or wireless device Rx beams). The Tx beams of a base station (e.g., base station 1210) and the Rx beams of a wireless device (e.g., wireless device 1205) are shown as ovals in the top row of P1 and bottom row of P1, respectively. Beamforming (e.g., at a TRP) may comprise a Tx beam sweep for a set of beams (e.g., the beam sweeps shown, in the top rows of P1 and P2, as ovals rotated in a counter-clockwise direction indicated by the dashed arrows). Beamforming (e.g., at a wireless device) may comprise an Rx beam sweep for a set of beams (e.g., the beam sweeps shown, in the bottom rows of P1 and P3, as ovals rotated in a clockwise direction indicated by the dashed arrows). Procedure P2 may be used to enable a measurement (e.g., a wireless device measurement) on Tx beams of a TRP (shown, in the top row of P2, as ovals rotated in a counter-clockwise direction indicated by the dashed arrow). The wireless device and/or the base station may perform procedure P2, for example, using a smaller set of beams than the set of beams used in procedure P1, or using narrower beams than the beams used in procedure P1. Procedure P2 may be referred to as a beam refinement. The wireless device may perform procedure P3 for an Rx beam determination, for example, by using the same Tx beam(s) of the base station and sweeping Rx beam(s) of the wireless device.

FIG. 12B shows examples of uplink beam management procedures. One or more uplink beam management procedures (e.g., uplink beam management procedures U1, U2, and U3) may be performed. Procedure U1 may be used to enable a base station (e.g., base station 1210) to perform a measurement on Tx beams of a wireless device (e.g., wireless device 1205) (e.g., to support a selection of one or more Tx beams of the wireless device and/or Rx beams of the base station). The Tx beams of the wireless device and the Rx beams of the base station are shown as ovals in the top row of U1 and bottom row of U1, respectively). Beamforming (e.g., at the wireless device) may comprise one or more beam sweeps, for example, a Tx beam sweep from a set of beams (shown, in the bottom rows of U1 and U3, as ovals rotated in a clockwise direction indicated by the dashed arrows). Beamforming (e.g., at the base station) may comprise one or more beam sweeps, for example, an Rx beam sweep from a set of beams (shown, in the top rows of U1 and U2, as ovals rotated in a counter-clockwise direction indicated by the dashed arrows). Procedure U2 may be used to enable the base station to adjust its Rx beam, for example, if the wireless device (e.g., UE) uses a fixed Tx beam. The wireless device and/or the base station may perform procedure U2, for example, using a smaller set of beams than the set of beams used in procedure P1, or using narrower beams than the beams used in procedure P1. Procedure U2 may be referred to as a beam refinement. The wireless device may perform procedure U3 to adjust its Tx beam, for example, if the base station uses a fixed Rx beam.

A wireless device may initiate/start/perform a beam failure recovery (BFR) procedure, for example, based on detecting a beam failure. The wireless device may send/transmit a BFR request (e.g., a preamble, UCI, an SR, a MAC CE, and/or the like), for example, based on the initiating the BFR procedure. The wireless device may detect the beam failure, for example, based on a determination that a quality of beam pair link(s) of an associated control channel is unsatisfactory (e.g., having an error rate higher than an error rate threshold, a received signal power lower than a received signal power threshold, an expiration of a timer, and/or the like).

The wireless device may measure a quality of a beam pair link, for example, using one or more reference signals (RSs) comprising one or more SS/PBCH blocks, one or more CSI-RS resources, and/or one or more DM-RSs. A quality of the beam pair link may be based on one or more of a block error rate (BLER), an RSRP value, a signal to interference plus noise ratio (SINR) value, an RSRQ value, and/or a CSI value measured on RS resources. The base station may indicate that an RS resource is QCLed with one or more DM-RSs of a channel (e.g., a control channel, a shared data channel, and/or the like). The RS resource and the one or more DM-RSs of the channel may be QCLed, for example, if the channel characteristics (e.g., Doppler shift, Doppler spread, an average delay, delay spread, a spatial Rx parameter, fading, and/or the like) from a transmission via the RS resource to the wireless device are similar or the same as the channel characteristics from a transmission via the channel to the wireless device.

A network (e.g., an NR network comprising a gNB and/or an ng-eNB) and/or the wireless device may initiate/start/perform a random access procedure. A wireless device in an RRC idle (e.g., an RRC_IDLE) state and/or an RRC inactive (e.g., an RRC_INACTIVE) state may initiate/perform the random access procedure to request a connection setup to a network. The wireless device may initiate/start/perform the random access procedure from an RRC connected (e.g., an RRC_CONNECTED) state. The wireless device may initiate/start/perform the random access procedure to request uplink resources (e.g., for uplink transmission of an SR if there is no PUCCH resource available) and/or acquire/obtain/determine an uplink timing (e.g., if an uplink synchronization status is non-synchronized). The wireless device may initiate/start/perform the random access procedure to request one or more system information blocks (SIBs) (e.g., other system information blocks, such as SIB2, SIB3, and/or the like). The wireless device may initiate/start/perform the random access procedure for a beam failure recovery request. A network may initiate/start/perform a random access procedure, for example, for a handover and/or for establishing time alignment for an SCell addition.

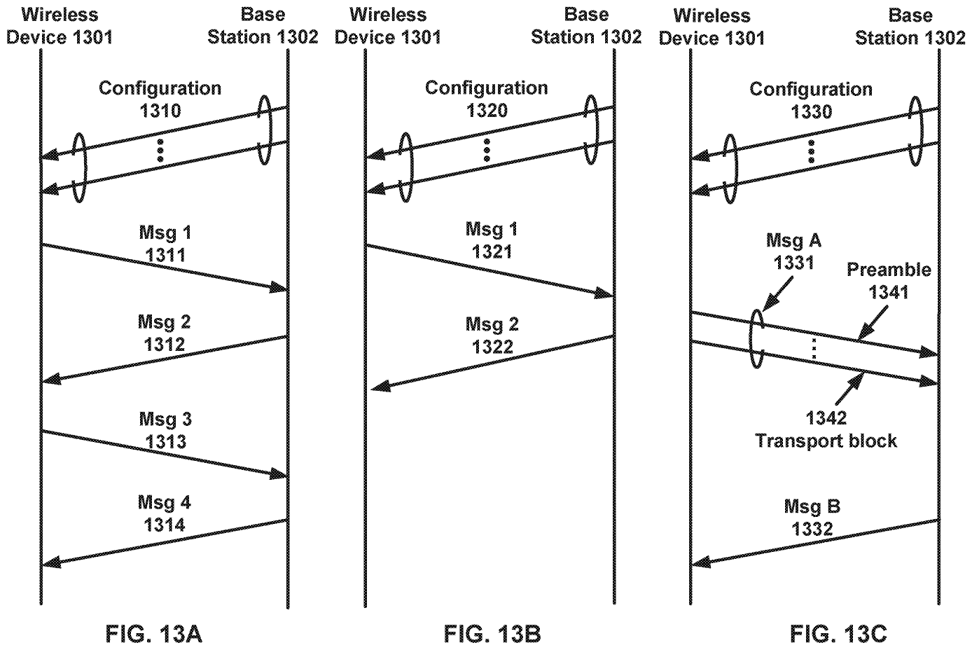

FIG. 13A shows an example four-step random access procedure. The four-step random access procedure may comprise a four-step contention-based random access procedure. A base station (e.g., base station 1302) may send/transmit a configuration message 1310 to a wireless device (e.g., wireless device 1301), for example, before initiating the random access procedure. The four-step random access procedure may comprise transmissions of four messages comprising: a first message (e.g., Msg 1 1311), a second message (e.g., Msg 2 1312), a third message (e.g., Msg 3 1313), and a fourth message (e.g., Msg 4 1314). The first message (e.g., Msg 1 1311) may comprise a preamble (or a random access preamble). The first message (e.g., Msg 1 1311) may be referred to as a preamble. The second message (e.g., Msg 2 1312) may comprise as a random access response (RAR). The second message (e.g., Msg 2 1312) may be referred to as an RAR.

The configuration message 1310 may be sent/transmitted, for example, using one or more RRC messages. The one or more RRC messages may indicate one or more random access channel (RACH) parameters to the wireless device. The one or more RACH parameters may comprise at least one of: general parameters for one or more random access procedures (e.g., RACH-configGeneral); cell-specific parameters (e.g., RACH-ConfigCommon); and/or dedicated parameters (e.g., RACH-configDedicated). The base station may send/transmit (e.g., broadcast or multicast) the one or more RRC messages to one or more wireless devices. The one or more RRC messages may be wireless device-specific. The one or more RRC messages that are wireless device-specific may be, for example, dedicated RRC messages sent/transmitted to a wireless device in an RRC connected (e.g., an RRC_CONNECTED) state and/or in an RRC inactive (e.g., an RRC_INACTIVE) state. The wireless devices may determine, based on the one or more RACH parameters, a time-frequency resource and/or an uplink transmit power for transmission of the first message (e.g., Msg 1 1311) and/or the third message (e.g., Msg 3 1313). The wireless device may determine a reception timing and a downlink channel for receiving the second message (e.g., Msg 2 1312) and the fourth message (e.g., Msg 4 1314), for example, based on the one or more RACH parameters.

The one or more RACH parameters provided/configured/comprised in the configuration message 1310 may indicate one or more Physical RACH (PRACH) occasions available for transmission of the first message (e.g., Msg 1 1311). The one or more PRACH occasions may be predefined (e.g., by a network comprising one or more base stations). The one or more RACH parameters may indicate one or more available sets of one or more PRACH occasions (e.g., prach-ConfigIndex). The one or more RACH parameters may indicate an association between (a) one or more PRACH occasions and (b) one or more reference signals. The one or more RACH parameters may indicate an association between (a) one or more preambles and (b) one or more reference signals. The one or more reference signals may be SS/PBCH blocks and/or CSI-RSs. The one or more RACH parameters may indicate a quantity/number of SS/PBCH blocks mapped to a PRACH occasion and/or a quantity/number of preambles mapped to a SS/PBCH blocks.

The one or more RACH parameters provided/configured/comprised in the configuration message 1310 may be used to determine an uplink transmit power of first message (e.g., Msg 1 1311) and/or third message (e.g., Msg 3 1313). The one or more RACH parameters may indicate a reference power for a preamble transmission (e.g., a received target power and/or an initial power of the preamble transmission). There may be one or more power offsets indicated by the one or more RACH parameters. The one or more RACH parameters may indicate: a power ramping step; a power offset between SSB and CSI-RS; a power offset between transmissions of the first message (e.g., Msg 1 1311) and the third message (e.g., Msg 3 1313); and/or a power offset value between preamble groups. The one or more RACH parameters may indicate one or more thresholds, for example, based on which the wireless device may determine at least one reference signal (e.g., an SSB and/or CSI-RS) and/or an uplink carrier (e.g., a normal uplink (NUL) carrier and/or a supplemental uplink (SUL) carrier).

The first message (e.g., Msg 1 1311) may comprise one or more preamble transmissions (e.g., a preamble transmission and one or more preamble retransmissions). An RRC message may be used to configure one or more preamble groups (e.g., group A and/or group B). A preamble group may comprise one or more preambles. The wireless device may determine the preamble group, for example, based on a pathloss measurement and/or a size of the third message (e.g., Msg 3 1313). The wireless device may measure an RSRP of one or more reference signals (e.g., SSBs and/or CSI-RSs) and determine at least one reference signal having an RSRP above an RSRP threshold (e.g., rsrp-ThresholdSSB and/or rsrp-ThresholdCSI-RS). The wireless device may select at least one preamble associated with the one or more reference signals and/or a selected preamble group, for example, if the association between the one or more preambles and the at least one reference signal is configured by an RRC message.

The wireless device may determine the preamble, for example, based on the one or more RACH parameters provided/configured/comprised in the configuration message 1310. The wireless device may determine the preamble, for example, based on a pathloss measurement, an RSRP measurement, and/or a size of the third message (e.g., Msg 3 1313). The one or more RACH parameters may indicate: a preamble format; a maximum quantity/number of preamble transmissions; and/or one or more thresholds for determining one or more preamble groups (e.g., group A and group B). A base station may use the one or more RACH parameters to configure the wireless device with an association between one or more preambles and one or more reference signals (e.g., SSBs and/or CSI-RSs). The wireless device may determine the preamble to be comprised in first message (e.g., Msg 1 1311), for example, based on the association if the association is configured. The first message (e.g., Msg 1 1311) may be sent/transmitted to the base station via one or more PRACH occasions. The wireless device may use one or more reference signals (e.g., SSBs and/or CSI-RSs) for selection of the preamble and for determining of the PRACH occasion. One or more RACH parameters (e.g., ra-ssb-OccasionMskIndex and/or ra-OccasionList) may indicate an association between the PRACH occasions and the one or more reference signals.

The wireless device may perform a preamble retransmission, for example, if no response is received based on (e.g., after or in response to) a preamble transmission (e.g., for a period of time, such as a monitoring window for monitoring an RAR). The wireless device may increase an uplink transmit power for the preamble retransmission. The wireless device may select an initial preamble transmit power, for example, based on a pathloss measurement and/or a target received preamble power configured by the network. The wireless device may determine to resend/retransmit a preamble and may ramp up the uplink transmit power. The wireless device may receive one or more RACH parameters (e.g., PREAMBLE_POWER_RAMPING_STEP) indicating a ramping step for the preamble retransmission. The ramping step may be an amount of incremental increase in uplink transmit power for a retransmission. The wireless device may ramp up the uplink transmit power, for example, if the wireless device determines a reference signal (e.g., SSB and/or CSI-RS) that is the same as a previous preamble transmission. The wireless device may count the quantity/number of preamble transmissions and/or retransmissions, for example, using a counter parameter (e.g., PREAMBLE_TRANSMISSION_COUNTER). The wireless device may determine that a random access procedure has been completed unsuccessfully, for example, if the quantity/number of preamble transmissions exceeds a threshold configured by the one or more RACH parameters (e.g., preambleTransMax) without receiving a successful response (e.g., an RAR).

The second message (e.g., Msg 2 1312) (e.g., received by the wireless device) may comprise an RAR. The second message (e.g., Msg 2 1312) may comprise multiple RARs corresponding to multiple wireless devices. The second message (e.g., Msg 2 1312) may be received, for example, based on (e.g., after or in response to) the sending/transmitting of the first message (e.g., Msg 1 1311). The second message (e.g., Msg 2 1312) may be scheduled on the DL-SCH and may be indicated by a PDCCH, for example, using a random access radio network temporary identifier (RA RNTI). The second message (e.g., Msg 2 1312) may indicate that the first message (e.g., Msg 1 1311) was received by the base station. The second message (e.g., Msg 2 1312) may comprise a time-alignment command that may be used by the wireless device to adjust the transmission timing of the wireless device, a scheduling grant for transmission of the third message (e.g., Msg 3 1313), and/or a Temporary Cell RNTI (TC-RNTI). The wireless device may determine/start a time window (e.g., ra-ResponseWindow) to monitor a PDCCH for the second message (e.g., Msg 2 1312), for example, after sending/transmitting the first message (e.g., Msg 1 1311) (e.g., a preamble). The wireless device may determine the start time of the time window, for example, based on a PRACH occasion that the wireless device uses to send/transmit the first message (e.g., Msg 1 1311) (e.g., the preamble). The wireless device may start the time window one or more symbols after the last symbol of the first message (e.g., Msg 1 1311) comprising the preamble (e.g., the symbol in which the first message (e.g., Msg 1 1311) comprising the preamble transmission was completed or at a first PDCCH occasion from an end of a preamble transmission). The one or more symbols may be determined based on a numerology. The PDCCH may be mapped in a common search space (e.g., a Type1-PDCCH common search space) configured by an RRC message. The wireless device may identify/determine the RAR, for example, based on an RNTI. Radio network temporary identifiers (RNTIs) may be used depending on one or more events initiating/starting the random access procedure. The wireless device may use a RA-RNTI, for example, for one or more communications associated with random access or any other purpose. The RA-RNTI may be associated with PRACH occasions in which the wireless device sends/transmits a preamble. The wireless device may determine the RA-RNTI, for example, based on at least one of: an OFDM symbol index; a slot index; a frequency domain index; and/or a UL carrier indicator of the PRACH occasions. An example RA-RNTI may be determined as follows:

$$RA - RNTI = 1 + s\_id + 14 \times t\_id + 14 \times 80 \times f\_id + 14 \times 80 \times 8 \times ul\_carrier \_id$$

where s_id may be an index of a first OFDM symbol of the PRACH occasion (e.g., 0≤s_id<14), t_id may be an index of a first slot of the PRACH occasion in a system frame (e.g., 0≤t_id<80), f_id may be an index of the PRACH occasion in the frequency domain (e.g., 0≤f_id<8), and ul_carrier_id may be a UL carrier used for a preamble transmission (e.g., 0 for an NUL carrier, and 1 for an SUL carrier).

The wireless device may send/transmit the third message (e.g., Msg 3 1313), for example, based on (e.g., after or in response to) a successful reception of the second message (e.g., Msg 2 1312) (e.g., using resources identified in the Msg 2 1312). The third message (e.g., Msg 3 1313) may be used, for example, for contention resolution in the contention-based random access procedure. A plurality of wireless devices may send/transmit the same preamble to a base station, and the base station may send/transmit an RAR that corresponds to a wireless device. Collisions may occur, for example, if the plurality of wireless device interpret the RAR as corresponding to themselves. Contention resolution (e.g., using the third message (e.g., Msg 3 1313) and the fourth message (e.g., Msg 4 1314)) may be used to increase the likelihood that the wireless device does not incorrectly use an identity of another the wireless device. The wireless device may comprise a device identifier in the third message (e.g., Msg 3 1313) (e.g., a C-RNTI if assigned, a TC RNTI comprised in the second message (e.g., Msg 2 1312), and/or any other suitable identifier), for example, to perform contention resolution.

The fourth message (e.g., Msg 4 1314) may be received, for example, based on (e.g., after or in response to) the sending/transmitting of the third message (e.g., Msg 3 1313). The base station may address the wireless on the PDCCH (e.g., the base station may send the PDCCH to the wireless device) using a C-RNTI, for example, If the C-RNTI was included in the third message (e.g., Msg 3 1313). The random access procedure may be determined to be successfully completed, for example, if the unique C RNTI of the wireless device is detected on the PDCCH (e.g., the PDCCH is scrambled by the C-RNTI). fourth message (e.g., Msg 4 1314) may be received using a DL-SCH associated with a TC RNTI, for example, if the TC RNTI is comprised in the third message (e.g., Msg 3 1313) (e.g., if the wireless device is in an RRC idle (e.g., an RRC_IDLE) state or not otherwise connected to the base station). The wireless device may determine that the contention resolution is successful and/or the wireless device may determine that the random access procedure is successfully completed, for example, if a MAC PDU is successfully decoded and a MAC PDU comprises the wireless device contention resolution identity MAC CE that matches or otherwise corresponds with the CCCH SDU sent/transmitted in third message (e.g., Msg 3 1313).

The wireless device may be configured with an SUL carrier and/or an NUL carrier. An initial access (e.g., random access) may be supported via an uplink carrier. A base station may configure the wireless device with multiple RACH configurations (e.g., two separate RACH configurations comprising: one for an SUL carrier and the other for an NUL carrier). For random access in a cell configured with an SUL carrier, the network may indicate which carrier to use (NUL or SUL). The wireless device may determine to use the SUL carrier, for example, if a measured quality of one or more reference signals (e.g., one or more reference signals associated with the NUL carrier) is lower than a broadcast threshold. Uplink transmissions of the random access procedure (e.g., the first message (e.g., Msg 1 1311) and/or the third message (e.g., Msg 3 1313)) may remain on, or may be performed via, the selected carrier. The wireless device may switch an uplink carrier during the random access procedure (e.g., between the Msg 1 1311 and the Msg 3 1313). The wireless device may determine and/or switch an uplink carrier for the first message (e.g., Msg 1 1311) and/or the third message (e.g., Msg 3 1313), for example, based on a channel clear assessment (e.g., a listen-before-talk).

FIG. 13B shows a two-step random access procedure. The two-step random access procedure may comprise a two-step contention-free random access procedure. Similar to the four-step contention-based random access procedure, a base station (e.g., base station 1302) may, prior to initiation of the procedure, send/transmit a configuration message 1320 to the wireless device (e.g., wireless device 1301). The configuration message 1320 may be analogous in some respects to the configuration message 1310. The procedure shown in FIG. 13B may comprise transmissions of two messages: a first message (e.g., Msg 1 1321) and a second message (e.g., Msg 2 1322). The first message (e.g., Msg 1 1321) and the second message (e.g., Msg 2 1322) may be analogous in some respects to the first message (e.g., Msg 1 1311) and a second message (e.g., Msg 2 1312), respectively. The two-step contention-free random access procedure may not comprise messages analogous to the third message (e.g., Msg 3 1313) and/or the fourth message (e.g., Msg 4 1314).

The two-step (e.g., contention-free) random access procedure may be configured/initiated for a beam failure recovery, other SI request, an SCell addition, and/or a handover. A base station may indicate, or assign to, the wireless device a preamble to be used for the first message (e.g., Msg 1 1321). The wireless device may receive, from the base station via a PDCCH and/or an RRC, an indication of the preamble (e.g., ra-PreambleIndex).

The wireless device may start a time window (e.g., ra-ResponseWindow) to monitor a PDCCH for the RAR, for example, based on (e.g., after or in response to) sending/transmitting the preamble. The base station may configure the wireless device with one or more beam failure recovery parameters, such as a separate time window and/or a separate PDCCH in a search space indicated by an RRC message (e.g., recoverySearchSpaceId). The base station may configure the one or more beam failure recovery parameters, for example, in association with a beam failure recovery request. The separate time window for monitoring the PDCCH and/or an RAR may be configured to start after sending/transmitting a beam failure recovery request (e.g., the window may start any quantity of symbols and/or slots after sending/transmitting the beam failure recovery request). The wireless device may monitor for a PDCCH transmission addressed to a Cell RNTI (C-RNTI) on the search space. During the two-step (e.g., contention-free) random access procedure, the wireless device may determine that a random access procedure is successful, for example, based on (e.g., after or in response to) sending/transmitting first message (e.g., Msg 1 1321) and receiving a corresponding second message (e.g., Msg 2 1322). The wireless device may determine that a random access procedure has successfully been completed, for example, if a PDCCH transmission is addressed to a corresponding C-RNTI. The wireless device may determine that a random access procedure has successfully been completed, for example, if the wireless device receives an RAR comprising a preamble identifier corresponding to a preamble sent/transmitted by the wireless device and/or the RAR comprises a MAC sub-PDU with the preamble identifier. The wireless device may determine the response as an indication of an acknowledgement for an SI request.

FIG. 13C shows an example two-step random access procedure. Similar to the random access procedures shown in FIGS. 13A and 13B, a base station (e.g., base station 1302) may, prior to initiation of the procedure, send/transmit a configuration message 1330 to the wireless device (e.g., wireless device 1301). The configuration message 1330 may be analogous in some respects to the configuration message 1310 and/or the configuration message 1320. The procedure shown in FIG. 13C may comprise transmissions of multiple messages (e.g., two messages comprising: a first message (e.g., Msg A 1331) and a second message (e.g., Msg B 1332)).

Msg A 1320 may be sent/transmitted in an uplink transmission by the wireless device. Msg A 1320 may comprise one or more transmissions of a preamble 1341 and/or one or more transmissions of a transport block 1342. The transport block 1342 may comprise contents that are similar and/or equivalent to the contents of the third message (e.g., Msg 3 1313) (e.g., shown in FIG. 13A). The transport block 1342 may comprise UCI (e.g., an SR, a HARQ ACK/NACK, and/or the like). The wireless device may receive the second message (e.g., Msg B 1332), for example, based on (e.g., after or in response to) sending/transmitting the first message (e.g., Msg A 1331). The second message (e.g., Msg B 1332) may comprise contents that are similar and/or equivalent to the contents of the second message (e.g., Msg 2 1312) (e.g., an RAR shown in FIGS. 13A), the contents of the second message (e.g., Msg 2 1322) (e.g., an RAR shown in FIG. 13B) and/or the fourth message (e.g., Msg 4 1314) (e.g., shown in FIG. 13A).

The wireless device may start/initiate the two-step random access procedure (e.g., the two-step random access procedure shown in FIG. 13C) for a licensed spectrum and/or an unlicensed spectrum. The wireless device may determine, based on one or more factors, whether to start/initiate the two-step random access procedure. The one or more factors may comprise at least one of: a radio access technology in use (e.g., LTE, NR, and/or the like); whether the wireless device has a valid TA or not; a cell size; the RRC state of the wireless device; a type of spectrum (e.g., licensed vs. unlicensed); and/or any other suitable factors.

The wireless device may determine, based on two-step RACH parameters comprised in the configuration message 1330, a radio resource and/or an uplink transmit power for the preamble 1341 and/or the transport block 1342 (e.g., comprised in the first message (e.g., Msg A 1331)). The RACH parameters may indicate an MCS, a time-frequency resource, and/or a power control for the preamble 1341 and/or the transport block 1342. A time-frequency resource for transmission of the preamble 1341 (e.g., a PRACH) and a time-frequency resource for transmission of the transport block 1342 (e.g., a PUSCH) may be multiplexed using FDM, TDM, and/or CDM. The RACH parameters may enable the wireless device to determine a reception timing and a downlink channel for monitoring for and/or receiving second message (e.g., Msg B 1332).

The transport block 1342 may comprise data (e.g., delay-sensitive data), an identifier of the wireless device, security information, and/or device information (e.g., an International Mobile Subscriber Identity (IMSI)). The base station may send/transmit the second message (e.g., Msg B 1332) as a response to the first message (e.g., Msg A 1331). The second message (e.g., Msg B 1332) may comprise at least one of: a preamble identifier; a timing advance command; a power control command; an uplink grant (e.g., a radio resource assignment and/or an MCS); a wireless device identifier (e.g., a UE identifier for contention resolution); and/or an RNTI (e.g., a C-RNTI or a TC-RNTI). The wireless device may determine that the two-step random access procedure is successfully completed, for example, if a preamble identifier in the second message (e.g., Msg B 1332) corresponds to, or is matched to, a preamble sent/transmitted by the wireless device and/or the identifier of the wireless device in second message (e.g., Msg B 1332) corresponds to, or is matched to, the identifier of the wireless device in the first message (e.g., Msg A 1331) (e.g., the transport block 1342).

A wireless device and a base station may exchange control signaling (e.g., control information). The control signaling may be referred to as L1/L2 control signaling and may originate from the PHY layer (e.g., layer 1) and/or the MAC layer (e.g., layer 2) of the wireless device or the base station. The control signaling may comprise downlink control signaling sent/transmitted from the base station to the wireless device and/or uplink control signaling sent/transmitted from the wireless device to the base station.

The downlink control signaling may comprise at least one of: a downlink scheduling assignment; an uplink scheduling grant indicating uplink radio resources and/or a transport format; slot format information; a preemption indication; a power control command; and/or any other suitable signaling. The wireless device may receive the downlink control signaling in a payload sent/transmitted by the base station via a PDCCH. The payload sent/transmitted via the PDCCH may be referred to as downlink control information (DCI). The PDCCH may be a group common PDCCH (GC-PDCCH) that is common to a group of wireless devices. The GC-PDCCH may be scrambled by a group common RNTI.

A base station may attach one or more cyclic redundancy check (CRC) parity bits to DCI, for example, in order to facilitate detection of transmission errors. The base station may scramble the CRC parity bits with an identifier of a wireless device (or an identifier of a group of wireless devices), for example, if the DCI is intended for the wireless device (or the group of the wireless devices). Scrambling the CRC parity bits with the identifier may comprise Modulo-2 addition (or an exclusive-OR operation) of the identifier value and the CRC parity bits. The identifier may comprise a 16-bit value of an RNTI.

DCIs may be used for different purposes. A purpose may be indicated by the type of an RNTI used to scramble the CRC parity bits. DCI having CRC parity bits scrambled with a paging RNTI (P-RNTI) may indicate paging information and/or a system information change notification. The P-RNTI may be predefined as “FFFE” in hexadecimal. DCI having CRC parity bits scrambled with a system information RNTI (SI-RNTI) may indicate a broadcast transmission of the system information. The SI-RNTI may be predefined as “FFFF” in hexadecimal. DCI having CRC parity bits scrambled with a random access RNTI (RA-RNTI) may indicate a random access response (RAR). DCI having CRC parity bits scrambled with a cell RNTI (C-RNTI) may indicate a dynamically scheduled unicast transmission and/or a triggering of PDCCH-ordered random access. DCI having CRC parity bits scrambled with a temporary cell RNTI (TC-RNTI) may indicate a contention resolution (e.g., a Msg 3 analogous to the Msg 3 1313 shown in FIG. 13A). Other RNTIs configured for a wireless device by a base station may comprise a Configured Scheduling RNTI (CS RNTI), a Transmit Power Control-PUCCH RNTI (TPC PUCCH-RNTI), a Transmit Power Control-PUSCH RNTI (TPC-PUSCH-RNTI), a Transmit Power Control-SRS RNTI (TPC-SRS-RNTI), an Interruption RNTI (INT-RNTI), a Slot Format Indication RNTI (SFI-RNTI), a Semi-Persistent CSI RNTI (SP-CSI-RNTI), a Modulation and Coding Scheme Cell RNTI (MCS-C RNTI), and/or the like.

A base station may send/transmit DCIs with one or more DCI formats, for example, depending on the purpose and/or content of the DCIs. DCI format 0_0 may be used for scheduling of a PUSCH in a cell. DCI format 0_0 may be a fallback DCI format (e.g., with compact DCI payloads). DCI format 0_1 may be used for scheduling of a PUSCH in a cell (e.g., with more DCI payloads than DCI format 0_0). DCI format 1_0 may be used for scheduling of a PDSCH in a cell. DCI format 1_0 may be a fallback DCI format (e.g., with compact DCI payloads). DCI format 1_1 may be used for scheduling of a PDSCH in a cell (e.g., with more DCI payloads than DCI format 1_0). DCI format 2_0 may be used for providing a slot format indication to a group of wireless devices. DCI format 2_1 may be used for informing/notifying a group of wireless devices of a physical resource block and/or an OFDM symbol where the group of wireless devices may assume no transmission is intended to the group of wireless devices. DCI format 2_2 may be used for transmission of a transmit power control (TPC) command for PUCCH or PUSCH. DCI format 2_3 may be used for transmission of a group of TPC commands for SRS transmissions by one or more wireless devices. DCI format(s) for new functions may be defined in future releases. DCI formats may have different DCI sizes, or may share the same DCI size.

The base station may process the DCI with channel coding (e.g., polar coding), rate matching, scrambling and/or QPSK modulation, for example, after scrambling the DCI with an RNTI. A base station may map the coded and modulated DCI on resource elements used and/or configured for a PDCCH. The base station may send/transmit the DCI via a PDCCH occupying a quantity/number of contiguous control channel elements (CCEs), for example, based on a payload size of the DCI and/or a coverage of the base station. The quantity/number of the contiguous CCEs (referred to as aggregation level) may be 1, 2, 4, 8, 16, and/or any other suitable quantity/number. A CCE may comprise a number (e.g., 6) of resource-element groups (REGs). A REG may comprise a resource block in an OFDM symbol. The mapping of the coded and modulated DCI on the resource elements may be based on mapping of CCEs and REGs (e.g., CCE-to-REG mapping).

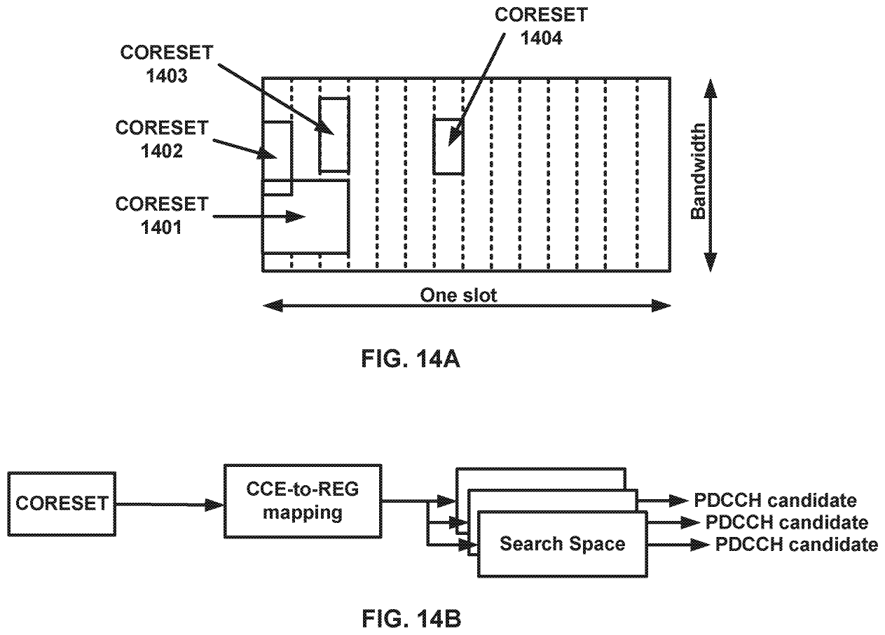

FIG. 14A shows an example of CORESET configurations. The CORESET configurations may be for a bandwidth part or any other frequency bands. The base station may send/transmit DCI via a PDCCH on one or more control resource sets (CORESETs). A CORESET may comprise a time-frequency resource in which the wireless device attempts/tries to decode DCI using one or more search spaces. The base station may configure a size and a location of the CORESET in the time-frequency domain. A first CORESET 1401 and a second CORESET 1402 may occur or may be set/configured at the first symbol in a slot. The first CORESET 1401 may overlap with the second CORESET 1402 in the frequency domain. A third CORESET 1403 may occur or may be set/configured at a third symbol in the slot. A fourth CORESET 1404 may occur or may be set/configured at the seventh symbol in the slot. CORESETs may have a different quantity/number of resource blocks in frequency domain.

FIG. 14B shows an example of a CCE-to-REG mapping. The CCE-to-REG mapping may be performed for DCI transmission via a CORESET and PDCCH processing. The CCE-to-REG mapping may be an interleaved mapping (e.g., for the purpose of providing frequency diversity) or a non-interleaved mapping (e.g., for the purposes of facilitating interference coordination and/or frequency-selective transmission of control channels). The base station may perform different or same CCE-to-REG mapping on different CORESETs. A CORESET may be associated with a CCE-to-REG mapping (e.g., by an RRC configuration). A CORESET may be configured with an antenna port QCL parameter. The antenna port QCL parameter may indicate QCL information of a DM-RS for a PDCCH reception via the CORESET.

The base station may send/transmit, to the wireless device, one or more RRC messages comprising configuration parameters of one or more CORESETs and one or more search space sets. The configuration parameters may indicate an association between a search space set and a CORESET. A search space set may comprise a set of PDCCH candidates formed by CCEs (e.g., at a given aggregation level). The configuration parameters may indicate at least one of: a quantity/number of PDCCH candidates to be monitored per aggregation level; a PDCCH monitoring periodicity and a PDCCH monitoring pattern; one or more DCI formats to be monitored by the wireless device; and/or whether a search space set is a common search space set or a wireless device-specific search space set (e.g., a UE-specific search space set). A set of CCEs in the common search space set may be predefined and known to the wireless device. A set of CCEs in the wireless device-specific search space set (e.g., the UE-specific search space set) may be configured, for example, based on the identity of the wireless device (e.g., C-RNTI).

As shown in FIG. 14B, the wireless device may determine a time-frequency resource for a CORESET based on one or more RRC messages. The wireless device may determine a CCE-to-REG mapping (e.g., interleaved or non-interleaved, and/or mapping parameters) for the CORESET, for example, based on configuration parameters of the CORESET. The wireless device may determine a quantity/number (e.g., at most 10) of search space sets configured on/for the CORESET, for example, based on the one or more RRC messages. The wireless device may monitor a set of PDCCH candidates according to configuration parameters of a search space set. The wireless device may monitor a set of PDCCH candidates in one or more CORESETs for detecting one or more DCIs. Monitoring may comprise decoding one or more PDCCH candidates of the set of the PDCCH candidates according to the monitored DCI formats. Monitoring may comprise decoding DCI content of one or more PDCCH candidates with possible (or configured) PDCCH locations, possible (or configured) PDCCH formats (e.g., the quantity/number of CCEs, the quantity/number of PDCCH candidates in common search spaces, and/or the quantity/number of PDCCH candidates in the wireless device-specific search spaces) and possible (or configured) DCI formats. The decoding may be referred to as blind decoding. The wireless device may determine DCI as valid for the wireless device, for example, based on (e.g., after or in response to) CRC checking (e.g., scrambled bits for CRC parity bits of the DCI matching an RNTI value). The wireless device may process information comprised in the DCI (e.g., a scheduling assignment, an uplink grant, power control, a slot format indication, a downlink preemption, and/or the like).

The may send/transmit uplink control signaling (e.g., UCI) to a base station. The uplink control signaling may comprise HARQ acknowledgements for received DL-SCH transport blocks. The wireless device may send/transmit the HARQ acknowledgements, for example, based on (e.g., after or in response to) receiving a DL-SCH transport block. Uplink control signaling may comprise CSI indicating a channel quality of a physical downlink channel. The wireless device may send/transmit the CSI to the base station. The base station, based on the received CSI, may determine transmission format parameters (e.g., comprising multi-antenna and beamforming schemes) for downlink transmission(s). Uplink control signaling may comprise scheduling requests (SR). The wireless device may send/transmit an SR indicating that uplink data is available for transmission to the base station. The wireless device may send/transmit UCI (e.g., HARQ acknowledgements (HARQ-ACK), CSI report, SR, and the like) via a PUCCH or a PUSCH. The wireless device may send/transmit the uplink control signaling via a PUCCH using one of several PUCCH formats.

There may be multiple PUCCH formats (e.g., five PUCCH formats). A wireless device may determine a PUCCH format, for example, based on a size of UCI (e.g., a quantity/number of uplink symbols of UCI transmission and a quantity/number of UCI bits). PUCCH format 0 may have a length of one or two OFDM symbols and may comprise two or fewer bits. The wireless device may send/transmit UCI via a PUCCH resource, for example, using PUCCH format 0 if the transmission is over/via one or two symbols and the quantity/number of HARQ-ACK information bits with positive or negative SR (HARQ-ACK/SR bits) is one or two. PUCCH format 1 may occupy a quantity/number of OFDM symbols (e.g., between four and fourteen OFDM symbols) and may comprise two or fewer bits. The wireless device may use PUCCH format 1, for example, if the transmission is over/via four or more symbols and the quantity/number of HARQ-ACK/SR bits is one or two. PUCCH format 2 may occupy one or two OFDM symbols and may comprise more than two bits. The wireless device may use PUCCH format 2, for example, if the transmission is over/via one or two symbols and the quantity/number of UCI bits is two or more. PUCCH format 3 may occupy a quantity/number of OFDM symbols (e.g., between four and fourteen OFDM symbols) and may comprise more than two bits. The wireless device may use PUCCH format 3, for example, if the transmission is four or more symbols, the quantity/number of UCI bits is two or more, and the PUCCH resource does not comprise an orthogonal cover code (OCC). PUCCH format 4 may occupy a quantity/number of OFDM symbols (e.g., between four and fourteen OFDM symbols) and may comprise more than two bits. The wireless device may use PUCCH format 4, for example, if the transmission is four or more symbols, the quantity/number of UCI bits is two or more, and the PUCCH resource comprises an OCC.

The base station may send/transmit configuration parameters to the wireless device for a plurality of PUCCH resource sets, for example, using an RRC message. The plurality of PUCCH resource sets (e.g., up to four sets in NR, or up to any other quantity of sets in other systems) may be configured on an uplink BWP of a cell. A PUCCH resource set may be configured with a PUCCH resource set index, a plurality of PUCCH resources with a PUCCH resource being identified by a PUCCH resource identifier (e.g., pucch-Resourceid), and/or a quantity/number (e.g. a maximum quantity/number) of UCI information bits the wireless device may send/transmit using one of the plurality of PUCCH resources in the PUCCH resource set. The wireless device may select one of the plurality of PUCCH resource sets, for example, based on a total bit length of the UCI information bits (e.g., HARQ-ACK, SR, and/or CSI) if configured with a plurality of PUCCH resource sets. The wireless device may select a first PUCCH resource set having a PUCCH resource set index equal to “0,” for example, if the total bit length of UCI information bits is two or fewer. The wireless device may select a second PUCCH resource set having a PUCCH resource set index equal to “1,” for example, if the total bit length of UCI information bits is greater than two and less than or equal to a first configured value. The wireless device may select a third PUCCH resource set having a PUCCH resource set index equal to “2,” for example, if the total bit length of UCI information bits is greater than the first configured value and less than or equal to a second configured value. The wireless device may select a fourth PUCCH resource set having a PUCCH resource set index equal to “3,” for example, if the total bit length of UCI information bits is greater than the second configured value and less than or equal to a third value (e.g., 1406, 1706, or any other quantity of bits).

The wireless device may determine a PUCCH resource from the PUCCH resource set for UCI (HARQ-ACK, CSI, and/or SR) transmission, for example, after determining a PUCCH resource set from a plurality of PUCCH resource sets. The wireless device may determine the PUCCH resource, for example, based on a PUCCH resource indicator in DCI (e.g., with DCI format 1_0 or DCI for 1_1) received on/via a PDCCH. An n-bit (e.g., a three-bit) PUCCH resource indicator in the DCI may indicate one of multiple (e.g., eight) PUCCH resources in the PUCCH resource set. The wireless device may send/transmit the UCI (HARQ-ACK, CSI and/or SR) using a PUCCH resource indicated by the PUCCH resource indicator in the DCI, for example, based on the PUCCH resource indicator.

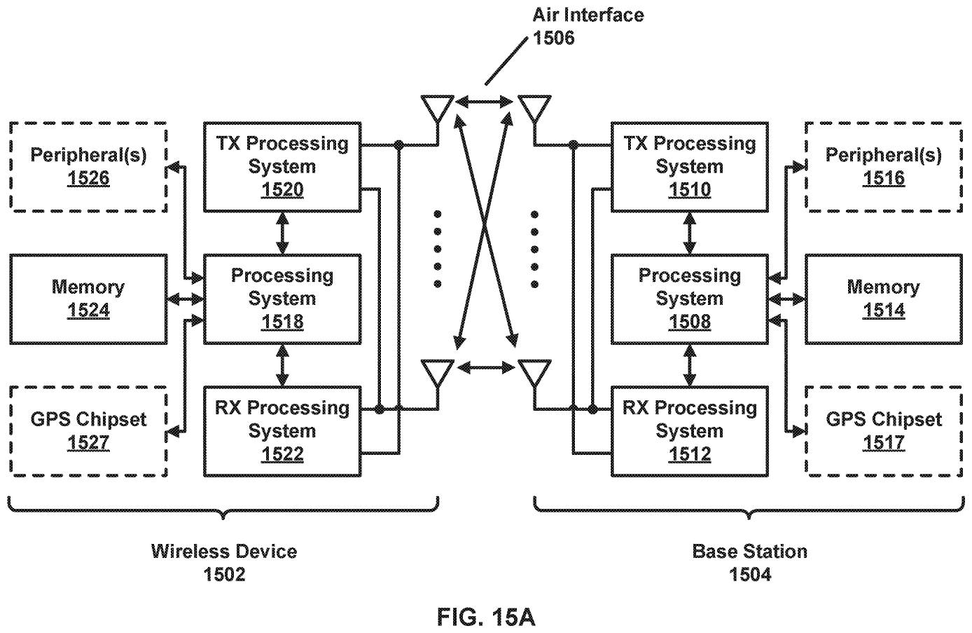

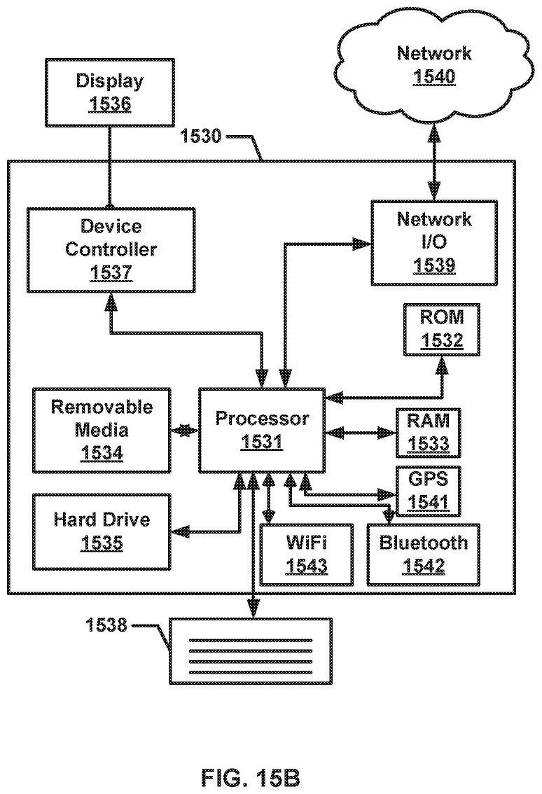

FIG. 15A shows example communications between a wireless device and a base station. A wireless device 1502 and a base station 1504 may be part of a communication network, such as the communication network 100 shown in FIG. 1A, the communication network 150 shown in FIG. 1B, or any other communication network. A communication network may comprise more than one wireless device and/or more than one base station, with substantially the same or similar configurations as those shown in FIG. 15A.

The base station 1504 may connect the wireless device 1502 to a core network (not shown) via radio communications over the air interface (or radio interface) 1506. The communication direction from the base station 1504 to the wireless device 1502 over the air interface 1506 may be referred to as the downlink. The communication direction from the wireless device 1502 to the base station 1504 over the air interface may be referred to as the uplink. Downlink transmissions may be separated from uplink transmissions, for example, using various duplex schemes (e.g., FDD, TDD, and/or some combination of the duplexing techniques).

For the downlink, data to be sent to the wireless device 1502 from the base station 1504 may be provided/transferred/sent to the processing system 1508 of the base station 1504. The data may be provided/transferred/sent to the processing system 1508 by, for example, a core network. For the uplink, data to be sent to the base station 1504 from the wireless device 1502 may be provided/transferred/sent to the processing system 1518 of the wireless device 1502. The processing system 1508 and the processing system 1518 may implement layer 3 and layer 2 OSI functionality to process the data for transmission. Layer 2 may comprise an SDAP layer, a PDCP layer, an RLC layer, and a MAC layer, for example, described with respect to FIG. 2A, FIG. 2B, FIG. 3, and FIG. 4A. Layer 3 may comprise an RRC layer, for example, described with respect to FIG. 2B.

The data to be sent to the wireless device 1502 may be provided/transferred/sent to a transmission processing system 1510 of base station 1504, for example, after being processed by the processing system 1508. The data to be sent to base station 1504 may be provided/transferred/sent to a transmission processing system 1520 of the wireless device 1502, for example, after being processed by the processing system 1518. The transmission processing system 1510 and the transmission processing system 1520 may implement layer 1 OSI functionality. Layer 1 may comprise a PHY layer, for example, described with respect to FIG. 2A, FIG. 2B, FIG. 3, and FIG. 4A. For transmit processing, the PHY layer may perform, for example, forward error correction coding of transport channels, interleaving, rate matching, mapping of transport channels to physical channels, modulation of physical channel, multiple-input multiple-output (MIMO) or multi-antenna processing, and/or the like.

A reception processing system 1512 of the base station 1504 may receive the uplink transmission from the wireless device 1502. The reception processing system 1512 of the base station 1504 may comprise one or more TRPs. A reception processing system 1522 of the wireless device 1502 may receive the downlink transmission from the base station 1504. The reception processing system 1522 of the wireless device 1502 may comprise one or more antenna panels. The reception processing system 1512 and the reception processing system 1522 may implement layer 1 OSI functionality. Layer 1 may include a PHY layer, for example, described with respect to FIG. 2A, FIG. 2B, FIG. 3, and FIG. 4A. For receive processing, the PHY layer may perform, for example, error detection, forward error correction decoding, deinterleaving, demapping of transport channels to physical channels, demodulation of physical channels, MIMO or multi-antenna processing, and/or the like.

The base station 1504 may comprise multiple antennas (e.g., multiple antenna panels, multiple TRPs, etc.). The wireless device 1502 may comprise multiple antennas (e.g., multiple antenna panels, etc.). The multiple antennas may be used to perform one or more MIMO or multi-antenna techniques, such as spatial multiplexing (e.g., single-user MIMO or multi-user MIMO), transmit/receive diversity, and/or beamforming. The wireless device 1502 and/or the base station 1504 may have a single antenna.

The processing system 1508 and the processing system 1518 may be associated with a memory 1514 and a memory 1524, respectively. Memory 1514 and memory 1524 (e.g., one or more non-transitory computer readable mediums) may store computer program instructions or code that may be executed by the processing system 1508 and/or the processing system 1518, respectively, to carry out one or more of the functionalities (e.g., one or more functionalities described herein and other functionalities of general computers, processors, memories, and/or other peripherals). The transmission processing system 1510 and/or the reception processing system 1512 may be coupled to the memory 1514 and/or another memory (e.g., one or more non-transitory computer readable mediums) storing computer program instructions or code that may be executed to carry out one or more of their respective functionalities. The transmission processing system 1520 and/or the reception processing system 1522 may be coupled to the memory 1524 and/or another memory (e.g., one or more non-transitory computer readable mediums) storing computer program instructions or code that may be executed to carry out one or more of their respective functionalities.

The processing system 1508 and/or the processing system 1518 may comprise one or more controllers and/or one or more processors. The one or more controllers and/or one or more processors may comprise, for example, a general-purpose processor, a digital signal processor (DSP), a microcontroller, an application specific integrated circuit (ASIC), a field programmable gate array (FPGA) and/or other programmable logic device, discrete gate and/or transistor logic, discrete hardware components, an on-board unit, or any combination thereof. The processing system 1508 and/or the processing system 1518 may perform at least one of signal coding/processing, data processing, power control, input/output processing, and/or any other functionality that may enable the wireless device 1502 and/or the base station 1504 to operate in a wireless environment.

The processing system 1508 may be connected to one or more peripherals 1516. The processing system 1518 may be connected to one or more peripherals 1526. The one or more peripherals 1516 and the one or more peripherals 1526 may comprise software and/or hardware that provide features and/or functionalities, for example, a speaker, a microphone, a keypad, a display, a touchpad, a power source, a satellite transceiver, a universal serial bus (USB) port, a hands-free headset, a frequency modulated (FM) radio unit, a media player, an Internet browser, an electronic control unit (e.g., for a motor vehicle), and/or one or more sensors (e.g., an accelerometer, a gyroscope, a temperature sensor, a radar sensor, a lidar sensor, an ultrasonic sensor, a light sensor, a camera, and/or the like). The processing system 1508 and/or the processing system 1518 may receive input data (e.g., user input data) from, and/or provide output data (e.g., user output data) to, the one or more peripherals 1516 and/or the one or more peripherals 1526. The processing system 1518 in the wireless device 1502 may receive power from a power source and/or may be configured to distribute the power to the other components in the wireless device 1502. The power source may comprise one or more sources of power, for example, a battery, a solar cell, a fuel cell, or any combination thereof. The processing system 1508 may be connected to a Global Positioning System (GPS) chipset 1517. The processing system 1518 may be connected to a Global Positioning System (GPS) chipset 1527. The GPS chipset 1517 and the GPS chipset 1527 may be configured to determine and provide geographic location information of the wireless device 1502 and the base station 1504, respectively.

FIG. 15B shows example elements of a computing device that may be used to implement any of the various devices described herein, including, for example, the base station 160A, 160B, 162A, 162B, 220, 1210, and/or 1302, the wireless device 106, 156A, 156B, 210, 1205, 1301, 2115, 2130, and/or 2140, the reader/network 2110, 2210, 2310, 2410, 2610, 3010, and/or 3110, the A-IoT device 2120, 2220, 2320, 2420, 2430, 2440, 2620, 3020, and/or 3120, or any other base station, wireless device, AMF, UPF, network device, or computing device described herein. The computing device 1530 may include one or more processors 1531, which may execute instructions stored in the random-access memory (RAM) 1533, the removable media 1534 (such as a Universal Serial Bus (USB) drive, compact disk (CD) or digital versatile disk (DVD), or floppy disk drive), or any other desired storage medium. Instructions may also be stored in an attached (or internal) hard drive 1535. The computing device 1530 may also include a security processor (not shown), which may execute instructions of one or more computer programs to monitor the processes executing on the processor 1531 and any process that requests access to any hardware and/or software components of the computing device 1530 (e.g., ROM 1532, RAM 1533, the removable media 1534, the hard drive 1535, the device controller 1537, a network interface 1539, a GPS 1541, a Bluetooth interface 1542, a WiFi interface 1543, etc.). The computing device 1530 may include one or more output devices, such as the display 1536 (e.g., a screen, a display device, a monitor, a television, etc.), and may include one or more output device controllers 1537, such as a video processor. There may also be one or more user input devices 1538, such as a remote control, keyboard, mouse, touch screen, microphone, etc. The computing device 1530 may also include one or more network interfaces, such as a network interface 1539, which may be a wired interface, a wireless interface, or a combination of the two. The network interface 1539 may provide an interface for the computing device 1530 to communicate with a network 1540 (e.g., a RAN, or any other network). The network interface 1539 may include a modem (e.g., a cable modem), and the external network 1540 may include communication links, an external network, an in-home network, a provider's wireless, coaxial, fiber, or hybrid fiber/coaxial distribution system (e.g., a DOCSIS network), or any other desired network. Additionally, the computing device 1530 may include a location-detecting device, such as a global positioning system (GPS) microprocessor 1541, which may be configured to receive and process global positioning signals and determine, with possible assistance from an external server and antenna, a geographic position of the computing device 1530.

The example in FIG. 15B may be a hardware configuration, although the components shown may be implemented as software as well. Modifications may be made to add, remove, combine, divide, etc. components of the computing device 1530 as desired. Additionally, the components may be implemented using basic computing devices and components, and the same components (e.g., processor 1531, ROM storage 1532, display 1536, etc.) may be used to implement any of the other computing devices and components described herein. For example, the various components described herein may be implemented using computing devices having components such as a processor executing computer-executable instructions stored on a computer-readable medium, as shown in FIG. 15B. Some or all of the entities described herein may be software based, and may co-exist in a common physical platform (e.g., a requesting entity may be a separate software process and program from a dependent entity, both of which may be executed as software on a common computing device).

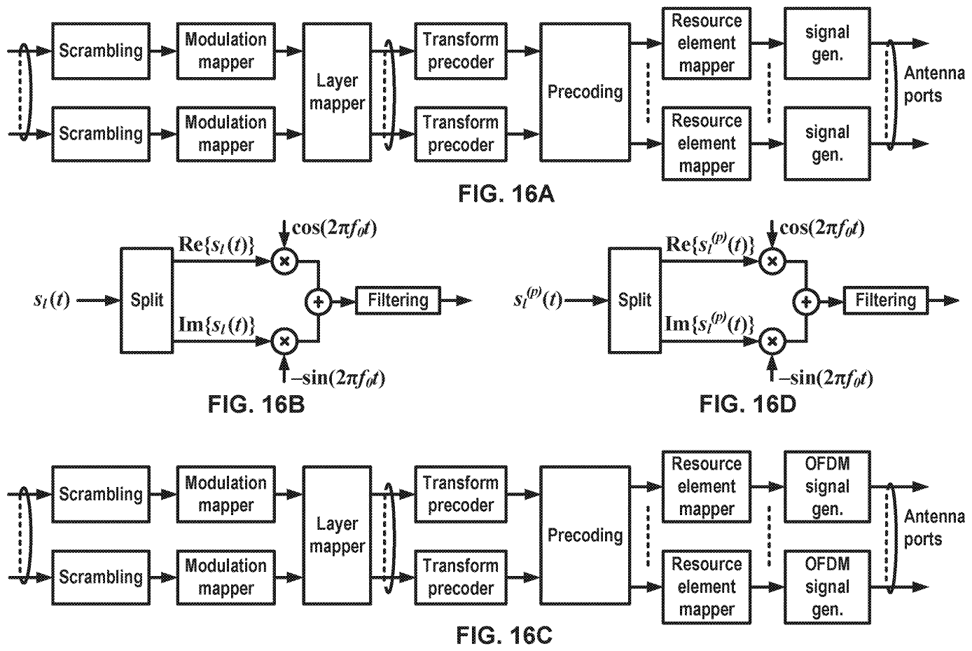

FIG. 16A shows an example structure for uplink transmission. Processing of a baseband signal representing a physical uplink shared channel may comprise/perform one or more functions. The one or more functions may comprise at least one of: scrambling; modulation of scrambled bits to generate complex-valued symbols; mapping of the complex-valued modulation symbols onto one or several transmission layers; transform precoding to generate complex-valued symbols; precoding of the complex-valued symbols; mapping of precoded complex-valued symbols to resource elements; generation of complex-valued time-domain Single Carrier-Frequency Division Multiple Access (SC-FDMA), CP-OFDM signal for an antenna port, or any other signals; and/or the like. An SC-FDMA signal for uplink transmission may be generated, for example, if transform precoding is enabled. A CP-OFDM signal for uplink transmission may be generated, for example, if transform precoding is not enabled (e.g., as shown in FIG. 16A). These functions are examples and other mechanisms for uplink transmission may be implemented.

FIG. 16B shows an example structure for modulation and up-conversion of a baseband signal to a carrier frequency. The baseband signal may be a complex-valued SC-FDMA, CP-OFDM baseband signal (or any other baseband signals) for an antenna port and/or a complex-valued Physical Random Access Channel (PRACH) baseband signal. Filtering may be performed/employed, for example, prior to transmission.

FIG. 16C shows an example structure for downlink transmissions. Processing of a baseband signal representing a physical downlink channel may comprise/perform one or more functions. The one or more functions may comprise: scrambling of coded bits in a codeword to be sent/transmitted on/via a physical channel; modulation of scrambled bits to generate complex-valued modulation symbols; mapping of the complex-valued modulation symbols onto one or several transmission layers; precoding of the complex-valued modulation symbols on a layer for transmission on the antenna ports; mapping of complex-valued modulation symbols for an antenna port to resource elements; generation of complex-valued time-domain OFDM signal for an antenna port; and/or the like. These functions are examples and other mechanisms for downlink transmission may be implemented.

FIG. 16D shows an example structure for modulation and up-conversion of a baseband signal to a carrier frequency. The baseband signal may be a complex-valued OFDM baseband signal for an antenna port or any other signal. Filtering may be performed/employed, for example, prior to transmission.

A wireless device may receive, from a base station, one or more messages (e.g. RRC messages) comprising configuration parameters of a plurality of cells (e.g., a primary cell, one or more secondary cells). The wireless device may communicate with at least one base station (e.g., two or more base stations in dual-connectivity) via the plurality of cells. The one or more messages (e.g. as a part of the configuration parameters) may comprise parameters of PHY, MAC, RLC, PCDP, SDAP, RRC layers for configuring the wireless device. The configuration parameters may comprise parameters for configuring PHY and MAC layer channels, bearers, etc. The configuration parameters may comprise parameters indicating values of timers for PHY, MAC, RLC, PCDP, SDAP, RRC layers, and/or communication channels.

A timer may begin running, for example, after (e.g., as soon as) it is started and continue running until it is stopped or until it expires. A timer may be started, for example, if it is not running or restarted if it is running. A timer may be associated with a value (e.g., the timer may be started or restarted from a value or may be started from zero and expire after (e.g., as soon as) it reaches the value). The duration of a timer may not be updated, for example, until the timer is stopped or expires (e.g., due to BWP switching). A timer may be used to measure a time period/window for a process. With respect to an implementation and/or procedure related to one or more timers or other parameters, it will be understood that there may be multiple ways to implement the one or more timers or other parameters. One or more of the multiple ways to implement a timer may be used to measure a time period/window for the procedure. A random access response window timer may be used for measuring a window of time for receiving a random access response. The time difference between two time stamps may be used, for example, instead of starting a random access response window timer and determine the expiration of the timer. A process for measuring a time window may be restarted, for example, if a timer is restarted. Other example implementations may be configured/provided to restart a measurement of a time window.

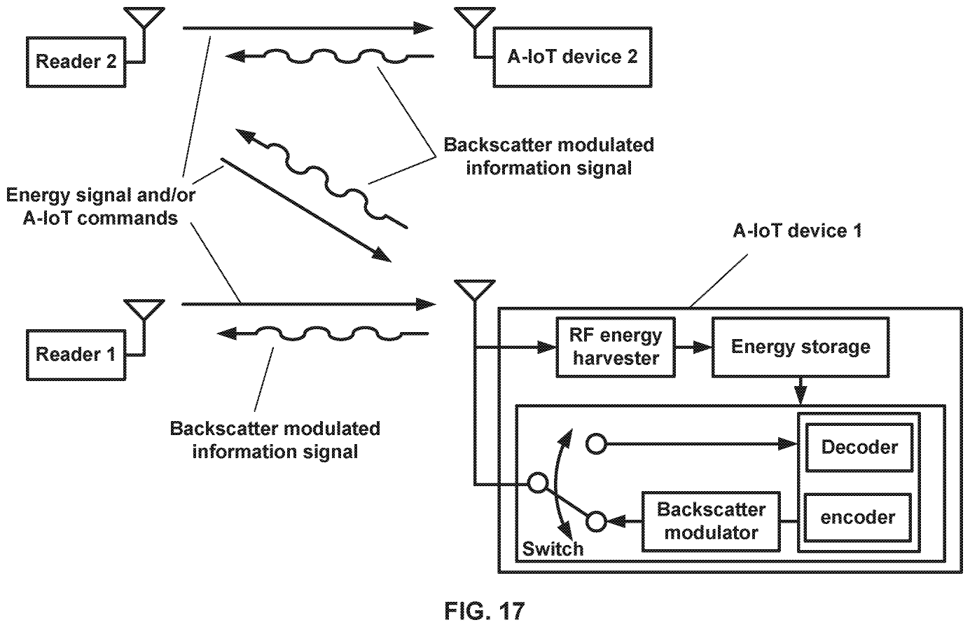

FIG. 17 shows an example of ambient internet-of-thing (A-IoT) communications. The A-IoT communications may comprise communication(s) between a reader and an A-IoT device.

The reader may comprise a base station (e.g., RAN 104 in FIG. 1A, gNB 160A in FIG. 1B, and/or gNB 160B in FIG. 1B). The reader may comprise a wireless device (e.g., wireless device 106 in FIG. 1A, wireless device 156A in FIG. 1B, and/or wireless device 156B in FIG. 1B).

An A-IoT device may be referred to as an ambient intelligence device, an ambient power-enabled IoT device, an ambient computing device, an IoT device (e.g., configured and/or deployed for ambient IoT), a tag, and/or the like. The A-IoT device may comprise hardware (e.g., a sensor, actuator, gadget, appliance, machine, etc.) that may be programmed for certain applications. The A-IoT device may be a smart watch, a smart eyewear, a smart refrigerator, a smart door lock, and so on. The A-IoT device may be battery-free and based on energy harvested from one or more ambient sources.

In the A-IoT communications, multiple readers may communicate with one or more A-IoT devices. For example, in FIG. 17, Reader 1 and Reader 2 may communicate with A-IoT device 1. In the A-IoT communications, a reader may communicate with one or more A-IoT devices. For example, in FIG. 17, Reader 2 may communicate with A-IoT device 1 and A-IoT device 2.

A communication channel from a reader to an A-IoT device may be referred to as a reader-to-device channel (e.g., R2D channel), A-IoT downlink channel, a sidelink channel, and/or the like. The reader-to-device channel may comprise a physical channel (e.g., physical reader to device channel (PRDCH)). In the present disclosure, a communication channel from a reader to an A-IoT device may be referred to as a reader-to-device channel and/or an R2D channel, for example, for simplicity.

A communication channel from an A-IoT device to a reader may be referred to as a device-to-reader channel (e.g., D2R channel), A-IoT uplink channel, a sidelink channel, and/or the like. The device-to-reader channel may comprise a physical channel (e.g., physical device to reader channel (PDRCH)). In the present disclosure, a communication channel from an A-IoT device to a reader may be referred to as a device-to-reader channel and/or a D2R channel, for example, for simplicity.

An A-IoT device may refer to a device primarily or substantially powered by harvesting energy from one or more viable ambient IoT energy sources. The A-IoT device may be battery-less or with limited energy storage capability (e.g., using a capacitor). The one or more viable ambient IoT energy sources may comprise radio waves (e.g., radio frequency (RF) wave). The one or more viable ambient IoT energy sources may comprise light, motion, heat, or any other suitable power sources.

An A-IoT device may harvest the energy from radio waves. The A-IoT device may receive, from a reader or energy source (e.g., RF emitter), a radio wave (e.g., carrier wave). The A-IoT device may harvest an energy from the radio wave. The A-IoT device may store the harvested energy in an energy storage. The A-IoT device may use the harvested energy for transmitting a signal to the reader via D2R channel(s). For example, the A-IoT device may send (e.g., transmit), to the reader, a reflected (e.g., backscatter) signal using the harvested energy. The A-IoT device may use the harvested energy for receiving a signal from the reader via R2D channel(s).

An A-IoT device may employ, use, send (e.g., transmit), trigger, initiate, and/or perform a transmission of a backscatter signal. The backscatter signal or transmission may be referred to as ambient backscatter, bistatic communication, and/or the like. Transmitting a backscatter signal may comprise reflecting, by the A-IoT device, waves, particles, or signals back in the direction from which they were detected. For example, the A-IoT device may modify and/or reflect the received signal with encoded data (e.g., by using the power converted from the harvest energy). The encoded data may include a response (e.g., command response) to a command (e.g., sent/transmitted by a reader). Antennas on other devices (e.g., a reader) may, in turn, detect the signal reflected by the A-IoT device.

The backscatter transmission or backscatter signal may be transmitted in an UL spectrum/frequency/frequency band (e.g., Uu UL spectrum/frequency/frequency band). The backscatter transmission or backscatter signal may be transmitted in a DL spectrum/frequency/frequency band (e.g., Uu UL spectrum/frequency/frequency band). In the present disclosure, the A-IoT device transmitting a signal/message/channel may refer to the A-IoT device backscattering the signal/message/channel.

Harvested energy from a radio (e.g., RF) wave may be used to perform one or more tasks at the A-IoT device. For example, the tasks may comprise data decoding, filter operation, data reception, data encoding, and/or data transmission. A purpose of harvesting the energy may be to energize the A-IoT device and/or to charge a battery of the A-IoT device. The A-IoT device may perform the one or more tasks using the harvested energy. The A-IoT device may perform the one or more tasks, for example, based at least in part on an accumulation of harvested energy over a period of time.

The harvested energy may be derived from a radio wave (e.g., RF signals) transmitted by a network (e.g., base station) and/or by a wireless device (e.g., UE) connected to the network. The A-IoT device may communicate with the network using the harvested energy. For example, RF energy harvesting may lead to a longer battery lifespan of the A-IoT device with a battery. RF energy harvesting may lead to a battery-less IoT device, such as a medical sensor or an implanted sensor.

An amount of energy that the A-IoT device harvests from the radio wave may depend on one or more parameters. For example, the one or more parameters may comprise a frequency of the radio wave and a distance traveled by the radio wave. For example, the one or more parameters may comprise a transmission power of the radio wave. For example, the one or more parameters may comprise a received power of the radio wave. The signal source of the radio wave may be a network such as a base station (e.g., RAN 104) in FIG. 1A (and/or gNB 160A, gNB 160B, ng-eNB 162A, ng-eNB 162B, and/or NG-RAN 154 in FIG. 1B) and/or another device, such as a wireless device connected to the wireless device 106 in FIG. 1A (and/or wireless device 156A, wireless device 156B in FIG. 1B).

The A-IoT device may perform the energy harvesting from various energy sources, such as solar, vibration, thermal, laser or light, and/or RF. Energy harvesting from a solar source may use photovoltaic cells and/or may require exposure to light (e.g., may not be feasible for implantable devices and/or indoor devices). Energy harvesting from a vibration source may use piezoelectric, electrostatic, and/or electromagnetic techniques. Energy harvesting from a vibration source may be implantable and/or may suffer from material physical limitations. Energy harvesting from a thermal source may use thermoelectric or pyroelectric techniques. Energy harvesting from a thermal source may provide a relatively high power density (e.g., compared with other energy sources). Energy harvesting from a thermal source may be implantable, and/or may produce excess heat. Energy harvesting from RF (a radio wave) may use an antenna and/or may be implantable. Energy harvesting from RF (a radio wave) may provide a relatively low power density (e.g., compared with other energy sources) where an efficiency is inversely proportional to a distance.

Referring to FIG. 17, a reader may send (e.g., transmit), to an A-IoT device and via an R2D channel, an energy signal to energize the A-IoT device. The energy signal may be a continuous waveform (CW). The energy signal may be unmodulated signal. The reader may send (e.g., transmit), to an A-IoT device and via an R2D channel, one or more A-IoT commands. The reader may send (e.g., transmit) the energy signal, for example, prior to the one or more A-IoT commands.

The CW may be transmitted in an UL spectrum/frequency/frequency band (e.g., Uu UL spectrum/frequency/frequency band). The CW may be transmitted in a DL spectrum/frequency/frequency band (e.g., Uu UL spectrum/frequency/frequency band).

The backscatter transmission or backscatter signal may be transmitted in a same spectrum/frequency/frequency band as the CW. The backscatter transmission or backscatter signal may be transmitted in a different spectrum/frequency/frequency band as the CW.

Referring to FIG. 17, an A-IoT device may receive, from a reader and via R2D channel, an energy signal. The A-IoT device may comprise an RF energy harvester. For example, the RF energy harvester may comprise a rectifier performing RF signal alternating current (AC) to direct current (DC) conversion. The A-IoT device may comprise an energy storage (e.g., capacitor). The energy storage may store harvested energy from the RF energy harvester. The A-IoT device may supply the harvested energy to active component blocks (e.g., decoder, encoder, backscatter modulator, amplifier, and/or the like) of the A-IoT device.

Referring to FIG. 17, an A-IoT device may receive, from the reader and via R2D channel, one or more A-IoT commands. The A-IoT device may send (e.g., transmit), to the reader and via D2R channel, a backscatter modulated information signal using the transmit power based on the harvested energy. The backscatter modulated information signal may comprise one or more responses respective to the one or more A-IoT commands. The backscatter modulated information signal may be referred to as a backscatter signal, a backscattering signal, and/or the like.

The A-IoT device may comprise an antenna shared for the RF energy harvester and receiver/transmitter. The A-IoT device may comprise at least one first antenna and/or at least one second antenna. The at least one first antenna may be dedicated for the RF energy harvester. The at least one second antenna may be dedicated for the receiver to receiving the energy signal and/or A-IoT commands. The at least one second antenna may be dedicated for the transmitter to send (e.g., transmit) the backscatter modulated information signal.

An A-IoT device may be categorized, for example, based on its capability of energy storage, a transmit signal generation, and/or amplification of a transmit signal (e.g., backscattered signal). For example, an A-IoT device may be categorized as Device 1 (or Device A), Device 2a (or Device B), or Device 2b (or Device C).

An A-IoT device may be referred to as (e.g., a type) Device 1 (or Device A). The A-IoT device categorized as Device 1 may have (or support) peak power consumption less than or equal to 1 μW peak power consumption. The A-IoT device categorized as Device 1 may have energy storage. The A-IoT device categorized as Device 1 may have initial sampling frequency offset (SFO) up to 10×ppm. The A-IoT device categorized as Device 1 may have neither DL (e.g., R2D) nor UL (e.g., D2R) amplification in the device. The UL (e.g., D2R) transmission of the A-IoT device categorized as Device 1 may be backscattered on a carrier wave provided/transmitted externally (e.g., by a reader).

An A-IoT device may be referred to as (e.g., a type) Device 2a (or Device B). The A-IoT device categorized as Device 2a may have (or support) peak power consumption less than or equal to a few hundred μW peak power consumption. The A-IoT device categorized as Device 2a may have (or support) energy storage. The A-IoT device categorized as Device 2a may have (or support) initial sampling frequency offset (SFO) up to 10×ppm. The A-IoT device categorized as Device 2a may have (or support) both DL (e.g., R2D) and/or UL (e.g., D2R) amplification in the device. The UL (e.g., D2R) transmission of the A-IoT device categorized as Device 2a may be backscattered on a carrier wave provided/transmitted externally (e.g., by a reader).

An A-IoT device may be referred to as (e.g., a type) Device 2b (or Device C). The A-IoT device categorized as Device 2b may have (or support) peak power consumption less than or equal to a few hundred μW peak power consumption. The A-IoT device categorized as Device 2b may have (or support) energy storage. The A-IoT device categorized as Device 2b may have (or support) initial sampling frequency offset (SFO) up to 10×ppm. The A-IoT device categorized as Device 2b may have (or support) both DL (e.g., R2D) and/or UL (e.g., D2R) amplification in the device. The UL (e.g., D2R) transmission of the A-IoT device categorized as Device 2b may be generated internally by the A-IoT device.

An A-IoT device may comprise a message size (e.g., a maximum message size). A (e.g., maximum) message size of the A-IoT may be approximately 1000 bits to be received by the A-IoT device. A (e.g., maximum) message size of the A-IT may be approximately 1000 bits to be transmitted from the A-IoT device. The one-way end-to-end (e.g., maximum) latency (e.g., including query/triggering time) of the A-IoT device may be from 1 second to 10 seconds. The (e.g., maximum) connection density of the A-IoT communications may be about 150 A-IoT devices per 100 m2 for indoor scenarios. The (e.g., maximum) connection density of the A-IoT communications may be about 20 A-IoT devices per 100 m2 for outdoor scenarios. The A-IoT device may be a fixed or static (not moving) device. The A-IoT device may have a moving speed of 10 km/h (e.g., at least for indoor scenarios).

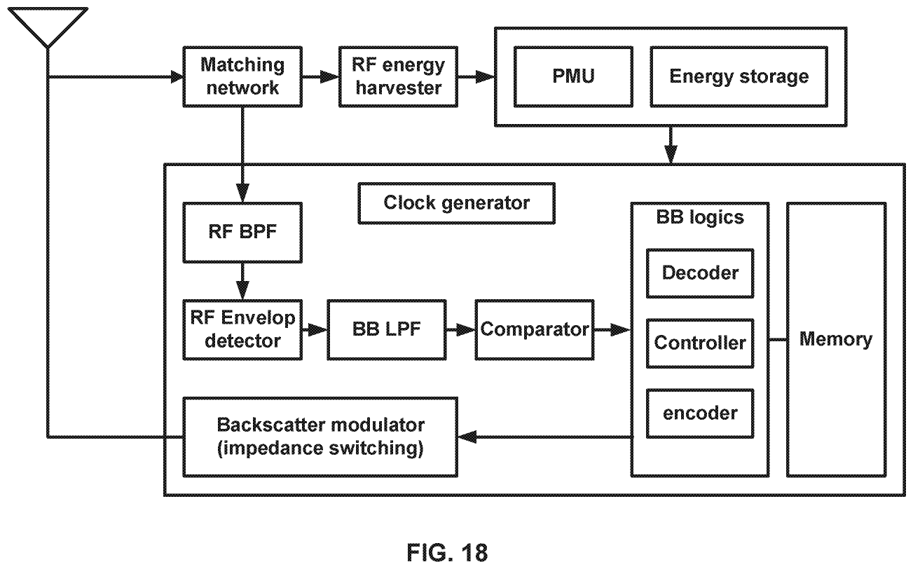

FIG. 18 shows an example of A-IoT device architecture. The block diagrams in FIG. 18 may be an example A-IoT device architecture of Device 1. For example, the A-IoT device may comprise one or more antennas. The one or more antennas may be either shared or separate for RF energy harvester and receiver/transmitter. For example, the A-IoT device may comprise a block for a matching network. The matching network may be to match impedance between antenna and other components (including RF energy harvester and receiver related blocks). For example, the A-IoT device may comprise an RF energy harvester. The RF energy harvester may comprise a rectifier performing RF signal (AC) to DC conversion. For example, the A-IoT device may comprise an energy storage (e.g., capacitor). The energy storage may store harvested energy from RF energy harvester. For example, the A-IoT device may comprise a power management unit (PMU). The PMU may manage storing energy to energy storage from energy harvester and supplying power to active component blocks which needs a power supply.

In FIG. 18, the A-IoT device may comprise a digital baseband (BB) logic. The digital BB logic may include functional blocks like encoder, decoder, controller, etc. For example, the A-IoT device may comprise a memory. The memory may comprise at least one of Non-Volatile Memory (NVM) and/or registers. The NVM may comprise an Erasable Programmable Read-Only Memory (EEPROM), for example, for permanently storing device ID, etc. The registers may be for temporarily keeping information for its operation, for example, while/if energy is available for the operation in energy storage. For example, the A-IoT device may comprise a clock generator. The clock generator may provide/generate clock signal(s).

In FIG. 18, the A-IoT device may comprise reception related blocks. For example, the A-IoT device may comprise RF band-pass filter (BPF), for example, for improving selectivity. The RF BPF may be optional to be implemented in the A-IoT device. For example, the A-IoT device may comprise an RF envelope detector. The RF envelop detector may convert RF signal to baseband. For example, the A-IoT device may comprise a BB low-pass filter (LPF). The BB LPF may filter out harmonics and high frequency components to improve input signal quality to comparator. The BB LPF may be optional to be implemented in the A-IoT device. For example, the A-IoT device may comprise a comparator that may determine high/low of input signal.

In FIG. 18, the A-IoT device may comprise transmission related blocks. For example, the A-IoT device may comprise a backscatter modulator. The backscatter modulator may switch impedance to modulate a backscattered signal with a Tx signal from BB logics.

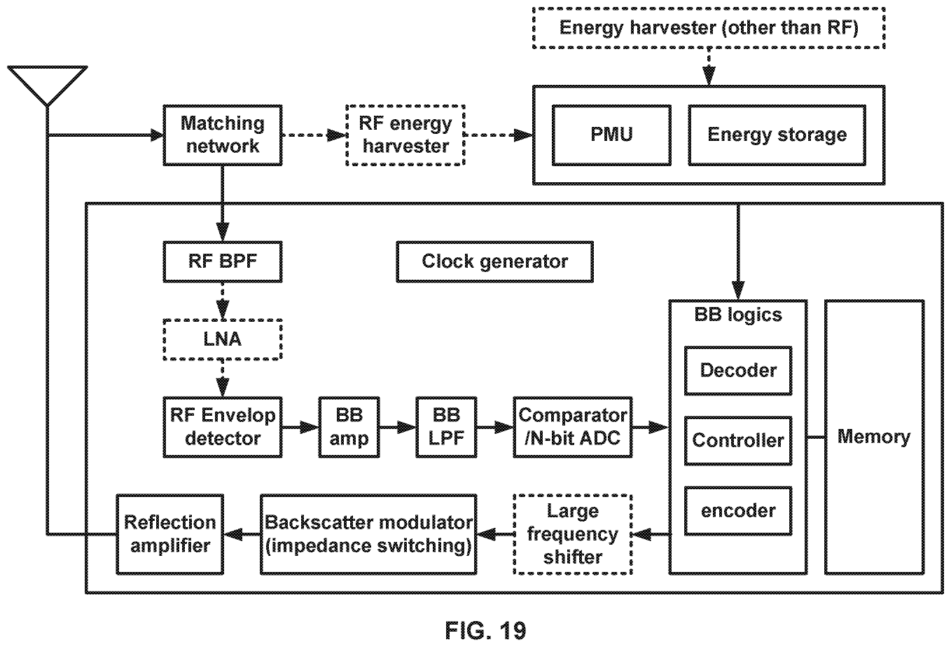

FIG. 19 shows an example of A-IoT device architecture. The block diagrams in FIG. 19 may be an example A-IoT device architecture of Device 2a and/or Device 2b. Comparing with the A-IoT device architecture in FIG. 18, the A-IoT device architecture in FIG. 19 may further comprise one or more additional blocks. The one or more additional blocks may comprise a low noise amplifier (LNA). The LNA may improve (e.g., amplifier) a signal strength and sensitivity of receiver. The one or more additional blocks may comprise a BB amplifier. The BB amplifier may amplify a BB signal to improve signal strength (e.g., increase signal strength). The one or more additional blocks may comprise a reflection amplifier. The reflection amplifier may amplify (e.g., increase a power of) a reflected backscattered signal. The one or more additional blocks may comprise a large frequency shifter. The large frequency shifter (e.g., tens of MHz) may shift a backscattered signal from one frequency (e.g., FDD-DL frequency) to another frequency (e.g., FDD-UL frequency).

In FIG. 19, the A-IoT device may comprise an N-bit analog-to-digital converter (ADC), for example, instead of the comparator. The A-IoT device may have one or more energy sources. For example, the A-IoT device may comprise an RF energy harvester for harvesting an energy from an RF signal (e.g., radio wave). The RF energy harvester may include a rectifier performing RF signal (AC) to DC conversion. The A-IoT device may comprise an energy harvester (other than the RF energy harvester) for energy harvesting from energy source(s) other than the RF signal.

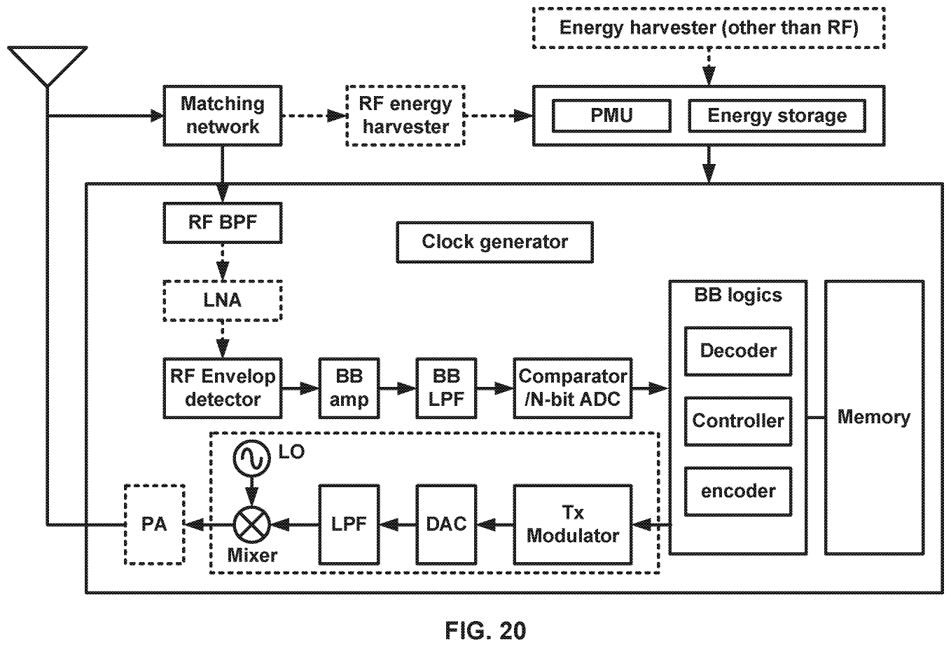

FIG. 20 shows an example of A-IoT device architecture. The block diagrams in FIG. 20 may be an example A-IoT device architecture of Device 2b. Comparing with the A-IoT device architectures in FIG. 18 and/or FIG. 19, the A-IoT device architecture in FIG. 20 may further comprise one or more additional blocks. The one or more additional blocks may comprise a Tx modulator. Baseband bits may be modulated at the Tx modulator according to modulation scheme. The Tx modulator block may be a part of BB logic. The one or more additional blocks may comprise a digital to analog converter (DAC) that converts digital signal to analog signal. The one or more additional blocks may comprise a low pass filter (LPF) for filtering out undesired signal. The one or more additional blocks may comprise a mixer that performs up-converting baseband signal to RF range. The one or more additional blocks may comprise a local oscillator (LO) for carrier frequency generation. The block diagrams in FIG. 20 may comprise a phase locked loop (PLL) and/or a frequency locked loop (FLL) (not shown in FIG. 20) that may be used to generate frequencies suitable for the LO in a respective frequency range. The one or more additional blocks may comprise a power amplifier (PA) that amplifies Tx signal, if present.

In FIG. 17, FIG. 18, FIG. 19, and/or FIG. 20, the RF energy harvester and the reception related blocks may operate in a simultaneous manner. For example, an RF energy harvester of the A-IoT device may receive RF signals from a first set of antennas. For example, a reception related blocks of the A-IoT device may receive RF signals from a second set of antennas.

In FIG. 17, FIG. 18, FIG. 19, and/or FIG. 20, the A-IoT device may comprise common antenna(s) shared between the energy harvester and the reception related blocks. For example, the common antenna(s) between the energy harvester and the reception related blocks may receive RF signals. The received RF signals may be split into two streams for the energy harvester and the reception related blocks. For example, a power of the received RF signals may be split between the energy harvester and the reception related blocks. For example, the A-IoT device may switch the antenna(s) between the RF energy harvester and the reception related blocks using time switching. For example, RF signals received at the antenna(s) may be directed to the energy harvester, for example, when/if a path is switched to be directed to the energy harvester. The RF signals received at the antenna(s) may be directed to the reception related blocks, for example, when/if a path is switched to be directed to the reception related blocks.

The A-IoT communications may comprise one or more topologies. The one or more topologies may comprise at least one of: a topology for an A-IoT direct network communication, a topology for an A-IoT Indirect network communication, and/or a topology for an A-IoT device to UE direct communication.

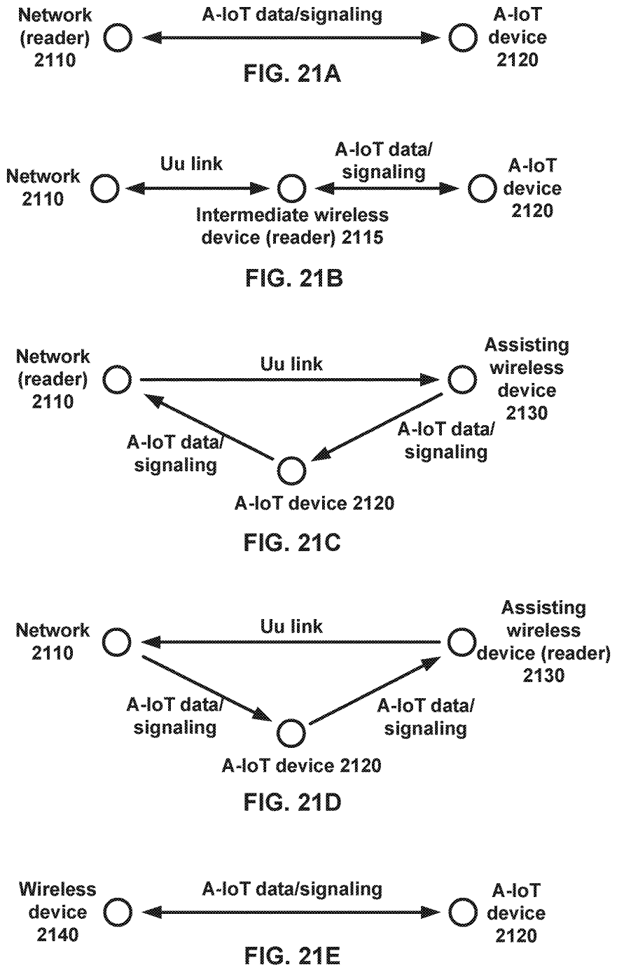

FIG. 21A shows an example of an A-IoT direct network communication. The topology in FIG. 21A may be an example of an A-IoT direct network communication. For example, the A-IoT direct network communication may comprise an A-IoT device 2120 and a network node 2110 such as a base station. In the example, the network node 2110 is a reader for the A-IoT device. The topology for the A-IoT direct network communication may comprise a direct link between the network node 2110 and the A-IoT device 2020.

In an A-IoT direct network communication, the A-IoT device 2020 may directly and/or bidirectionally communicate, via the direct link, with the network node 2110. The communication between the network node and the A-IT device may include A-IT data and/or signaling. A direct link between a reader (e.g., the network node) and an A-IoT device may be referred as an A-IoT link, an A-IoT downlink/uplink, an A-DL/A-UL, an R2D link, a D2R link, and/or the like. The A-IoT device and the reader may communicate, via the direct link, with/using one or more A-IoT messages (e.g., A-IoT signals). The A-IoT device may send (e.g., transmit), via the direct link, one or more D2R messages (e.g., D2R transmissions) to the reader. The reader may receive the one or more D2R messages from the A-IoT device. The reader may send (e.g., transmit), via the direct link, one or more R2D messages (e.g., R2D transmissions). The A-IoT device may receive the one or more R2D messages from the reader.

The topology in FIG. 21A may comprise a second direct link between the A-IoT device and a second network node (not shown). For example, the network node 2110 may send (e.g., transmit), to the A-IoT device 2120 and via a first direct link, one or more signal and/or A-IoT data. The A-IoT device 2120 may send (e.g., transmit), to the second network node and via the second direct link, one or more second signals and/or second A-IoT data. For example, the network node 2110 transmitting to the A-IoT device may be different from the second network node receiving from the A-IoT device.

In the A-IoT direct network communication, the direct link may comprise and/or referred to as a downlink, an uplink, a sidelink, an A-IoT link, and/or the like. The direct link from the network node to the A-IoT device may comprise an R2D channel. The direct link from the A-IoT device to the network node may comprise a D2R channel.

FIG. 21B, FIG. 21C, and FIG. 21D each show an example of an A-IoT device communication comprising an indirect link. The topologies in FIG. 21B, FIG. 21C, and FIG. 21D may be examples of an A-IoT device communication comprising an indirect link. For example, a topology for an A-IoT indirect network communication may comprise an A-IoT device 2120, a network node 2110, and/or a wireless device. The wireless device may be an intermediate wireless device 2115 in FIG. 21B and/or an assisting wireless device 2130 in FIG. 21C and/or in FIG. 21D. The A-IoT indirect network communication may comprise communication(s) between the A-IoT device 2120 and the network 2110. In the A-IoT indirect network communication, a wireless device may help with conveying information between the A-IoT device and the network. For example, the wireless device may be referred to as an intermediate (wireless) device 2115, an assisting (wireless) device 2130, and/or the like. In FIG. 21B, FIG. 21C, and FIG. 21D, Network 2110 may comprise at least one of: a base station, a cell, a transmission-reception point (TRP), a repeater, a relay, an NTN node, and/or an integrated access and backhaul (IAB) node.

The A-IoT indirect network communication in FIG. 21B may not comprise a direct link between the A-IoT device 2120 and the network 2110. The communication between the A-IoT device and the network may be via a wireless device (e.g., Intermediate wireless device 2115 in FIG. 21B). The wireless device may relay and/or convey control information (A-IoT signaling) and/or A-IoT data generated/transmitted by the network 2110 to the A-IoT device 2120. The wireless device 2115 may relay and/or convey control information and/or A-IoT data/signaling generated/transmitted by the A-IoT device 2120 to the network 2110.

For example, the wireless device 2115 in FIG. 21B may be referred to as an intermediate wireless device (e.g., an intermediate device and/or an intermediate node). The intermediate wireless device 2115 may be referred to as a reader, an interrogator, and/or the like.

The intermediate wireless device 2115 may receive, from the network (e.g., base station) 2110 and via a downlink channel (e.g., PDCCH and/or PDSCH), A-IT data and/or a control signal. A link between the network (e.g., the base station) 2110 and the intermediate wireless device 2115 may be referred as an access link, a link via a Uu interface, an Uu link (e.g., for Uu communication), and/or the like. For example, the intermediate wireless device 2115 may send (e.g., transmit), to the A-IoT device 2120, the A-IoT data and/or the control signal.

The intermediate wireless device 2115 may receive, from the A-IoT device 2120, A-IoT data/signaling. For example, the intermediate wireless device 2115 may send (e.g., transmit), to the network 2110, A-IoT data/signaling, for example, via an uplink channel (e.g., PUCCH and/or PUSCH). The link between the intermediate wireless device 2115 and the network 2110 may comprise an uplink (e.g., PUCCH and/or PUSCH). The link between the intermediate wireless device 2115 and the network 2110 may comprise a downlink (e.g., PDCCH and/or PDSCH). The link between the intermediate wireless device 2115 and the A-IoT device 2120 may comprise a sidelink, an A-IoT link, and/or the like.

The intermediate wireless device 2115 may comprise a wireless device, relay, an NTN node, an IAB node, a second cell, a second base station, a reader, an interrogator, an access point, and/or the like. The intermediate wireless device 2115 may send (e.g., transmit), to the A-IoT device 2120, an RF signal (e.g., energy signal and/or wireless energy transmission). The A-IoT device 2120 may harvest, from the RF signal, energy to be used for A-IoT communication(s). The intermediate wireless device 2115 may communicate with the A-IoT device 2120 with/using an R2D channel and/or a D2R channel.

The intermediate wireless device 2115 may be indicated with one or more resources for A-IoT communication (e.g., for transmissions/receptions to/from the A-IoT device). The intermediate wireless device 2115 may receive one or more messages (e.g., higher layer and/or RRC messages) from the network indicating the one or more resources. The intermediate wireless device 2115 may receive one or more control commands (e.g., DCI and/or MAC CEs) indicating the one or more resources. The intermediate wireless device 2115 may receive the one or more messages and the one or more control commands. The one or more messages may indicate/configure the one or more resources and the one or more control commands may activate the one or more resources.

The one or more control commands may indicate/configure an activation status of the one or more resources. The one or more control commands may comprise one or more fields. The one or more fields may activate the one or more resources. The one or more fields may indicate the activation status of the one or more resources.

The topologies in FIG. 21C and in FIG. 21D may comprise an A-IoT indirect network communication between the A-IoT device 2120 and the network node 2110. The topologies in FIG. 21C and in FIG. 21D may comprise a direct link between the A-IoT device 2120 and the network node 2110. The communication between the A-IoT device 2120 and the network 2110 may be via a wireless device (e.g., Assisting wireless device 2130 in FIG. 21C and/or in FIG. 21D). Between the A-IoT device and the network, there may be a direct link (e.g., Uu link in FIG. 21C and/or FIG. 21D) and an indirect link.

For example, the direct link in FIG. 21C may be for transmission between the network 2110 and the A-IoT device 2120. For example, the direct link may be for transmission from the A-IoT device 2120 to the network 2110. For example, the indirect link may be for transmission from the network 2110 to the A-IoT device 2120. For example, the direct link may comprise a link between Network 2110 and A-IoT device 2120 in FIG. 21C. For example, the indirect link may comprise a link (e.g., Uu link and/or downlink) between the network 2110 and an assisting wireless device 2130 in FIG. 21C. For example, the indirect link may comprise a link (e.g., R2D link or channel) between A-IoT device 2120 and the assisting wireless device 2130 in FIG. 21C.

In FIG. 21C, the network 2110 may send (e.g., transmit) a control signal (e.g., A-IoT signaling) and/or A-IoT data to the wireless device 2130 via an Uu link. The Uu link may comprise a downlink, PDSCH, PBCH, and/or a PDCCH. The wireless device 2130 may convey (relay, forward, and/or send (e.g., transmit)), to the A-IoT device 2120 and via R2D channel, the control signal and/or the A-IoT data that the wireless device 2130 receives from the network 2110. The A-IoT device 2120 may send (e.g., transmit) a second control signal and/or second A-IoT data to the network 2110 via the direct link. The direct link may comprise a D2R link (or channel), uplink, and/or sidelink. The second control signal and/or second A-IoT data may comprise the response to the received control signal and/or A-IoT data from the wireless device 2130.

The direct link in FIG. 21D may be for transmission between the network 2110 and the A-IoT device 2120. For example, the direct link may be for transmission from the network 2110 to the A-IoT device 2120. For example, the indirect link may be for transmission from the A-IoT device 2120 to the network 2110. For example, the direct link may comprise a link between Network 2110 and A-IoT device 2120 in FIG. 21D. For example, the indirect link (e.g., Uu link and/or uplink) may comprise a link between the network 2110 and an assisting wireless device 2130 in FIG. 21D. For example, the indirect link (e.g., D2R link or channel) may comprise a link between A-IoT device 2120 and the assisting wireless device 2130 in FIG. 21D.

In FIG. 21D, the network 2110 may send (e.g., transmit) a control signal (e.g., A-IoT signaling) and/or A-IoT data to A-IoT device 2120 via a direct link. The direct link may comprise a downlink, PDSCH, PBCH, PDCCH, and/or an R2D link (or channel). The A-IoT device 2120 may send (e.g., transmit) a second control signal and/or second A-IoT data to the network 2110 via the indirect link. For example, the A-IoT device 2120 may send (e.g., transmit) the second control signal and/or second A-IoT data to the wireless device 2130 via a link between the A-IoT device 2120 and the wireless device 2130. The link between the A-IoT device 2120 and the wireless device 2130 may comprise an uplink, a sidelink and/or a D2R link (or channel). The wireless device 2130 may convey (relay, forward, and/or send (e.g., transmit)), to the network 2110 and via a Uu link, the second control signal and/or second A-IoT data that the wireless device 2130 receives from the A-IoT device 2120. The Uu link may comprise an uplink, PUCCH, PUSCH, and/or a RACH.

Referring to FIG. 21C and in FIG. 21D, the wireless device 2130 may be referred to as an assisting wireless device (e.g., an intermediate wireless device, an assisting device and/or an assisting node), a reader, an interrogator, and/or the like.

The assisting wireless device 2130 may receive, from the network (e.g., base station) 2110 and via a Uu link comprising a downlink channel (e.g., PDCCH and/or PDSCH), A-IoT data and/or a control signal (A-IoT signaling). The assisting wireless device 2130 may convey (relay, forward, and/or send (e.g., transmit)), to the A-IoT device 2120 via an R2D link (or channel), the A-IoT data and/or the control signal.

The assisting wireless device 2130 may receive, from the A-IoT device 2120 and via a D2R link (or channel), A-IoT data and/or a control signal. The assisting wireless device 2130 may convey (relay, forward, and/or send (e.g., transmit)), to the network (e.g., base station) 2110 and via a Uu link comprising an uplink channel (e.g., PUCCH and/or PUSCH), A-IoT data and/or a control signal.

Referring to FIG. 21C and in FIG. 21D, the link (e.g., Uu link) between the assisting wireless device 2130 and the network 2110 may comprise an uplink (e.g., PUCCH and/or PUSCH) and/or downlink (e.g., PDCCH and/or PDSCH). The link between the assisting wireless device 2130 and the A-IoT device 2120 may comprise an R2D link (or channel), a D2R link (or channel), a sidelink, A-IoT link, and/or the like. The assisting wireless device 2130 may comprise a wireless device, a relay, an NTN node, an IAB device, a second cell, a second base station, a reader, an interrogator, an access point, and/or the like. The assisting wireless device 2130 may send (e.g., transmit), to the A-IoT device 2120, a signal (e.g., RF signal, energy signal, wireless energy transmission) from which the A-IoT device 2120 may harvest energy to be used for A-IoT communication(s).

FIG. 21E shows an example of an A-IoT direct communication. The topology in FIG. 21E may be for direct communication between an A-IoT device 2120 and a wireless device 2140. The topology may comprise a communication between an A-IoT device 2120 and an ambient capable wireless device 2140 with no network node in the middle. The A-IoT device 2120 may communicate bidirectionally with the wireless device 2140. The communication between the wireless device 2140 and the A-IoT device 2120 may comprise the A-IoT data and/or signaling. The communication link between the wireless device 2140 and the A-IoT device 2120 may comprise a sidelink (e.g., comprising a sidelink channel such as PSFCH, PSSCH, PSCCH, PSDCH, and/or the like), A-IoT link, and/or the like. For example, a channel or link from the wireless device 2140 to the A-IoT device 2120 may comprise an R2D link or R2D channel. For example, a channel or link from the A-IoT device 2120 to the wireless device 2140 may comprise a D2R link or D2R channel.

The device-to-device (D2D) communication may comprise A-IoT communications and/or A-IoT topologies. The D2D communication may comprise a communication between a network node and an A-IoT device. The D2D communication may comprise a communication between a wireless device and an A-IoT device.

A link defined, included, and used for the D2D communication may be referred to as a sidelink (SL). The link used for the D2D communication may be referred to as other terminologies, for example, an IoT link, an A-IoT link, a D2D link, and/or the like.

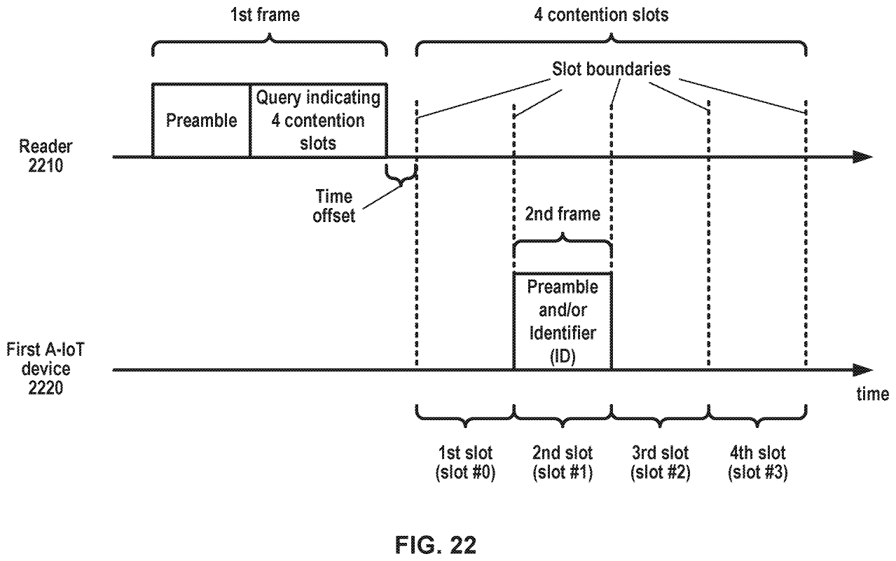

FIG. 22 shows an example of an inventory procedure. The inventory procedure may be referred to as an IoT procedure. In the A-IoT communications, a reader and one or more A-IoT device may perform an inventory procedure. The inventory procedure may refer to a procedure, a process, and/or an operation by which a reader (or a network) may identify one or more A-IoT devices. The inventory procedure may be referred to as an inventory process, an inventory operation, A-IoT device population, a random access procedure (e.g., to identify one or more A-IoT device), an inventory operation, a paging procedure (e.g., to identify one or more A-IoT device), a query procedure, and/or the like.

The inventory procedure may comprise one or more transmissions of one or more commands from a reader to one or more A-IoT devices. The one or more commands may comprise a query command (e.g., referred to as Query). The query command may initiate (e.g., start and/or begin) the inventory procedure. The query command may be referred to as an initial trigger message (e.g., initial trigger of inventory procedure). The one or more commands may comprise an acknowledge command (e.g., referred to as ACK). The one or more commands may comprise a negative-acknowledge command (e.g., referred to as NACK). The one or more transmissions of the one or more commands may comprise a broadcast transmission to one or more A-IoT devices in a proximity area of the reader. For example, the broadcast transmission may comprise a query command. The one or more transmissions of the one or more commands may comprise a groupcast (or multicast) transmission to one or more A-IoT devices in a proximity area of the reader. For example, the groupcast transmission may comprise a query command. The one or more transmissions of the one or more commands may comprise a unicast transmission to a particular A-IoT device in a proximity area of the reader. For example, the unicast transmission may comprise an acknowledge command and/or a negative-acknowledge command.

The one or more transmissions of the one or more commands may comprise a first transmission of one or more first commands and a second transmission of one or more second commands. The one or more first commands may be among the one or more commands. The one or more second commands may be among the one or more commands.

The inventory procedure may comprise one or more inventory rounds. For example, an inventory procedure may comprise a single inventory round. The inventory procedure may be interchangeable with an inventory round, for example, in the case of an inventory procedure being a single inventory round. An inventory procedure may comprise multiple inventory rounds. The reader and one or more A-IoT devices may perform the multiple inventory rounds for the same inventory procedure.

A reader may send (e.g., transmit) a frame comprising a query command, for example, for each of one or more inventory rounds. The query command of the frame may initiate or start an inventory round associated with (e.g., respective to) the query command. The frame comprising the query command may initiate or start an inventory round associated with (e.g., respective to) the query command. The frame may (further) comprise a preamble. The preamble of the frame may initiate or start an inventory round associated with (e.g., respective to) the query command. The preamble may be referred to as an R2D preamble. For example, the preamble may be a timing acquisition signal for R2D. For example, the frame may include the preamble, for example, at least for timing acquisition and for indicating the start of the R2D transmission (e.g., the start of the frame) in time domain.

The frame may be an A-IoT frame. The A-IoT frame may be the same (length) as a frame for Uu communication (e.g., radio frame). The A-IoT frame may comprise one or more A-IoT transmissions. The one or more A-IoT transmission may comprise one or more R2D transmissions (e.g., on/via an R2D channel) and/or one or more D2R transmissions (e.g., on/via a D2R channel).

The A-IoT frame may be different from a frame for Uu communication (e.g., radio frame). For example, an A-IoT frame may comprise a different length from that of the frame for Uu communication (e.g., radio frame). The A-IoT frame may comprise a length (e.g., time length) equal to one A-IoT transmission.

The frame may comprise a postamble. The postamble may be at the end of (e.g., after) the query command. The postamble may indicate an end of the query command.

The frame may comprise a midamble. The midamble may be in the middle of the query command. For example, a first part of the query command may be before the midamble and a second part of the query command may be after the midamble. The midamble may provide timing synchronization (e.g., to the A-IoT device).

The query command may be transmitted/sent on/via a PRDCH. The PRDCH may comprise one or more fields. The one or more fields may contain/indicate/carry the query command.

An inventory round may be terminated by a subsequent frame after a frame comprising a query command initiating the inventory round. The subsequent frame may comprise one or more subsequent commands. For example, the one or more subsequent commands may comprise a second query command (e.g., another or subsequent query command). The second query command may be different from or subsequent to the query command initiating the inventory round. For example, the subsequent frame may terminate the inventory round. For example, the second query command of the subsequent frame may terminate the inventory round. For example, the subsequent frame may comprise a preamble. The preamble of the subsequent frame may terminate the inventory round.

The inventory round may be terminated after a time duration (e.g., InventoryRoundExpiryTimer) from a time at which the inventory round is initiated (e.g., started). The A-IoT device may determine the inventory round is completed, for example, based on a timer (e.g., InventoryRoundExpiryTimer) expiring and/or not running. The A-IoT device may start (e.g., begin) the timer at the initiation of the inventory round. The A-IoT device may stop (e.g., stop running) the timer, for example, after the time duration (e.g., the time duration after starting the timer). The inventory round may be terminated, for example, after one or more contention slots indicated by a query command of a frame that has initiated (e.g., started) the inventory round. The inventory round may be terminated, for example, after a number/quantity of query commands (e.g., after a number/quantity of query commands have been sent (e.g., transmitted), Query Max, and/or a maximum number/quantity of query commands). The A-IoT device may determine the inventory round is terminated, for example, based on receiving the number/quantity of query commands (e.g., after receiving the maximum number/quantity of query commands). An inventory round terminating may be referred to as the inventory round completing, the inventory round finishing, the inventory round ending, or the inventory round closing.

In the present disclosure, a query command initiating a respective inventory round may be interchangeable with a frame (comprising the query command) initiating the respective inventory round. A query command may be referred as a frame comprising the query command. In the present disclosure, a query command initiating a respective inventory round may be interchangeable with a preamble of a frame (comprising the query command) initiating the respective inventory round. A query command may be referred to as a preamble of a frame comprising the query command.

A reader may send (e.g., transmit) a first query command to one or more A-IoT devices. The first query command may initiate or start a first inventory round. The reader may receive one or more responses from at least one (e.g., a first A-IoT device) of the one or more A-IoT devices, for example, during the first inventory round. The reader may send (e.g., transmit) a second query command to the one or more A-IoT devices. The second query command may terminate the first inventory round. The second query command may initiate a second inventory round. The reader may receive one or more second responses from at least one (e.g., a second A-IoT device) of the one or more A-IoT devices, for example, during the second inventory round.

The reader may determine the first inventory round is ongoing, for example, based on (e.g., in response to or after) transmitting the first query command initiating the first inventory round. The reader may determine the first inventory round is ongoing until the reader may send (e.g., transmit) the second query command initiating the second inventory round. The reader may determine the first inventory round is ongoing from a first time to a second time. The first time may be associated with a transmission time of the first query command. The first time may be associated with a transmission time of the second query command.

The one or more A-IoT devices may determine the first inventory round is ongoing, for example, based on (e.g., in response to or after) receiving the first query command initiating the first inventory round. The one or more A-IoT devices may determine the first inventory round is ongoing until the one or more A-IoT devices receive the second query command initiating the second inventory round. The one or more A-IoT devices may determine the first inventory round is ongoing from a first time to a second time. The first time may be associated with a reception time of the first query command. The first time may be associated with a reception time of the second query command.

FIG. 22 shows an example of an inventory round. A reader 2210 may send (e.g., transmit), via an R2D channel, a first frame to one or more A-IoT devices comprising a first A-IoT device 2220. The first frame may comprise a preamble for synchronization of the inventory round. The first frame may comprise a query command. The first frame, the preamble, and/or the query command may initiate an inventory round or an inventory procedure. The query command may indicate a quantity of contention slots starting after the first frame.

The contention slots may be referred to as a slot. The slot may be an A-IoT slot. The A-IoT slot may be a time duration of/for an A-IoT transmission. The A-IoT slot may be a fixed length of time. The A-IoT slot may be the same (value) as a slot for Uu communication (e.g., NR slot). The A-IoT slot may be based on a subcarrier spacing (e.g., based on a numerology) of A-IoT. The A-IoT slot may be based on a subcarrier spacing of a carrier of reference cell (e.g., a reference carrier). The carrier may be for Uu communication. The reference cell may be for Uu communication. The reference carrier may be for Uu communication. A numerology of A-IoT may comprise the subcarrier spacing. The numerology may comprise a cyclic prefix (CP) length. The A-IoT slot may be based on the numerology (e.g., the subcarrier spacing, the CP length, etc.).

An earliest slot of the contention slots may start from the end of a frame with a time offset. An earliest slot of the contention slots may start from the end of the 1st frame with a time offset (e.g., T_{R2Dmin}) as shown in FIG. 22. The time offset (e.g., T_{R2Dmin}) may be a time interval or duration from a transmission of the reader to an A-IoT device response. For example, the time offset (e.g., T_{R2Dmin}) may be a minimum time between a transmission via R2D channel and the corresponding transmission via a D2R channel following the transmission via R2D channel.

The contention slots may be one or more consecutive time slots. For example, in FIG. 22, four contention slots may comprise a first slot (with index slot #0), a second slot (with index slot #1), a third slot (with index slot #2), and a fourth slot (with index slot #3).

The query command may comprise a field indicating the quantity of contention slots. The quantity of contention slots may be 2^{Q}, where Q (or any other letter or symbol) may comprise zero or a positive integer value.

A size of the field, in the query command, indicating the quantity of contention slots may be fixed (e.g., n-bit field). For example, the query command may indicate a size of the field (e.g., n-bit field). For example, for the case of the field being a 4-bit field, ‘0000’ value of the field may indicate that the quantity of contention slots is one (e.g., 2^{Q}=1 with Q=0 in decimal (Q=‘0000’ in binary)). For example, ‘0001’ value of the field may indicate that the quantity of contention slots is two (e.g., 2^{Q}=2 with Q=1 in decimal (Q=‘0001’ in binary)). For example, ‘0010’ value of the field may indicate that the quantity of contention slots is four (e.g., 2^{Q}=4 with Q=2 in decimal (Q=‘0010’ in binary)), and so on.

In FIG. 22, the reader may determine a length of a preamble and/or may send (e.g., transmit) the preamble. The one or more A-IoT device may receive the preamble. The one or more A-IoT device may determine slot boundaries of contention slots using the preamble. For example, the one or more A-IoT device may estimate or detect a length of the preamble, for example, using an RF envelop detector.

A length of each slot or a time interval between two consecutive slot boundaries may be scaled by the length of the preamble. A length of each slot or a time interval between two consecutive slot boundaries may be the length of the preamble minus one or more time offsets. A length of each slot or a time interval between two consecutive slot boundaries may be the length of the preamble plus one or more time offsets.

In FIG. 22, the reader and/or the one or more A-IoT devices may determine the quantity of the contention slots. In FIG. 22, the reader and/or the one or more A-IoT devices may determine a starting time and/or an end time of each slot of contention slots. In FIG. 22, the reader and/or the one or more A-IoT devices may determine slot boundaries of the contention slots.

At least one of the one or more A-IoT devices may receive, via an R2D channel, the first frame. The at least one of the one or more A-IoT devices may be referred to as a first A-IoT device in FIG. 22.

The first A-IoT device may receive, identify, detect, and/or decode a query command of the first frame (e.g., based on receiving the first frame). For example, the first A-IoT device may receive, identify, detect, and/or decode a value of Q in the query command of the first frame (e.g., based on receiving the first frame). The first A-IoT device may determine a number/quantity of contention slot(s) after the first frame. For example, the first A-IoT device may determine that there are 2^{Q} contention slot(s) after the first frame.

The first A-IoT device may select one slot from the contention slot(s). The first A-IoT device may select one slot (e.g., the second slot in FIG. 21) from the 2^{Q} contention slots. The selected slot by the first A-IoT device may be i-th slot where 1≤i≤2^{Q}.

An index of the selected slot by the first A-IoT device may be determined. For example, if a slot index starts from K, an index of the selected slot by the first A-IoT device may be k where K≤k≤2^{Q}+K−1 (K may be a zero or a positive integer number), and/or k=i+K−1. For example, if a slot index starts from 0, an index of the selected slot by the first A-IoT device may be k where 0≤k≤2^{Q}−1 and/or k=i−1 as shown in FIG. 21. For example, if a slot index starts from 1, an index of the selected slot by the first A-IoT device may be k where 1≤k≤2^{Q} and/or k=i.

The first A-IoT device may use a counter to determine when to send (e.g., transmit) the second frame. The counter may be a count-down counter. The counter may be a count-up counter.

The first A-IoT device may (e.g., randomly) select one value. For example, the first A-IoT device may (e.g., randomly) select one of 2^{Q} values. Each value may be associated with and/or may be mapped to a respective contention slot of the contention slots. For example, each of 2^{Q} values may be associated with and/or may be mapped to a respective contention slot of the contention slots. For example, in FIG. 22, the first A-IoT device may select a value 1 out of 2^{Q} values (e.g., 4 values) in the range from 0 to 3. The value 1 may be associated with and/or may be mapped to the second slot and/or the slot #1. The first A-IoT device may load or set the selected value 1 into the counter.

The A-IoT device may change the value of the counter, for example, based on (e.g., in response to) transitioning from one slot to a next slot. For example, the A-IoT device may decrease the value of the counter (e.g., count-down counter) by 1, for example, based on (e.g., in response to) transitioning from one slot to a next slot. For example, the A-IoT device may increase the value of the counter (e.g., count-up counter) by 1, for example, based on (e.g., in response to) transitioning from one slot to a next slot.

The A-IoT device may send (e.g., transmit) the second frame via a contention slot, for example, if the value of the counter reaches the one (value) representing the selected value and/or the selected contention slot. For example, for the count-down counter, the first A-IoT device may send (e.g., transmit) the second frame, for example, when/if the value of the counter reaches zero. The value of the counter may reach zero, for example, if the first A-IoT device starts to decrease a value of the count-down counter from the selected value k, where k is 0≤k≤2^{Q}−1. For example, for the count-up counter, the first A-IoT device may send (e.g., transmit) the second frame, for example, when/if the value of the counter reaches the selected value (e.g., k). The value of the counter may reach the selected value (e.g., k), for example, if the first A-IoT device starts to increase a value of the count-up counter from zero, where k is 0≤k≤2^{Q}−1.

In FIG. 22, the first A-IoT device may select a value 1 (e.g., selected value k=1). For example, the first A-IoT device may load and/or set a value 1 into the counter. For example, the counter may be a count-down counter. For example, the counter may start from the selected value 1. The first A-IoT device may keep the counter value as 1, for example, during the first slot (e.g., slot #0) in FIG. 22. The first A-IoT device may decrease the value of the counter by 1, for example, based on (e.g., after or in response to) transitioning from the first slot to the second slot (e.g., slot #1) in FIG. 22. The value of the counter may be zero, for example, based on (e.g., after or in response to) transitioning to the second slot (e.g., slot #1) in FIG. 22. The value of the counter may be zero, for example, based on (e.g., after or in response to) decreasing the value of the counter by 1. The first A-IoT device may send (e.g., transmit) the second frame via the second slot (e.g., slot #1), for example, based on (e.g., after or in response to) the value of the counter being zero.

The first A-IoT device may use a timer to determine when to send (e.g., transmit) the second frame. The first A-IoT device may start the timer, for example, after/based on/in response to receiving the first frame. The first A-IoT device may select (e.g., determine) a maximum value of the timer, for example, based on the one slot (e.g., by converting the one slot to a length of time). The first A-IoT device may send (e.g., transmit) the second frame via the one slot, for example, based on/in response to the timer expiring (e.g., reaching the maximum value).

The first A-IoT device may send (e.g., transmit) a response (or payload) to the first frame and/or a query command in the first frame, for example, via the selected slot. The selected slot may be or comprise a D2R channel. The response may be a second frame. The response and/or the second frame may comprise an identifier of the first A-IoT device. The identifier may be a random number (or pseudo-random number) that the first A-IoT device selects. A size of random number may be fixed or predefined. For example, the random number may be m-bit random number. For example, m is equal to 16. For example, the second frame may comprise a respective preamble for synchronization of timing for the D2R channel.

The response may comprise a contention resolution identifier. For example, the response may comprise a contention resolution identifier of/for a two-step inventory procedure.

The second frame may comprise a preamble for timing acquisition from the first A-IoT device to the reader. For example, the second frame may comprise the preamble followed by the response in a time domain. The preamble in the second frame may be referred to as a D2R preamble. For example, the preamble in the second frame may be a D2R timing acquisition signal. The preamble in the second frame may be for indicating the start of a transmission (e.g., a start of the second frame or the response) from the first A-IoT device to the reader in time domain.

The second frame may be sent/transmitted on/via a PDRCH. The PDRCH may comprise/carry/contain one or more fields. The one or more fields may indicate the response.

The second frame may comprise a postamble. The postamble may indicate the end of the second frame. The postamble may be after (e.g., at the end of) the response.

A transmission from an A-IoT device to a reader may occur within a slot. For example, a transmission from an A-IoT device to a reader may not occur across two or more slots. For example, a transmission from an A-IoT device to a reader may not occur across any slot boundaries.

The first A-IoT device may send (e.g., transmit) the second frame within the second slot. For example, the transmission of the second frame may start at or after a start time of the second slot. For example, the transmission of the second frame may end at or before an end time of the second slot.

The reader may monitor (or keep monitoring) the contention slots or D2R channels respective to the contention slots. The monitoring the contention slots may be for receiving a response from at least one of the one or more A-IoT devices.

The reader may terminate the (ongoing) inventory round, for example, if the reader receives the second frame via the second slot. For example, the reader may send (e.g., transmit) a third frame comprising another query command. The third frame or the another query command may terminate the (ongoing) inventory round.

The reader may continue the (ongoing) inventory round, for example, after or if the reader receives the second frame via the second slot. For example, the reader may monitor (or keep monitoring) the contention slots (e.g., a third slot and/or a fourth slot). The reader may receive one or more responses from one or more of the A-IoT devices via the third slot and/or the fourth slot. The reader and/or the one or more A-IoT devices may determine that the inventory round is terminated, for example, after or in response to the contention slots (e.g., an end of the fourth slot).

In FIG. 22, the reader may not receive any response from A-IoT device(s) during the contention slots. The reader may initiate another inventory round or another inventory procedure, for example, if the reader does not receive any response from A-IoT device(s) during the contention slots. The reader may adjust a quantity of contentions slots of the another inventory round or the another inventory procedure. The reader may adjust or change a transmit power of a query command initiating the another inventory round or the another inventory procedure. For example, the reader may increase the transmit power, for example, to expand or increase the transmission coverage of the query command. For example, the reader may decrease the transmit power, for example, to shrink or reduce the transmission coverage of the query command.

In FIG. 22, a reader may comprise a network node, a base station, a base station central unit, a base station distributed unit, a TRP, an NTN node, an IAB node, and/or a relay. In FIG. 22, a reader may comprise a wireless device, an assisting wireless device, and/or an intermediate wireless device.

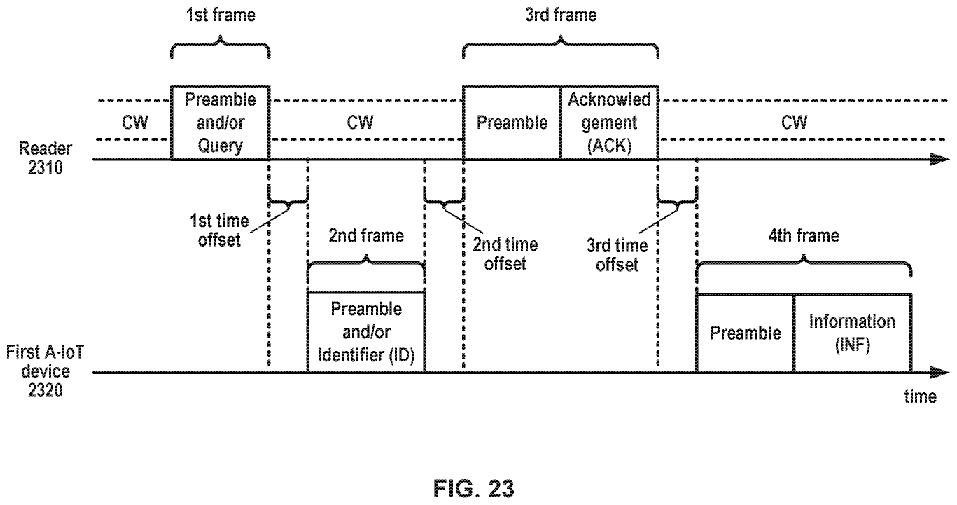

FIG. 23 shows an example of an inventory procedure. The first frame (1st frame) in FIG. 23 may be the first frame (1st frame) in FIG. 22. The second frame (2nd frame) in FIG. 23 may be the second frame (2nd frame) in FIG. 22. The first time offset (1st time offset) in FIG. 23 may be the time offset in FIG. 22.

FIG. 23 shows one or more subsequent transmission/reception after or in response to the 2nd frame in FIG. 22. For example, the one or more subsequent transmission/reception may comprise the third frame (3rd frame) and/or the fourth frame (4th frame) in FIG. 23. For example, the inventory round comprising the first frame (1st frame), the time offset, the second frame (2nd frame) described in FIG. 22 may be the same as the inventory round comprising the first frame (1st frame), the first time offset, the second frame (2nd frame) in FIG. 23, respectively.

A reader 2310 in FIG. 23 may send (e.g., transmit) a first frame to one or more A-IoT devices 2320, for example, via an R2D channel, according to the procedure described in FIG. 21. The first frame may comprise a preamble and/or a query (command). A first A-IoT device of the one or more A-IoT devices may send (e.g., transmit) a second frame to the reader, for example, via a D2R channel, according to the procedure described in FIG. 22. For example, in FIG. 23, the query command in the first frame may indicate a quantity of contention slots. For example, the first A-IoT device may select one (e.g., 2nd slot) of the contention slots. For example, the first A-IoT device may send (e.g., transmit), via the D2R channel of the 2nd slot and to the reader, the second frame. The second frame may comprise a respective preamble and an identifier (ID). For example, the identifier may be a random number that the first A-IoT device selects. The identifier may be a temporary identifier to proceed, with the reader, transmissions/receptions of a third frame and/or a fourth frame in FIG. 23.

In FIG. 23, the reader may receive, from the first A-IoT device and via a D2R channel (e.g., 2nd slot in FIG. 22), the second frame. The reader may determine, acquire, and/or adjust a timing of a transmission/reception of the second frame. The reader may identify and/or decode, using the timing, a payload part in the second frame. The reader may identify and/or receive the identifier (ID) that the first A-IoT device transmits via the second frame.

In FIG. 23, the reader may fail to successfully decode the second frame. For example, the reader may fail to detect and/or receive the second frame. The reader may fail to acquire timing of a transmission/reception of the second frame, for example, from the preamble of the second frame. The reader may fail to decode the payload part in the second frame. In this case, the reader may not send (e.g., transmit) any response or command, for example, after or in response to the second frame. Alternatively, in this case, the reader may send (e.g., transmit) a negative-acknowledgement (NACK) command (e.g., ACK is replaced with NACK in FIG. 23).

The NACK command may be/comprise a response to the second frame. The NACK command may be/comprise a response to the identifier in the second frame. The NACK command may indicate an unsuccessful reception (e.g., decoding failure, failure to decode, and/or the like) of the second frame by the reader.

The reader may terminate, to one or more A-IoT devices comprising the first A-IoT device, the inventory round and/or the inventory procedure initiated by the first frame, for example, based on (e.g., after or in response to) transmitting the NACK command. The A-IoT device may terminate the inventory round and/or the inventory procedure initiated by the first frame, for example, based on (e.g., after or in response to) receiving the NACK command.

The reader may send (e.g., transmit), to the first A-IoT device, an acknowledgement (ACK) command (e.g., ACK in FIG. 23), for example, based on (e.g., after or in response to) receiving the identifier. The reader may construct a third frame, for example, based on (e.g., after or in response to) receiving the identifier. The third frame may comprise a respective preamble and the ACK command. The preamble in the third frame may be a timing acquisition signal for (or of) the third frame sent (e.g., transmitted) by the reader via an R2D channel. The ACK command may comprise the identifier that the reader receives in the second frame.

In FIG. 23, the reader may send (e.g., transmit) the third frame, for example, based on (e.g., after or in response to) receiving the second frame. The time interval or duration between the (reception time of) second frame and the (transmission time of) third frame may be at least a second time offset. For example, the second time offset may be predefined. For example, the time interval or duration may be equal to or longer (larger) than the second time offset. For example, the second time offset (T_{D2Rmin}) may be a minimum time between a D2R transmission and the corresponding R2D transmission following the D2R transmission. For example, the D2R transmission may comprise a transmission of the second frame via a respective D2R channel. For example, the R2D transmission may comprise a transmission of the third frame via a respective R2D channel.

In FIG. 23, the ACK command may be a response to the second frame. The ACK command may be a response to the identifier in the second frame. The ACK command may indicate a successful reception of the second frame by the reader. The ACK command may initiate a transmission, by the first A-IoT device, of a fourth frame subsequent to the third frame.

In FIG. 23, the first A-IoT device may receive the third frame. The first A-IoT device may detect the preamble in the third frame. The first A-IoT device may determine a length or size of the third frame, for example, based on the length of the preamble detected as a part of the third frame. For example, the length or the size of the third frame may be proportional to the length of the preamble in the third frame. For example, the length or the size of the third frame may be the length of the preamble, in the third frame, minus one or more time offset. For example, the length or the size of the third frame may be the length of the preamble, in the third frame, plus one or more time offset.

In FIG. 23, the first A-IoT device may decode a payload part of the third frame. The preamble may be followed by a payload part in the third frame. The payload part of the third frame may comprise a field whose corresponding value may indicate that the payload comprises an ACK command. For example, the value corresponding to the field in the third frame may be an identifier identifying the ACK command among one or more commands. The ACK command may comprise a field whose corresponding field value indicates a value.

The ACK command may comprise an identifier (ID) field. The ID field may indicate that the ACK command is a response to a particular second frame. For example, a value in the ID field may indicate an ID that the reader received in the second frame.

The first A-IoT device may determine whether the value in the ID field in the ACK command is the same as (or matched with) the identifier (ID) that the first A-IoT device may send (e.g., transmit) in the second frame. The first A-IoT device may determine the ACK command is valid for or as the response (and/or ID) in the second frame, for example, if the value in the ID field in the ACK command is the same as (or matched with) the ID that the first A-IoT device transmits in the second frame. The first A-IoT device may determine the ACK command is not valid (or is invalid) for or as the response (and/or ID) in the second frame, for example, if the value in the ID field in the ACK command is not the same as (or is not matched with) the identifier (ID) that the first A-IoT device transmits in the second frame.

The first A-IoT device may not send (e.g., transmit) a response to the third frame (and/or the ACK command), for example, if the first A-IoT device determines the ACK command is not valid (or is invalid) for or as the response (and/or ID) in the second frame. The first A-IoT device may not send (e.g., transmit) a response to the third frame (and/or the ACK command), for example, if the value in the ID field in the ACK command is not the same as (or is not matched with) the identifier (ID) that the first A-IoT device transmits in the second frame.

The first A-IoT device may send (e.g., transmit) a response to the third frame (and/or the ACK command), for example, if the first A-IoT device determines the ACK command is valid for or as the response (and/or ID) in the second frame. The first A-IoT device may not send (e.g., transmit) a response to the third frame (and/or the ACK command), for example, if the value in the ID field in the ACK command is the same as (or is matched with) the identifier (ID) that the first A-IoT device transmits in the second frame.

The response to the third frame may be the fourth frame in FIG. 23. For example, the third frame may initiate a transmission of the fourth frame. For example, the first A-IoT device may send (e.g., transmit), to the reader via a D2R channel, the fourth frame as the response to the third frame (or the ACK command).

In FIG. 23, the first A-IoT device may send (e.g., transmit), via a D2R channel, the fourth frame, for example, based on (e.g., after or in response to) receiving the third frame. In FIG. 23, the reader may receive, via the D2R channel, the fourth frame, for example, based on (e.g., after or in response to) transmitting the third frame.

The time interval or duration between the (reception time of) third frame and the (transmission time of) fourth frame may be at least a third time offset. For example, the third time offset may be predefined. For example, the time interval or duration may be equal to or longer (larger) than the third time offset.

The third time offset may be the same as (or equal to) the first time offset in FIG. 23. For example, the first time offset and/or the third time offset (T_{R2Dmin}) may be a minimum time between an R2D transmission and the corresponding D2R transmission following the R2D transmission. For example, the R2D transmission may comprise a transmission of the first frame via a respective R2D channel. For example, the R2D transmission may comprise a transmission of the third frame via a respective R2D channel. For example, the D2R transmission may comprise a transmission of the second frame via a respective D2R channel. For example, the D2R transmission may comprise a transmission of the fourth frame via a respective D2R channel.

The third time offset may be different from the first time offset in FIG. 23. For example, the third time offset may be the first time offset plus a time offset value. For example, the third time offset may be the first time offset minus a time offset value. For example, the third time offset may be predefined separately from the first time offset. For example, the third time offset may be configured separately from the first time offset.

In FIG. 23, the fourth frame may comprise a preamble and an information (INF) field. The INF field may comprise a value indicating a second ID of the first A-IoT device. The second ID may be a uniquely assigned ID for the first A-IoT device. For example, the reader or network may allocate or assign the second ID to the first A-IoT device, for example, before the inventory procedure (and/or round). For example, the reader or network may write the second ID on the first A-IoT device, for example, before the inventory procedure (and/or round). For example, the reader or network may send or transmit the second ID on the first A-IoT device, for example, before the inventory procedure (and/or round).

The second ID may be a device ID identifying the first A-IoT device. For example, the second ID may be an ID used in an application layer of the first A-IoT device (and/or of the reader/network). For example, the second ID may be an ID, of the first A-IT device, registered to the reader or the network. For example, the second ID may be a global ID used in the network for identifying the first A-IoT device. For example, the second ID may be a physical ID used in the network for identifying the first A-IoT device.

The ID in the second frame may be a temporary ID. For example, the ID in the second frame may be an ID that the first A-IoT device may select for the inventory procedure (and/or round). For example, the ID in the second frame may be different from the second ID. For example, a size of field indicating the ID in the second frame may be different from a size of field indicating the second ID in the fourth frame.

One or more A-IoT devices may select the same ID as the one to be included in the second frame during the inventory procedure. For example, each of the one or more A-IoT devices may have a respective second ID that may be different from other A-IoT devices' second IDs.

The second ID may be hard-coded (e.g., (pre-) programmed) to the first A-IoT device. For example, the first A-IoT device may store the ID in the second frame in a first A-IoT device memory. The first A-IoT device and/or the reader may change information stored in the first A-IoT device memory. The first A-IoT device may overwrite or replace the ID with another ID (e.g., selected in a different inventory procedure or round) in the first A-IoT device memory. For example, the first A-IoT device may store the second ID in the fourth frame in a second A-IoT device memory. The first A-IoT device and/or the reader may not change information stored in the second A-IoT device memory.

The reader may receive, from the first A-IoT device, the fourth frame via the D2R channel. The reader may successfully decode the received fourth frame. The reader may fail to (may unsuccessfully) decode the received fourth frame.

The reader may terminate the initiated inventory procedure or round in FIG. 23, for example, based on (e.g., after or in response to) receiving the fourth frame. The reader may terminate the initiated inventory procedure or round in FIG. 23, for example, based on (e.g., after or in response to) successfully decoding the received fourth frame. The reader may terminate the initiated inventory procedure or round in FIG. 23, for example, based on (e.g., after or in response to) failing to decode the received fourth frame.

The reader may repeat the inventory round described in FIG. 23 for other A-IoT devices in a proximity area of the reader. Each inventory round may be an inventory procedure. One inventory procedure may comprise one or more inventory rounds, each inventory round being described in FIG. 23.

In FIG. 23, the A-IoT device may receive one or more continuous waves (or referred to as a continuous waveform) (CW). The CW may be for energy harvesting of (e.g., may be for energizing) one or more A-IoT devices comprising the first A-IoT device. The reader may send (e.g., transmit) the CW. A separate device (e.g., RF transmitter/emitter) other than the reader may send (e.g., transmit) the CW.

The first A-IoT may harvest energy from the CW. For example, the A-IoT may be energized, for example, based on (e.g., in response to) receiving the CW. The CW may comprise the transmission of the first frame. The CW may comprise the transmission of the third frame. The CW may comprise a CW before the transmission of the first frame in FIG. 23. The CW may comprise a CW between the transmissions of the first frame and the third frame in FIG. 23. The CW may comprise a CW, for example, after the transmission of the third frame in FIG. 23.

The transmission from the first A-IoT device may be a backscatter modulated information signal described in FIG. 17, FIG. 18, FIG. 19, and/or FIG. 20. The backscatter modulated information signal may be referred to as a backscatter signal. For example, the first A-IoT device may generate, amplify, and/or send (e.g., transmit) the backscatter signal using the stored energy harvested from the CW.

The transmission of the second frame may comprise a backscatter modulated information signal using the stored energy harvested from the CW before or prior to the transmission of the second frame. For example, the transmission of the fourth frame may comprise a backscatter modulated information signal using the stored energy harvested from the CW before or prior to the transmission of the fourth frame.

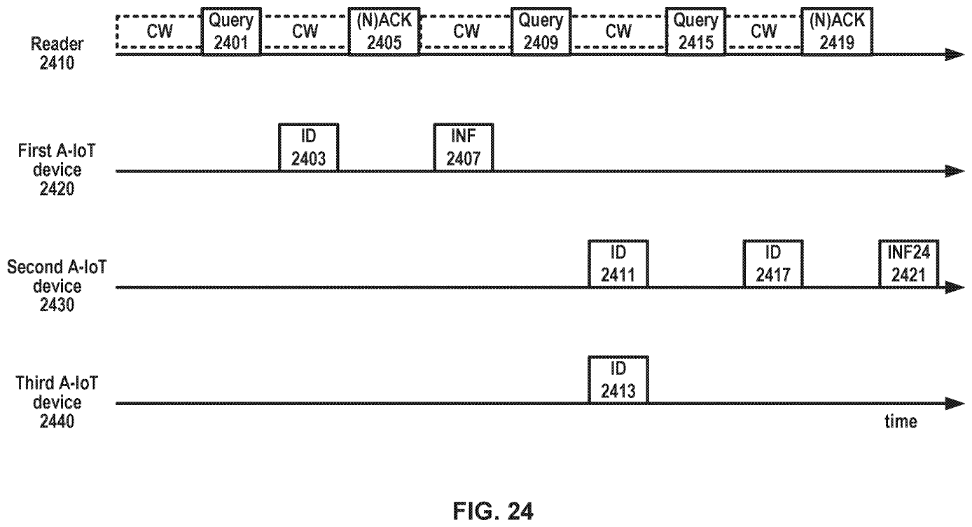

FIG. 24 shows an example of an inventory procedure. FIG. 24 shows an inventory procedure between the reader 2410 and three A-IoT devices 2420, 2430, and 2440. FIG. 24 may refer to signaling, a command structure, and/or reader/A-IoT behaviors described in FIG. 22 and/or FIG. 23.

The query command in the first frame (1st frame) in FIG. 22 and/or FIG. 23 may comprise Query 2401 (and/or Query 2409 and/or Query 2415) in FIG. 23. The Query 2401 (and/or Query 2409 and/or Query 2415) in FIG. 24 may be the simplified description of the first frame and/or the query command in the first frame in FIG. 22 and/or FIG. 23, for example, for simplicity in the drawing. For example, each of the Query 2401 (and/or Query 2409 and/or Query 2415) in FIG. 24 may be in a respective frame comprising a respective preamble as shown in FIG. 22 and/or FIG. 23.

The first frame (2nd frame) and/or ID in the second frame in FIG. 22 and/or FIG. 23 may comprise ID 2403 (and/or ID 2411, ID 2413, and/or ID 2417) in FIG. 24. The ID 2403 (and/or ID 2411, ID 2413, and/or ID 2417) in FIG. 24 may be the simplified description of the second frame and/or the ID in the second frame in FIG. 22 and/or FIG. 23, for example, for simplicity in the drawing. Each of the ID 2403 (and/or ID 2411, ID 2413, and/or ID 2417) in FIG. 24 may be in a respective frame comprising a respective preamble as shown in FIG. 22 and/or FIG. 23.

The third frame (3rd frame) and/or ACK in the third frame in FIG. 23 may comprise (N) ACK 2405 (and/or (N) ACK 2419) in FIG. 24. The (N) ACK 2405 (and/or (N) ACK 2419) in FIG. 24 may be the simplified description of the third frame and/or the ACK in the third frame in FIG. 23, for example, for simplicity in the drawing. For example, each of the (N) ACK 2405 (and/or (N) ACK 2419) in FIG. 24 may be in a respective frame comprising a respective preamble as shown in FIG. 23.

The fourth frame (4th frame) and/or INF in the fourth frame in FIG. 23 may comprise INF 2407 (and/or INF 2421) in FIG. 24. The INF 2407 (and/or INF 2421) in FIG. 24 may be the simplified description of the fourth frame and/or the INF in the fourth frame in FIG. 23, for example, for simplicity in the drawing. For example, each of INF 2407 (and/or INF 2421) in FIG. 24 may be in a respective frame comprising a respective preamble as shown in FIG. 23. For example, in FIG. 24, Query 2401, ID 2403, (N) ACK 2405, and INF 2407 may represent the 1st frame, the 2nd frame, the 3rd frame, and the 4^{th} frame, respectively. For example, in FIG. 24, Query 2401, ID 2403, (N) ACK 2405, and INF 2407 may represent the Query, the ID, the ACK, and the INF, respectively.

For example, in FIG. 24, the signaling from Query 2409 may be the subsequent signaling after or in response to the inventory procedure or round described in FIG. 23. For example, the reader 2410 in FIG. 23 may continue the inventory procedure by transmitting/sending one or more query commands (e.g., Query 2409 and/or Query 2415).

Query 2401 may comprise a first field indicating a first quantity of contention slots as described in FIG. 22 and/or FIG. 23. For example, Q₁ and 2^{Q}^{₁}, respectively, may denote a value of the first field and the first quantity of the first contention slots indicated by the value of the first field.

Query 2409 may comprise a second field indicating a second quantity of second contention slots initiated by Query 2449, for example, according to FIG. 22 and/or FIG. 23. Q₂ and 2^{Q}^{₂}, respectively, may denote a value of the second field and the second quantity of the second contention slots indicated by the value of the second field.

The reader may select Q₂ as the same as Q₁, for example, if there is no conflict detected during the first quantity of the first contention slots indicated by the value of the first field. For example, the reader may select Q₂ being smaller than Q₁, for example, if there is no conflict detected during the first quantity of the first contention slots.

The reader may select Q₂ that is different from Q₁, for example, if there is a conflict (between A-IoT device transmissions) detected during the first contention slots with the first quantity. For example, the reader may select Q₂ that is different from Q₁, for example, if there is a conflict detected during the first contention slots with the first quantity.

In FIG. 24, the second A-IoT device and the third A-IoT device may receive Query 2409. The second A-IoT device may select, according to the description in FIG. 22, a i₂₁-th slot (e.g., slot index #(i₂₁−1)) where 1≤i₂₁≤2^{Q}^{₂}. The third A-IoT device may select, according to the description in FIG. 22, a i₂₂-th slot (e.g., slot index #(i₂₂−1)) where 1≤i₂₂≤2^{Q}^{₂}.

A conflict may occur, for example, if i₂₁=i₂₂, during the second contention slots, between a transmission of ID 2411 and a transmission of ID 2413. The reader may not decode at least one of ID 2411 or ID 2413, for example, if the conflict occurs. The reader may not decode both of ID 2411 and ID 2413, for example, if the conflict occurs. No conflict may occur, for example, if i₂₁≠i₂₂, during the second contention slots, between a transmission of ID 2411 and a transmission of ID 2413. The reader may decode at least one of ID 2411 or ID 2413, for example, if the conflict does not occur. The reader may decode both of ID 2411 and ID 2413, for example, if the conflict does not occur. FIG. 24 shows an example of conflict occurring, during the second contention slots, between a transmission of ID 2411 and a transmission of ID 2413.

In FIG. 24, the conflict may occur between a transmission of ID 2411 and a transmission of ID 2413 and/or the reader may not decode both of ID 2411 and ID 2413. The reader may detect at least one of ID 2411 or ID 2413 and may not decode (or may fail to decode) at least one of ID 2411 or ID 2413. In FIG. 24, the reader may determine to send (e.g., transmit) another query (e.g., Query 2415), for example, for example, based on (e.g., in response to) the conflict detected.

Query 2415 may comprise a third field indicating a third quantity of third contention slots initiated by Query 2415, for example, according to FIG. 22 and/or FIG. 23. Q₃ and 2^{Q}^{₃}, respectively, may denote a value of the third field and the third quantity of the third contention slots indicated by the value of the third field.

As a third quantity of the third contention slots, the reader may select Q₃. For example, the reader may select Q₃ as the same as Q₂, for example, if there is no conflict detected during the second contention slots with the second quantity. For example, the reader may select Q₃ being smaller than Q₂, for example, if there is no conflict detected during the second contention slots initiated by Query 2409. For example, the reader may select Q₃ that is different from Q₂, for example, if there is a conflict (between A-IoT device transmissions) detected during the second contention slots with the second quantity. For example, the reader may select Q₃ that is different from Q₂, for example, if there is a conflict detected during the second contention slots initiated by Query 2409.

In FIG. 24, the second A-IoT device 2430 and the third A-IoT device 2440 may receive Query 2415. The second A-IoT device may select, according to the description in FIG. 22, select a i₃₁-th slot (e.g., slot index #(i₃₁−1)) where 1≤i₃₁≤2^{Q}^{₃}. The third A-IoT device may select, according to the description in FIG. 21, a i₃₂-th slot (e.g., slot index #(i₃₂−1)) where 1≤i₃₂≤2^{Q}^{₃₂}.

A conflict may occur, for example, if i₃₁=i₃₂, during the third contention slots, between a transmission of ID from the second A-IoT device (e.g., ID 2417) and a transmission of ID from the third A-IoT device. The reader may not decode at least one of transmission of ID from the second A-IoT device (e.g., ID 2417) and a transmission of ID from the third A-IoT device, for example, if the conflict occurs. The reader may not decode both of transmission of ID from the second A-IoT device (e.g., ID 2417) and a transmission of ID from the third A-IoT device, for example, if the conflict occurs.

No conflict may occur, for example, if i₃₁≠i₃₂, during the third contention slots, between a transmission of ID from the second A-IoT device (e.g., ID 2417) and a transmission of ID from the third A-IoT device. The reader may decode at least one of transmission of ID from the second A-IoT device (e.g., ID 2417) and a transmission of ID from the third A-IoT device, for example, if the conflict does not occur. The reader may decode both of transmission of ID from the second A-IoT device (e.g., ID 2417) and a transmission of ID from the third A-IoT device, for example, if the conflict does not occur.

FIG. 24 shows an example of no conflict occurring, during the third contention slots, between a transmission of ID from the second A-IoT device (e.g., ID 2417) and a transmission of ID from the third A-IoT device. FIG. 24 shows an example of i₃₁<i₃₂. For example, a contention slot, of the third contention slots, selected by the second A-IoT device occurs before a contention slot, of the third contention slots, selected by the third A-IoT device.

The second A-IoT device may select a random number in ID 2417 as the same as a random number in ID 2411. The second A-IoT device may (re-) select a random number in ID 2417 independent of a random number in ID 2411. For example, the second A-IoT device may select a random number in ID 2417 that is different from a random number in ID 2411.

The second A-IoT device may send (e.g., transmit) a frame comprising ID 2417 to the reader according to description for the second frame in FIG. 22 and/or FIG. 23. For example, the procedure to send (e.g., transmit) the frame comprising ID 2417 may be the same as the procedure to send (e.g., transmit) the second frame in FIG. 22 and/or FIG. 23, for example, by replacing identifier (ID) of the second frame in FIG. 22 or FIG. 23 with ID 2417 in FIG. 24.

The reader 2410 may receive the frame comprising ID 2417. The reader may respond to the frame comprising ID 2417. For example, (N) ACK 2419 may be a response to the ID 2417. (N) ACK 2419 may comprise an ACK command described in FIG. 23. For example, (N) ACK 2419 may comprise an ID field whose corresponding value indicates a (random) value indicated by ID 2417. The reader may send (e.g., transmit) (N) ACK 2419 to one or more A-IoT devices comprising the second A-IoT device.

The second A-IoT device may receive (N) ACK 2419 from the reader. The second A-IoT device may determine whether the value in the ID field in (N) ACK 2419 is the same as (or matched with) the identifier (ID) that the second A-IoT device transmits in ID 2417. The second A-IoT device may determine the (N) ACK 2419 is valid as a response to ID 2417 if the value in the ID field in (N) ACK 2419 is the same as (or matched with) the ID that the second A-IoT device transmits in the second frame. The second A-IoT device may transmit INF 2421 to the reader, for example, if the second A-IoT device may determine the (N) ACK 2419 is valid.

The second A-IoT device may determine (N) ACK 2419 is not valid (or is invalid) for or as the response (and/or ID) in the second frame, for example, if the value in the ID field in (N) ACK 2419 is not the same as (or is not matched with) the identifier (ID) that the second A-IoT device transmits in the second frame. One or more A-IoT devices (e.g., the third A-IoT device) other than the second A-IoT device may not send (e.g., transmit) a response to (N) ACK 2419 to the reader, for example, if the one or more A-IoT device may determine the (N) ACK 2419 is invalid.

In FIG. 24, the A-IoT device may receive one or more continuous waves (or referred to as a continuous waveform) (CW). The CW may be for energy harvesting of (e.g., may be for energizing) one or more A-IoT devices comprising at least one of the first A-IoT device 2420, the second A-IoT device 2430, or the third A-IoT device 2440. The reader may send (e.g., transmit) the CW as described in FIG. 23. A separate device (e.g., RF transmitter/emitter) other than the reader may send (e.g., transmit) the CW as described in FIG. 23.

The at least one of the first A-IoT device, the second A-IoT device, or the third A-IoT device may harvest an energy from the CW. For example, the at least one of the first A-IoT device, the second A-IoT device, or the third A-IoT device may be energized, for example, based on (e.g., in response to) receiving the CW. The CW may comprise the transmission of at least one of Query 2401, (N) ACK 2405, Query 2409, Query 2415, or (N) ACK 2419. The CW may comprise a CW in FIG. 24, for example, before any transmission of the at least one of Query 2401, (N) ACK 2405, Query 2409, Query 2415, or (N) ACK 2419. In FIG. 24, the CW may comprise a CW between any two transmissions of the at least one of Query 2401, (N) ACK 2405, Query 2409, Query 2415, or (N) ACK 2419. The CW may comprise a CW after any transmission of at least one of Query 2401, (N) ACK 2405, Query 2409, Query 2415, or (N) ACK 2419.

The transmission from at least one of the first A-IoT device, the second A-IoT device, or the third A-IoT device may be a backscatter modulated information signal described in FIG. 17, FIG. 18, FIG. 19 and/or FIG. 20. The backscatter modulated information signal may be referred to as a backscatter signal. For example, the first A-IoT device may generate, amplify, and/or send (e.g., transmit) the backscatter signal using the stored energy harvested from the CW.

In the present disclosure, Q or 2^{Q} may indicate a quantity of contention slots. For example, a quantity of contention slots may be 2^{Q}. For example, indicating, determining, comprising a value indicating Q may comprise and/or may be interchangeable with indicating, determining, comprising a quantity of contention slots, 2^{Q}. For example, indicating, determining, comprising a value indicating 2^{Q} may comprise and/or may be interchangeable with indicating, determining, comprising a quantity of contention slots, 2^{Q}.

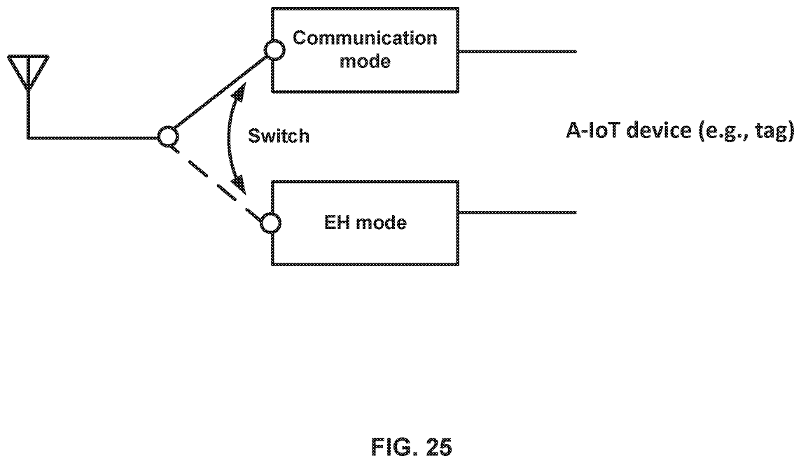

FIG. 25 shows an example of an A-IoT device switching between two modes. In the example of FIG. 25, an A-IoT device (e.g., a tag and/or as discussed with respect to FIGS. 17-20) may comprise one or more antennas. The one or more antennas may be shared (e.g., common) between a communication mode (e.g., communication circuitry) and an energy harvesting mode (e.g., energy harvesting circuitry).

The A-IoT device in FIG. 25 may switch between the communication mode and the energy harvesting (EH) mode. For example, the one or more antennas may work for one of the communication mode or the energy harvesting mode at a time. The A-IoT device may not be in the communication mode, for example, based on being in the energy harvesting mode. The A-IoT device may not be in the EH mode, for example, based on being in the communication mode. The EH mode may be referred to as an EH state. The communication mode may be referred to as a mode/state not for EH (e.g., not in EH mode/state).

The A-IoT device may frequently run out of energy/switch to the EH mode (e.g., compared with an NR UE with full capabilities). The A-IoT device may (periodically) switch to the EH mode to save energy and maintain low complexity (e.g., much lower than an NR UE with full capabilities).

The A-IoT device may not be able to communicate (e.g., with a reader), for example, while/if in the EH mode. The A-IoT device may not receive one or more signals/frames from a reader (e.g., on/via an R2D channel), for example, while/if in the energy harvesting mode.

The A-IoT device may not be able to energy harvest, for example, while/if in the communication mode. The A-IoT device may not be able to energy harvest (e.g., charge a battery) using RF energy, for example, based on/while being in the communication mode.

The A-IoT device may switch to (e.g., enter) the energy harvesting mode, for example, based on a power level of the A-IoT device being below a threshold (e.g., below a threshold value). The A-IoT device may switch to (e.g., enter) the energy harvesting mode, for example, based on an energy level in an energy storage (e.g., energy storage as in FIGS. 17-20) being below a threshold (e.g., threshold value).

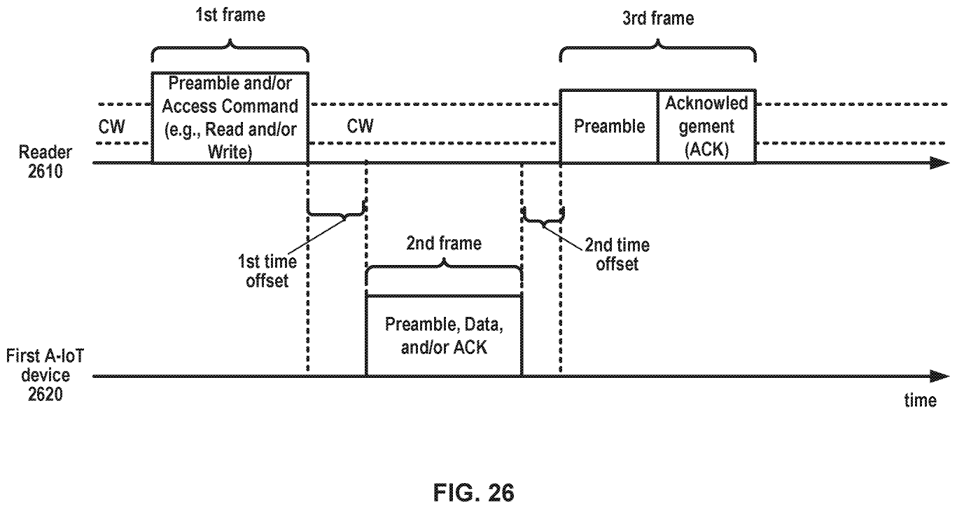

FIG. 26 shows an example of an access procedure (e.g., for A-IoT). The access procedure may be a write procedure/operation (e.g., transfer of data from a reader to an A-IoT device). The write procedure/operation may comprise a reader 2610 transmitting data (e.g., 1^{st} frame in FIG. 26) to an A-IoT device (e.g., first A-IoT device in FIG. 26) 2620. The A-IoT device may receive the data from the reader. The A-IoT device may save (e.g., store and/or keep in memory) the data (e.g., based on receiving it as part of/for the write procedure/operation).

The access procedure may be a read procedure/operation (e.g., transfer of data from the reader to the A-IoT device). The read procedure/operation may comprise an A-IoT device transmitting second data (e.g., 2^{nd} frame in FIG. 26) to the reader. The reader may receive the second data from the A-IoT device. The A-IoT device may send (e.g., transmit) the second data, for example, based on receiving a request from the reader. The reader may send (e.g., transmit) the request (e.g., 1^{st} frame in FIG. 26) to the A-IoT device.

In FIG. 26 the reader may send (e.g., transmit) a first frame (e.g., 1^{st} frame) to the A-IoT device (e.g., first A-IoT device). The first frame may comprise a preamble. The first frame may comprise an access command. The A-IoT device may send (e.g., transmit) a second frame (e.g., 2^{nd} frame) to the reader. The A-IoT device may send (e.g., transmit) the second frame, for example, based on/in response to receiving the first frame. The reader may receive the second frame (e.g., 2^{nd} frame) from the A-IoT device.

The access command may comprise/be a write command. The write command may comprise/indicate the data. The write command may comprise one or more fields. The one or more fields may indicate the data. The second frame may comprise a response (e.g., command response) to the write command. For example, the second frame may comprise/indicate an ACK of the read command (e.g., to indicate the A-IoT device received the read command/the data).

The access command may be a read command. The read command may request the second data (e.g., from the A-IoT device). The read command may comprise one or more fields. The one or more fields may request the second data. The second frame may comprise a response (e.g., command response) to the read command. For example, the second frame may comprise/indicate the second data. The reader may send (e.g., transmit) a third frame (e.g., 3^{rd} frame in FIG. 26), to the A-IoT device, for example, based on receiving the second frame. The A-IoT device may receive the third frame. The third frame may comprise/indicate an ACK of the second frame (e.g., of the second data).

In FIG. 26, a first time offset (e.g., as discussed with respect to FIG. 23) may exist, for example, between the first frame and the second frame. A second time offset (e.g., as discussed with respect to FIG. 23) may exist, for example, between the second frame and the third frame. The reader may send (e.g., transmit) a CW to the A-IoT device (e.g., as discussed with respect to FIG. 23).

The access command may comprise/indicate an ID of the A-IoT device. The access procedure may be after an inventory procedure (e.g., comprising determining the ID of the A-IoT device). The access procedure may be referred to as a command procedure. The access procedure may be referred to as an IoT procedure. The access command may be of the command procedure.

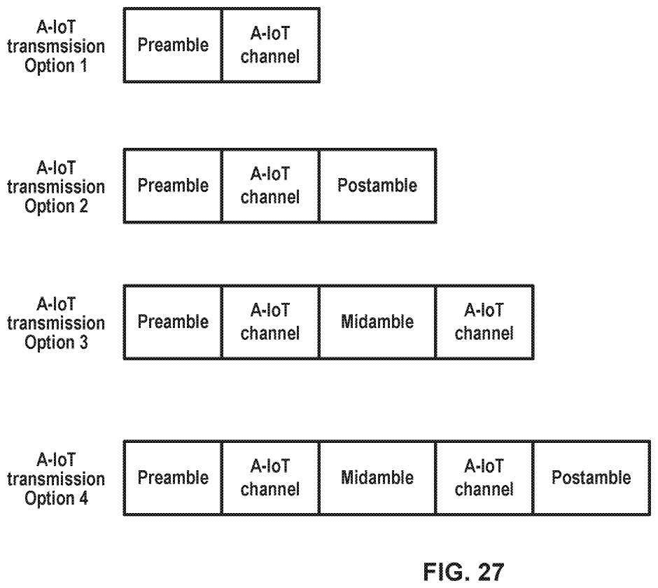

FIG. 27 shows an example of multiple options for A-IoT transmission. The A-IoT transmission may apply to/be used for PRDCH transmission(s) and/or PDRCH transmission(s) (e.g., D2R and/or R2D transmission(s) as discussed with respect to FIG. 17). The A-IoT transmission may comprise a transmission on an A-IoT channel. The A-IoT channel may comprise/be a physical channel. The A-IoT channel may be a PRDCH and/or a PDRCH. A transmitter (e.g., A-IoT device and/or reader) may send (e.g., transmit) the A-IoT transmission. A receiver (e.g., reader and/or A-IoT device) may receive the A-IoT transmission from the transmitter.

A preamble may precede an A-IoT channel, for example, as a first option of A-IoT transmission (e.g., on/via a D2R and/or R2D channel). The preamble may (e.g., immediately) precede (e.g., be adjacent in time to) the A-IoT channel (e.g., a transmission on the A-IoT channel). The preamble may indicate the start of the A-IoT transmission and/or the transmission of/on the A-IoT channel. The preamble may not be part of the A-IoT channel. The preamble may be referred to as an R2D/reader timing acquisition signal (R-TAS). The preamble may be referred to as a D2R timing acquisition signal (D-TAS). The preamble may (e.g., immediately) precede the A-IoT channel, for example, based on a first symbol/chip of the A-IoT channel being an earliest symbol/chip in time after a last symbol/chip of the preamble.

The preamble may comprise two parts. The preamble may comprise a start-indicator part (SIP). The SIP may provide/indicate the start of the A-IoT transmission and/or the transmission of/on the A-IoT channel. The receiver may receive the preamble. The receiver may determine (e.g., calculate) the start of the A-IoT transmission (and/or the transmission of/on the A-IoT channel), for example, based on the (received) preamble and/or the SIP.

The SIP may comprise a first pattern (e.g., ON/OFF pattern and/or high/low voltage transmission). The SIP may comprise a second pattern (e.g., OFF pattern and/or low voltage transmission).

The preamble may comprise a clock-acquisition part (CAP). The CAP may provide/indicate a chip synchronization of the A-IoT channel (e.g., the A-IoT channel transmission after the preamble). The receiver may determine (e.g., calculate) the chip synchronization of the A-IoT channel, for example, based on/using the (received) preamble and/or the CAP. The CAP (of the preamble) may be used to determine the on-off keying (OOK) chip duration. The receiver may determine the OOK chip duration based on/using the CAP. The OOK chip duration may be referred to as an OOK symbol (e.g., one (OOK) chip may be equivalent to one (OOK) symbol). The receiver may determine a number/quantity of OOK chips per symbol based on the CAP. The number of OOK chips per symbol may be the number of OOK chips per OFDM symbol. The OOK chip duration and number of OOK chips per symbol may be related. For example, the number/quantity of OOK chips per symbol may be the length of an (OFDM) symbol divided by the OOK chip duration. The number/quantity of OOK chips per symbol may be 2 (e.g., assuming a SCS of 15 kHz is used for the (OFDM) symbol), for example, if the chip duration is 33.3 us. The number/quantity of OOK chips per symbol may be 4, for example, if the chip duration is 16.67 us. The chip duration may be determined (e.g., calculated) as 1/(M*SCS), where M is the number/quantity of OOK chips per symbol.

The preamble may be a binary signal. The binary signal may comprise a sequence (e.g., binary sequence).

The binary signal may comprise a M-sequence. The M-sequence may be referred to as a maximum length sequence or an n-sequence. The M-sequence may be determined (e.g., generated) using maximal linear feedback shift registers. The M-sequence may comprise a sequence length. The sequence length may be the number/quantity of bits (e.g., number/quantity of symbols and/or chips) of the M-sequence.

The binary signal may comprise a Golay sequence. The Golay sequence may be referred to as a complementary sequence. The Golay sequence may comprise a sequence length. The sequence length may be the number/quantity of bits (e.g., number/quantity of symbols and/or chips) of the Golay sequence.

The binary signal may comprise a Walsh sequence. The Walsh sequence may comprise a sequence length. The sequence length may be the number/quantity of bits (e.g., number/quantity of symbols and/or chips) of the Walsh sequence.

The clock-acquisition part may be based on OOK without line coding. The clock-acquisition part may include rising and falling edges. The clock-acquisition part may comprise at least two rising or at least two falling edges. The receiver may determine (e.g., compute) the OOK chip duration, for example, based on/using the rising and falling edges. The OOK chip duration may be for the A-IoT channel. The receiver may receive the A-IoT channel, for example, using/with/based on the OOK chip duration.

A chip (e.g., a chip duration) may be a unit of time for A-IoT communication. The chip may be the length of one OOK symbol. The OOK chip duration may be referred to as an OOK symbol (e.g., one (OOK) chip may be equivalent to one (OOK) symbol). The chip duration may be different for R2D communication (e.g., PRDCH transmissions) and D2R communication (e.g., PDRCH transmissions). For example, an R2D chip duration (e.g., R2D chip) may be different (e.g., have a different value) than a D2R chip duration (e.g., D2R chip).

The preamble may be used for sampling frequency offset estimation, channel frequency offset estimation, channel estimation, and/or interference estimation. The receive may use the preamble for sampling frequency offset estimation, channel frequency offset estimation, channel estimation, and/or interference estimation.

The preamble may not comprise a SIP. For example, the CAP may (e.g.) provide/indicate the start of the of the A-IoT transmission and/or the transmission of/on the A-IoT channel.

A preamble may precede an A-IoT channel and be followed by a postamble, for example, as a second option of A-IoT transmission (e.g., on/via a D2R and/or R2D channel). The postamble may (e.g., immediately) follow the A-IoT channel. The postamble may provide/indicate the end of the A-IoT transmission and/or the transmission of/on the A-IoT channel. The postamble may (e.g., immediately) follow the A-IoT channel, for example, based on a first symbol/chip of the postamble being an earliest symbol/chip in time after a last symbol/chip of the A-IoT channel.

A preamble may precede an A-IoT channel and a midamble may be in the middle of (e.g., during) the A-IoT channel, for example, as a third option of A-IoT transmission (e.g., on/via a D2R and/or R2D channel). The A-IoT transmission may comprise a first transmission (part) of the A-IoT channel and a second transmission (part) of the A-IoT channel. The midamble may be sent (e.g., transmitted) between the first transmission (part) and the second transmission (part). The midamble may provide/indicate a chip synchronization of the A-IoT channel. The midamble may provide/indicate a continuation of the A-IoT channel. The A-IoT transmission may not comprise a postamble.

Although FIG. 27 shows one midamble, it will be understood that the present disclosure is not limited in this aspect. In other examples, multiple midambles may be included in the A-IoT transmission. For example, a first midamble may follow the first transmission (part) and a second midamble may follow the second transmission (part) and be immediately prior to a third transmission (part) of the A-IoT channel.

A preamble may precede an A-IoT channel, a midamble may be in the middle of (e.g., during) the A-IoT channel, and a postamble may immediately follow the A-IoT channel, for example, as a fourth option of A-IoT transmission (e.g., on/via a D2R and R2D channel). In an example, a midamble may be at an end of the A-IoT channel (e.g., immediately follow the A-IoT channel).

A reader (e.g., intermediate wireless device) may receive one or more messages indicating a set of resources for A-IoT. A base station may send (e.g., transmit) the one or more messages to the reader. The one or more messages may indicate one or more validity criteria for the set of resources. The wireless device may determine (e.g., check) whether the one or more validity criteria are satisfied, for example, before using the set of resources. The wireless device may use (e.g., send (e.g., transmit)/receive on/via) the set of resources, for example, based on the one or more validity criteria being satisfied. The wireless device may not use (e.g., not send (e.g., transmit)/receive on/via) the set of resources, for example, based on the one or more validity criteria not being satisfied. The one or more validity criteria may comprise a timer (e.g., the wireless device may determine whether the timer is running). The one or more validity criteria may comprise a received signal strength (e.g., RSRP) threshold.

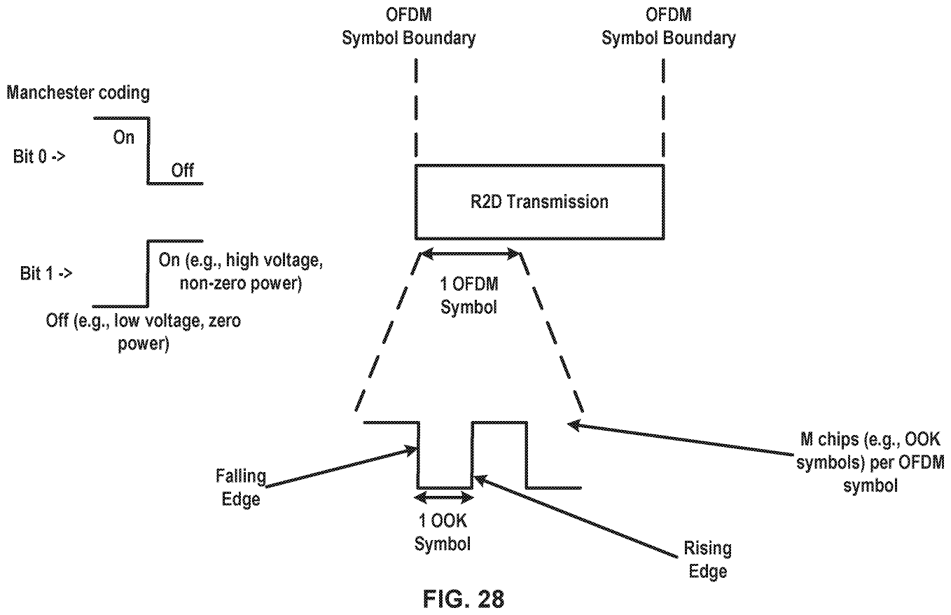

FIG. 28 shows an example of an R2D transmission aligning with an OFDM symbol boundary. In the example of FIG. 28, an R2D transmission (e.g., A-IoT transmission as discussed with respect to FIG. 27) may be aligned with an OFDM symbol boundary (e.g., NR OFDM symbol boundary). A start of the R2D transmission may be the same as (e.g., aligned with) a start of a first OFDM symbol. An end of the R2D transmission, may be the same (e.g., aligned with) an end of a second OFDM symbol.

The R2D transmission may comprise a PRDCH payload (e.g., data (bits), cyclic redundancy check (CRC) bits and/or control (bits)). An end of the PRDCH payload (e.g., a last chip of the PRDCH payload) may not be aligned with the end of the second OFDM symbol. The R2D transmission may comprise one or more padding chips (e.g., padding bits, padding symbols, and/or padding), for example, (e.g., immediately) after the end of the PRDCH payload. An end of the one or more padding chips may be the same as an end of the second OFDM symbol.

The R2D transmission may occur over one or more OFDM symbols (e.g., the R2D transmission may span (in time) one or more OFDM symbols durations (e.g., time duration of the one or more OFDM symbols). The R2D transmission may comprise a number/quantity of chips per OFDM symbol. The number of chips per OFDM symbol may be a number/quantity of OOK symbols per OFDM symbol. The number of chips per OFDM symbol may be a number/quantity of A-IoT chips per OFDM symbol. The number of chips per OFDM symbol may be referred to as M. M (e.g., the number/quantity of chips per OFDM symbol) may for example be 1, 2, 4, 8, 16, 24, 32, and/or the like.

The number/quantity of chips per OFDM symbol may be related to a chip (e.g., OOK chip) duration. For example, a time length of the OFDM symbol divided by the number of chips per OFDM symbol may equal the chip (e.g., OOK chip/symbol) duration. An OOK chip/symbol may be 0 (e.g., zero power and/or OFF). A 0 OOK chip/symbol (e.g., OFF OOK chip/symbol) may represent a 0 bit. A 1 OOK chip/symbol (e.g., ON OOK chip/symbol) may represent a 1 bit. An OOK chip/symbol may be 1 (e.g., non-zero power and/or ON). A transition (e.g., change) from a 1 OOK chip/symbol (e.g., ON OOK chip/symbol) to a 0 OOK chip/symbol (e.g., OFF OOK chip/symbol) may be referred to as a falling edge (e.g., a transition from high voltage to low voltage). A transition from a 0 OOK chip/symbol (e.g., OFF OOK chip/symbol) to a 1 OOK chip/symbol (e.g., ON OOK chip/symbol) may be referred to as a rising edge (e.g., a transition from low voltage to high voltage).

A falling edge may indicate an end of the 1 OOK chip/symbol and a start of the 0 OOK chip/symbol. For example, the falling edge may be the transition between the end of the 1 OOK chip/symbol and the start of the 0 OOK chip/symbol. A rising edge may indicate an end of the 0 OOK chip/symbol and a start of the 1 OOK chip/symbol. For example, the rising edge may be the transition between the end of the 0 OOK chip/symbol and the start of the 1 OOK chip/symbol.

A-IoT communication may use (e.g., apply) line coding and/or a coding rule. The line coding (e.g., coding rule) may be Manchester coding. In Manchester coding, the combination of a 1 OOK chip/symbol followed by a 0 OOK chip/symbol may represent a bit of 0. In Manchester coding, the combination of a 0 OOK chip/symbol followed by a 1 OOK chip/symbol may represent a bit of 1.

CRC bits may be used for error detection (e.g., during decoding). CRC bits may be used by a physical layer to determine if errors occurred during decoding and/or reception. CRC bits may be at an end of a payload (e.g., PRDCH payload). In an example, one or more first CRC bits may be used for L1 control information (e.g., after one or more L1 control bits). One or more second CRC bits may be used for one or more data bits (e.g., after the one or more L1 control bits and/or the one or more first CRC bits). An A-IoT device may decode the one or more first CRC bits to receive the L1 control information prior to decoding the one or more data bits and/or the one or more second CRC bits.

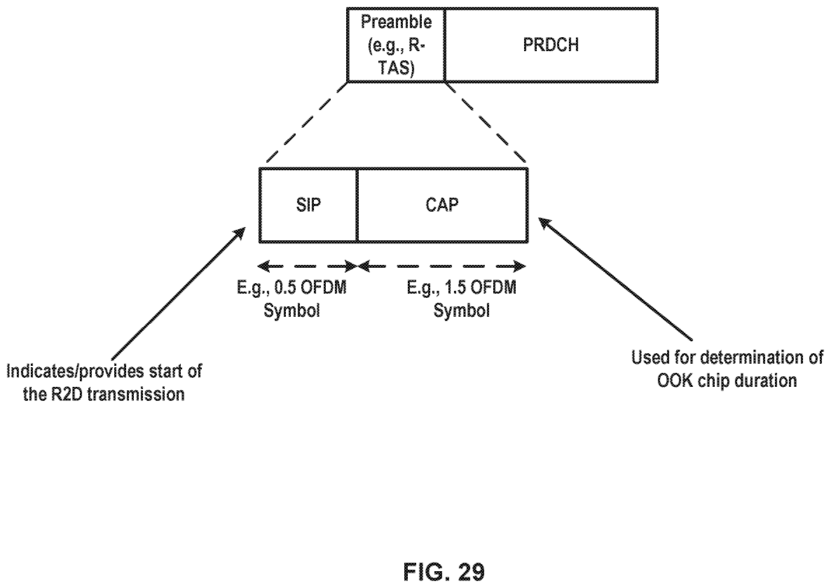

FIG. 29 shows an example R2D transmission. In the example of FIG. 29, an R2D transmission may comprise a preamble transmission and a PRDCH transmission (e.g., similar to as discussed with respect to FIGS. 22 and 27). The preamble transmission may be of the PRDCH transmission (e.g., indicate the start of the PRDCH transmission). The preamble transmission may be referred to as a reader timing acquisition signal (R-TAS). The R-TAS may comprise a SIP and a CAP. A reader may send (e.g., transmit) the R2D transmission. An A-IoT device may receive the R2D transmission.

The SIP may be a duration in terms of a time duration of a number/quantity of OFDM symbols (e.g., 0.5 OFDM symbols long). The time duration of the SIP may be fixed (e.g., not dependent on M (e.g., the number of chips per OFDM symbol)). The SIP may indicate (e.g., provide) a start of the R2D transmission. The SIP may comprise a single ON-OFF transmission (e.g., one ON symbol (e.g., OOK symbol) and one OFF symbol (e.g., OOK symbol)). The ON symbol and the OFF symbol may be different time durations. The time duration of the ON symbol and the time duration of the OFF symbol may be defined by a ratio. For example, the ratio of the time duration of the ON symbol to the time duration of the OFF symbol may be 1:1, 1:2, 1:3, 2:1, 3:1, and/or the like.

The SIP may comprise multiple ON-OFF transmissions (e.g., more than a single ON-OFF). The ON symbols and OFF symbols (of the multiple ON-OFF transmission) may be different time durations.

The CAP may be a duration in terms of a time duration of a number/quantity of OFDM symbols (e.g., 1.5 OFDM symbols long). The CAP may comprise at least two rising edges or at least two falling edges (e.g., as discussed with respect to FIG. 28).

A starting chip of the CAP and an ending chip of the SIP may be different voltages (e.g., different value). For example, the ending chip of the SIP may be OFF and the starting chip of the CAP may be ON.

The A-IoT device may determine a sampling frequency offset (SFO), for example, based on receiving the CAP. The A-IoT device may determine a time synchronization based on receiving the CAP. The A-IoT device may determine a channel estimate, for example, based on receiving the CAP. The A-IoT device may determine a chip duration (e.g., OOK chip duration) of the CAP, for example, based on receiving the CAP. The A-IoT device may determine a number/quantity of chips per symbol of the CAP, for example, based on receiving the CAP. The A-IoT device may determine a chip duration (e.g., OOK chip duration) of the PRDCH transmission, for example, based on receiving the CAP. The A-IoT device may determine a number/quantity of chips per symbol of the PRDCH, for example, based on receiving the CAP. The chip duration of the CAP and the chip duration of the PRDCH transmission may be the same. The A-IoT device may determine the number of chips per symbol based on the chip duration. The A-IoT device may determine the chip duration, for example, based on the number of chips per symbol.

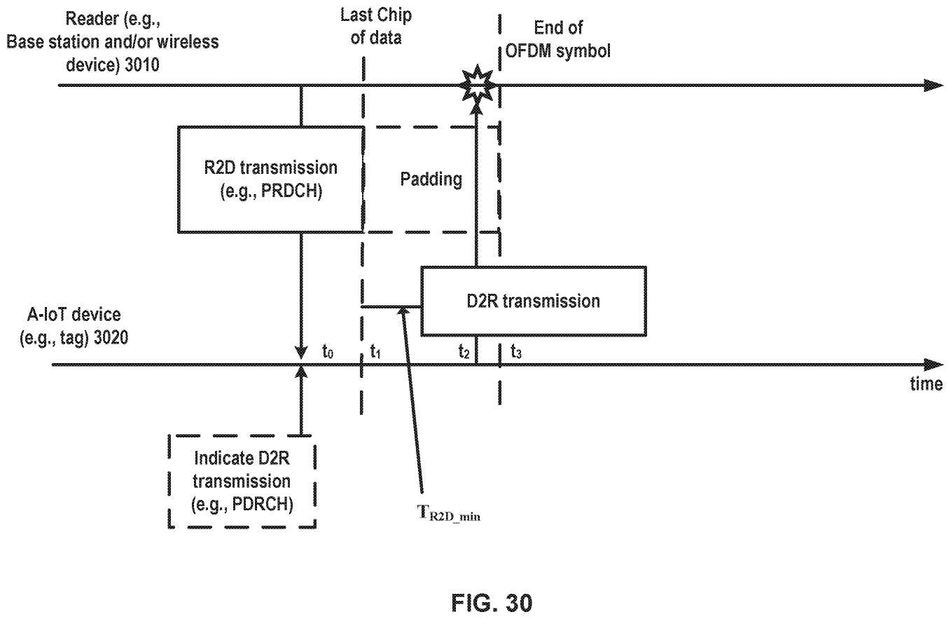

FIG. 30 shows an example of an R2D transmission and a subsequent D2R transmission. An A-IoT device (e.g., IoT device and/or tag) 3020 may receive an R2D transmission, for example, at (e.g., in, on, and/or during) time/time interval to in FIG. 30. A reader (e.g., base station, wireless device and/or intermediate wireless device) 3010 may send (e.g., transmit) the R2D transmission to the A-IoT device 3020. The R2D transmission may comprise/carry one or more messages. The one or more messages may comprise one or more A-IoT messages (e.g., A-IoT messages from an A-IoT network function).

The one or more messages may indicate (e.g., schedule and/or configure) a D2R transmission. The D2R transmission may comprise a PDRCH. The one or more messages may comprise one or more control commands (e.g., DCI(s) and/or MAC CE(s)). The one or more messages may indicate (e.g., schedule and/or configure) one or more resources for the PDRCH. The one or more messages may indicate (e.g., schedule and/or configure) a PDRCH transmission (e.g., a transmission on the PDRCH). The PDRCH transmission may be associated with a preamble transmission (e.g., as discussed with respect to FIGS. 22, 23, 26, 27). The one or more messages may indicate a starting time (e.g., starting symbol/chip/slot) of the PDRCH transmission.

The one or more messages may indicate a preamble transmission. The preamble transmission may be associated with the PDRCH transmission. The preamble transmission may be associated with the PDRCH transmission, for example, based on the preamble transmission (e.g., immediately) preceding the PDRCH transmission. The preamble transmission may be associated with the PDRCH transmission, for example, based on the preamble transmission comprising information used (e.g., required) to decode the PDRCH transmission. The preamble transmission may be associated with the PDRCH transmission, for example, based on the preamble transmission providing time/frequency synchronization information to communicate the PDRCH transmission. The preamble transmission may be associated with the PDRCH transmission, for example, based on the preamble transmission indicating a start (e.g., starting chip/symbol/slot) of the PDRCH transmission. The preamble transmission may be associated with the PDRCH transmission, for example, based on the preamble transmission providing sampling frequency offset (SFO) information to receive the PDRCH transmission.

The one or more messages may indicate the preamble transmission. The one or more messages may indicate that the preamble transmission is associated with the PDRCH transmission. The preamble transmission may be associated with the PDRCH transmission, for example, based on the preamble transmission indicating a start of the PDRCH transmission. The preamble transmission may be associated with the PDRCH transmission, for example, based on the preamble transmission being used for timing acquisition for the PDRCH transmission.

The one or more messages may indicate (e.g., schedule) a starting time of the preamble transmission. The starting time may be at least one of a starting symbol, a starting chip, or a starting slot. The one or more messages may indicate the preamble transmission, for example, based on indicating the PDRCH transmission. The A-IoT device may determine to send (e.g., transmit) the preamble, for example, based on the one or more messages indicating the PDRCH transmission. The A-IoT device may determine the starting time of the preamble transmission, for example, based on a starting time of the PDRCH transmission. The A-IoT device may determine to send (e.g., transmit) the preamble transmission, for example, prior to (or before) the starting time of the PDRCH transmission.

The R2D transmission may comprise a R-TAS (e.g., as discussed with respect to FIG. 29) and a PRDCH transmission. The PRDCH transmission may indicate the D2R transmission and/or the PDRCH transmission. The PRDCH transmission may be referred to as the PRDCH transmission triggering the PDRCH transmission, for example, based on the PRDCH transmission indicating the PDRCH transmission. The A-IoT device may determine a chip duration (e.g., OOK chip duration), for example, based on the R-TAS. The A-IoT device may determine a number/quantity of chips per symbol, for example, based on the R-TAS. The R2D transmission may indicate the chip duration. The R2D transmission may indicate the number/quantity of chips per symbol.

A last (e.g., final and/or ending) chip of data (e.g., data in/carried in the R2D transmission) may occur, for example, at (e.g., in, on, and/or during) time/time interval t₁ in FIG. 30. One or more padding chips (e.g., padding) may occur, for example, after the last chip of data. The one or more padding chips may be present, for example, based on the last chip of data not being aligned with an end of a symbol (e.g., OFDM symbol).

The A-IoT device may determine an end of the R2D transmission (e.g., end of the PRDCH transmission), for example, based on the last chip of data. The A-IoT device may determine the end of the R2D transmission as the end of the last chip of data. The A-IoT device may determine the end of the R2D transmission as the chip duration, for example, after the rising or falling edge (e.g., similar to as discussed with respect to FIG. 28) indicating the start of the last chip of data.

The A-IoT device may start a minimum time duration (e.g., minimum time, minimum timer, minimum time length, and/or minimum time window) at the end of the R2D transmission (e.g., from the last chip of data). For example, the A-IoT device may determine the end of the last chip of data as the beginning of the minimum time duration. The A-IoT device may start the minimum time duration, for example, based on determining the end of the R2D transmission. The minimum time duration may be a minimum time duration between reception of R2D and transmission of D2R (e.g., supported by the A-IoT device). The minimum time duration may be referred to as T_{R2D_min}.

The A-IoT device may send (e.g., transmit) the D2R transmission (e.g., comprising the preamble transmission and/or the PDRCH transmission), for example, at (e.g., in, on, and/or during) time/time interval t₂ in FIG. 30. The reader may receive the D2R transmission from the A-IoT device. The minimum time duration may end at (or prior to) t₂. The A-IoT device may send (e.g., transmit) the D2R transmission no earlier than (e.g., at a time starting on/at or after) the minimum time duration from the end of the R2D transmission. The A-IoT device may start to send (e.g., transmit) the D2R transmission no earlier than the minimum time duration from the end of the R2D transmission. The A-IoT device may send (e.g., transmit) a first chip of the D2R transmission no earlier than the minimum time duration from the end of the R2D transmission. The A-IoT device may may send (e.g., transmit) a first chip of the preamble transmission (of the D2R transmission) no earlier than the minimum time duration from the end of the R2D transmission.

The one or more padding chips may end, for example, at (e.g., in, on, and/or during) time/time interval t₃ in FIG. 30. The end of the one or more padding chips may be aligned with the end of the symbol (e.g., OFDM symbol). For example, a time duration (e.g., time length) of the one or more padding chips may be equal to (t₃−t₁). For example, the one or more padding chips may end at the same time as the end of the symbol. The time duration of the one or more padding chips may be based on the number/quantity of chips per symbol of the R2D transmission (e.g., of the PRDCH transmission). The time duration of the one or more padding chips may be based on the chip duration of the R2D transmission (e.g., of the PRDCH transmission). For example, the time duration of the one or more padding chips may be a first time duration, for example, based on the number/quantity of chips per symbol being a first value (e.g., 2). The time duration of the one or more padding chips may be a second time duration, for example, based on the number/quantity of chips per symbol being a second value (e.g., 16). The first time duration may be shorter (e.g., a smaller value) than the second time duration, for example, based on the first value being smaller than the second value.

In at least some wireless communications, an A-IoT device may send (e.g., transmit) a D2R transmission (e.g., may start to send (e.g., transmit) the D2R transmission) prior to (or before) an end of one or more padding chips. The A-IoT device may be unaware of the presence of the one or more padding chips. For example, the A-IoT device may not receive the one or more padding chips (e.g., based on determining an end of the R2D transmission).

In at least some wireless communications, a reader may not receive a D2R transmission, for example, based on the D2R transmission starting prior to an end of the one or more padding chips. The reader may not receive the D2R transmission, for example, based on the D2R transmission starting prior to an end of a symbol (e.g., OFDM symbol). The reader may not be able to receive the D2R transmission, for example, based on (e.g., while) the one or more padding chips being/are ongoing (e.g., occurring). The A-IoT device may send (e.g., transmit) a transmission (such as a DR2 transmission) asynchronously (e.g., not necessarily aligned with symbol/slot boundaries). The reader not receiving the D2R transmission may lead to issues such as a decreased data rate, an increased power consumption of the reader and the A-IoT device (e.g., due to retransmissions), an increased overhead, and/or a decreased efficiency.

Examples described herein provide improved D2R transmissions. An A-IoT device may determine an amount of time or a time duration (e.g., an R2D time duration, an R2D minimum time), for example, among a plurality of time durations (e.g., R2D time durations, R2D minimum times). The A-IoT device may determine the amount of time or the time duration, for example, based on information such as a number/quantity of chips per symbol of an R2D transmission. As an example, the A-IoT device may send (e.g., transmit) a D2R transmission based on or no earlier than (e.g., at a time starting on/at or after) the amount of time (or the time duration, e.g., the R2D minimum time) after (e.g., following, from) an end of the R2D transmission. A reader may receive the D2R transmission from the A-IoT device.

Examples described herein may enable the reader to receive the D2R transmission (e.g., comprising the preamble transmission and the PDRCH transmission) with improved communications, such as an increased data rate, decreased power consumption of the reader and/or the A-IoT device, decreased overhead, and/or an increased efficiency.

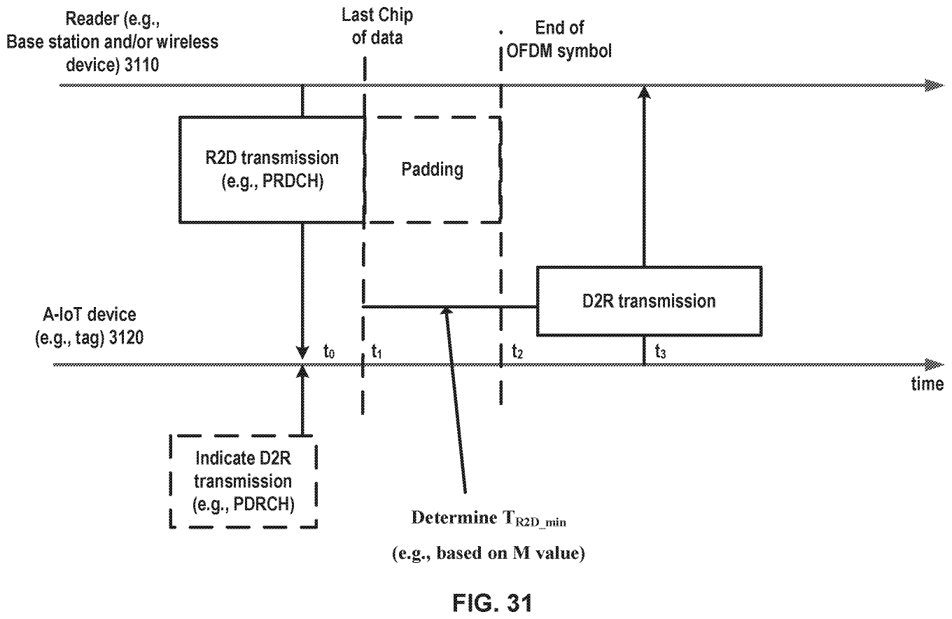

FIG. 31 shows an example of an R2D transmission and a subsequent D2R transmission. The example of FIG. 31 may be used together with or independently from any of the previous examples (e.g., in FIGS. 1A-30).

An A-IoT device (e.g., IoT device and/or tag) 3120 may receive an R2D transmission (e.g., similar to as discussed with respect to FIG. 30), for example, at (e.g., in, on, and/or during) time/time interval to in FIG. 31. A reader (e.g., base station, wireless device and/or intermediate wireless device) 3110 may send (e.g., transmit) the R2D transmission to the A-IoT device 3120. The R2D transmission may indicate a D2R transmission.

The R2D transmission may comprise a R-TAS transmission, a PRDCH transmission, and/or a postamble transmission. The PRDCH transmission may indicate (e.g., trigger) the D2R transmission. The R2D transmission may be associated with a number/quantity of chips per symbol (e.g., M value). The number/quantity of chips per symbol may be for the PRDCH transmission. The number/quantity of chips per symbol may be for the R-TAS transmission (e.g., of a CAP of the R-TAS). The number/quantity of chips per symbol may be for the postamble transmission. The A-IoT device may determine the number/quantity of chips per symbol, for example, based on receiving the R-TAS transmission (e.g., based on the CAP of the R-TAS).

The R2D transmission may be associated with a chip duration. The chip duration may be for the PRDCH transmission. The chip duration may be for the R-TAS transmission (e.g., of the CAP of the R-TAS). The chip duration may be for the postamble transmission. The A-IoT device may determine the chip duration, for example, based on receiving the R-TAS transmission. The D2R transmission may comprise a preamble transmission (e.g., D-TAS), a PDRCH transmission, and/or one or more midamble transmissions.

A last (e.g., final and/or ending) chip of data (e.g., data in/carried in the R2D transmission) may occur (e.g., similar to as discussed with respect to FIG. 30), for example, at (e.g., in, on, and/or during) time/time interval t₁ in FIG. 31. One or more padding chips (e.g., padding) may occur, for example, after the last chip of data. The one or more padding chips may be present, for example, based on the last chip of data not being aligned with an end of a symbol (e.g., OFDM symbol). The last chip of data may be in the symbol.

The R2D transmission may comprise (e.g., contain and/or carry) a PRDCH payload (e.g., payload of the PRDCH transmission and/or payload of the R2D transmission). The PRDCH payload may comprise one or more chips of data. The last chip of the data may be a last (e.g., final and/or ending) chip of the PRDCH payload (e.g., of the one or more chips of data).

The R2D transmission may indicate a size of the PRDCH payload. The R2D transmission may comprise one or more control commands (e.g., MAC CEs). The one or more control commands may comprise one or more fields. The one or more fields may indicate the size of the R2D transmission. For example, the one or more fields may indicate the size of the PRDCH payload (e.g., TB size and/or amount of data in the PRDCH transmission).

The A-IoT device may determine the last chip of data, for example, based on the size of the PRDCH payload. The A-IoT device may determine a total number/quantity of chips of the PRDCH (e.g., number/quantity of the one or more chips of data), for example, based on the size of the PRDCH payload. The A-IoT device may determine the last chip of data, for example, based on the total number/quantity of chips of the PRDCH.

The A-IoT device may determine an end of the R2D transmission. The A-IoT device may determine the last chip of data as the end of the R2D transmission. The A-IoT device may determine the end of the R2D transmission (e.g., the last chip of data), for example, based on the size of the R2D transmission (e.g., PRDCH payload).

The A-IoT device may determine the end of the R2D transmission as an end of the postamble. For example, the A-IoT device may determine the end of the postamble as the last chip of data.

The A-IoT device may determine the end of the R2D transmission (e.g., the last chip of data), for example, based on a violation of a coding rule. The coding rule may be a Manchester coding rule (e.g., as discussed with respect to FIG. 28). The A-IoT device may determine the violation of the coding rule, for example, based on not detecting the coding rule for a time duration after a chip of the R2D transmission (e.g., a chip of the PRDCH payload and/or a chip of the one or more chips). The A-IoT device may determine the violation of the coding rule, for example, based on not detecting a rising edge or falling edge (e.g., as discussed with respect to FIG. 28) for the time duration after a chip of the R2D transmission. The time duration may be a fixed value (e.g., 20 us and/or 40 us). The R2D transmission may indicate the fixed value.

The violation of the coding rule may be associated with a required time. The A-IoT device may determine the violation of the coding rule within the required time (e.g., from the end of the R2D transmission). The required time may be based on the number/quantity of chips per symbol (e.g., of the R2D transmission). The required time may be based on the chip duration (e.g., of the R2D transmission).

The A-IoT device may receive one or more messages (e.g., A-IoT messages). The reader may send (e.g., transmit) the one or more messages to the A-IoT device. The one or more messages may indicate the time duration.

The A-IoT device may start an R2D minimum time (e.g., minimum time length, time duration, and/or R2D minimum timer) from the last chip of data. For example, the A-IoT device may determine the last chip of data as the start of the R2D minimum time. For example, the R2D minimum time may be expressed in terms of X1 ns, X2, μs, X3 ms, etc. The R2D minimum time may be expressed in terms of number/quantity of chips (e.g., Y1 chips and/or the time duration of Y1 chips). The R2D minimum time may be referred to as time duration or R2D time duration.

Although FIG. 31 may show the A-IoT device determining the R2D minimum time, it will be understood that the present disclosure is not limited in this aspect. In other examples, the reader may determine the R2D minimum time (e.g., similar to as discussed above for the A-IoT device). In other examples, both the reader and the A-IoT device may determine the R2D minimum time.

The one or more padding chips may end (e.g., similar to as discussed with respect to FIG. 30), for example, at (e.g., in, on, and/or during) time/time interval t₂ in FIG. 31. The symbol (e.g., OFDM symbol) may end at time/time interval t₂ in FIG. 31. The end of the one or more padding chips may be aligned with the end of the symbol.

The A-IoT device may send (e.g., transmit) the D2R transmission (e.g., similar to as discussed with respect to FIG. 30), for example, at (e.g., in, on, and/or during) time/time interval t₃ in FIG. 31. The reader may receive the D2R transmission from the A-IoT device. The A-IoT device may send (e.g., transmit) the D2R transmission no earlier than (e.g., at a time starting on/at or after) the R2D minimum time after the end of the R2D transmission. The A-IoT device may send (e.g., transmit) the D2R transmission no earlier than the R2D minimum time after the last chip of data.

The A-IoT device may determine the R2D minimum time, for example, based on the number/quantity of chips per symbol of the R2D transmission (e.g., number/quantity of chips per symbol of the PRDCH transmission, and/or M value). The A-IoT device may determine the R2D minimum time among a plurality of R2D minimum times. Each of the plurality of R2D minimum times may be a minimum time, supported by the A-IoT device for a respective number/quantity of chips per symbol, between reception of R2D and transmission of D2R. For example, there may be a mapping between the plurality of R2D minimum times and different values of the number/quantity of chips per symbol.

The A-IoT device may determine the R2D minimum time, for example, based on the chip duration of the R2D transmission (e.g., chip duration of the PRDCH transmission). Each of the plurality of R2D minimum times may be a minimum time, supported by the A-IoT device for a respective chip duration, between reception of R2D and transmission of D2R. For example, there may be a mapping between the plurality of R2D minimum times and different values of the chip duration. For example, there may be a mapping (or a relation) between the plurality of R2D minimum times and different values of the chip duration.

A table of the plurality of R2D minimum times and/or the different values of the number/quantity of chips per symbol may be provided. The table may be of the plurality of R2D minimum times and the different values of the chip duration. For example, the table may indicate a mapping and a relation between the plurality of R2D minimum times and the different values of the chip duration. The A-IoT device may determine the number/quantity of chips per symbol (e.g., based on the R-TAS). The A-IoT device may determine the R2D minimum time, for example, based on the table and the number/quantity of chips per symbol (e.g., by using the row of the table associated with the number/quantity of chips per symbol). For example, a first row of the table may contain C1 number/quantity of chips per symbol (e.g., C1=16) and R1 R2D minimum time (e.g., R1=70 μs). The A-IoT device may determine the number/quantity of chips per symbol of the R2D transmission is C1 (e.g., 16) and determine the R2D minimum time as R1 (e.g., 70 us). A second row of the table may contain C2 number/quantity of chips per symbol (e.g., C2=24) and R2 R2D minimum time (e.g., R2=75 us). The A-IoT device may determine the R2D minimum time as R2 (e.g., 75), for example, based on (e.g., in response to) the number/quantity of chips of the R2D transmission being C2 (e.g., 24).

Two of the plurality of R2D minimum times may be associated with a respective number/quantity of chips per symbol. The two of the plurality of R2D minimum times may be associated with a respective chip duration. A first R2D minimum time of the two R2D minimum times may be associated with the respective number/quantity of chips per symbol and the presence of the one or more padding chips. The first R2D minimum time of the two R2D minimum times may be associated with the chip duration and the presence of the one or more padding chips.

The A-IoT device may determine the R2D minimum time, for example, based on the number/quantity of chips per symbol and the presence of the one or more padding chips. The A-IoT device may determine the R2D minimum time, for example, based on the chip duration and the presence of the one or more padding chips. The A-IoT device may determine the R2D minimum time as the first R2D minimum time, for example, based on the number/quantity of chips per symbol and the presence of the one or more padding chips. The A-IoT device may determine the R2D minimum time as the first R2D minimum time, for example, based on the chip duration and the presence of the one or more padding chips.

Although FIG. 31 shows the presence of the one or more padding chips, it will be understood that the present disclosure is not limited in this aspect. In other examples, the one or more or more padding chips may be absent. A second R2D minimum time of the two R2D minimum times may be associated with the respective number/quantity of chips per symbol and the absence of one or more padding chips. The second R2D minimum time of the two R2D minimum times may be associated with the respective chip duration and the absence of one or more padding chips. The A-IoT device may determine the R2D minimum time, for example, based on the number/quantity of chips per symbol and the absence of the one or more padding chips. The A-IoT device may determine the R2D minimum time, for example, based on the chip duration and the absence of the one or more padding chips. The A-IoT device may determine the R2D minimum time as the second R2D minimum time, for example, based on the number/quantity of chips per symbol and the absence of the one or more padding chips. The A-IoT device may determine the R2D minimum time as the second R2D minimum time, for example, based on the chip duration and the absence of the one or more padding chips.

The reader may indicate whether to use the first R2D minimum time or the second R2D minimum time. The R2D minimum time may comprise one or more fields indicating whether to use the first R2D minimum time or the second R2D minimum time. The A-IoT device may determine the R2D minimum time as the first R2D minimum time or the second R2D minimum time, for example, based on the one or more fields.

The R2D transmission may indicate the presence (or absence) of the one or padding chips. The A-IoT device may determine the presence (or absence) of the one or more padding chips, for example, based on the R2D transmission. The R2D transmission may comprise one or more fields indicating whether the one or more padding chips are present.

The A-IoT device may determine the presence (or absence) of the one or more padding chips, for example, based on the size of the PRDCH payload. The A-IoT device may determine the presence (or absence) of the one or more padding chips, for example, based on the size of the PRDCH payload and the number/quantity of chips per symbol. The A-IoT device may determine the presence (or absence) of the one or more padding chips, for example, based on the size of the PRDCH payload and the chip duration.

The one or more padding chips may comprise a padding sequence (e.g., a reserved sequence of bits/chips for padding). The A-IoT device may determine the presence (or absence) of the one or more padding chips, for example, based on the padding sequence. The A-IoT device may determine the one or more padding chips are present, for example, based on receiving the padding sequence.

The A-IoT device may determine whether the one or more padding chips are present, for example, based on a message type of the R2D transmission. One or more fields of the R2D transmission may indicate the message type. The message type may be an inventory message. The message type may be a command message. The message type may be a Msg0 (e.g., first message of an inventory procedure). The message type may be a Msg2 (e.g., third message of an inventory procedure). The message type may be a Msg4 (e.g., ACK/NACK and/or fifth message of an inventory procedure). The A-IoT device may determine whether the one or more padding chips are present, for example, based on the one or more fields of the R2D transmission.

The A-IoT device may determine the R2D minimum time by adding a (e.g., an additional) time offset to a first value. Alternatively, the A-IoT device may add a time offset to a determined R2D minimum time. The (additional) time offset may be referred to as a fourth time offset. For example, the A-IoT device may send (e.g., transmit) the D2R transmission no earlier than (e.g., at a time starting on/at or after) the R2D minimum time plus the (additional) time offset from the end of the R2D transmission. The A-IoT device may add the (additional) time offset, for example, based on the one or more padding chips being present (e.g., after the end of the R2D transmission). The A-IoT device may not add the (additional) time offset, for example, based on the one or more padding chips being absent (e.g., after the end of the R2D transmission). An A-IoT device may add the (additional) time offset to the first time offset (e.g., of FIG. 26) to determine (e.g., compute) the R2D minimum time.

The reader may indicate the (additional) time offset to the A-IoT device. The reader may send (e.g., transmit) one or more messages indicating the (additional) time offset. The A-IoT device may receive the one or more messages from the reader. The one or more messages may comprise one or more fields indicating the (additional) time offset. The one or more messages may comprise a parameter indicating the (additional) time offset. The A-IoT device may determine the fourth time offset, for example, based on the parameter.

The fourth time offset may be pre-defined. For example, the A-IoT device may determine (e.g., apply and/or use) the fourth time offset, for example, based on a pre-defined value.

The A-IoT device may determine a time duration of the one or more padding chips (e.g., based on the end of the symbol and the end of the R2D transmission). The reader may indicate the time duration of the one or more padding chips to the A-IoT device. The A-IoT device may determine the R2D minimum time as a first value plus the time duration of the one or more padding chips. The first value may be a minimum value of the plurality of R2D minimum times (e.g., smallest/shortest time among the plurality of R2D minimum times for all values of number/quantity of chips per symbol).

The R2D minimum time may be at least a time duration. The time duration might be based on a padding length (e.g., maximum padding length). The time duration may be based on a padding length (e.g., maximum padding length) for a respective number/quantity of chips per symbol. The time duration may be based on a padding length (e.g., maximum padding length) for a respective chip duration.

In the present disclosure, an A-IoT device may refer to an IoT device, an A-IoT user equipment, an A-IoT wireless device, a wireless device, a tag, an A-IoT tag, and/or a label. A reader may refer to an intermediate wireless device, an intermediate UE, a base station, a wireless device, and/or an interrogator.

A preamble may refer to an R2D timing acquisition signal, a D2R timing acquisition signal, a timing acquisition signal, a start of frame (SOF), a beginning of frame, and/or a start of signaling. A postamble may refer to an end of frame (EOF), an end of signaling (EOS), and/or a terminator.

A time interval may refer to a time period, a time window, a time duration, and/or a time slot. A number/quantity of chips per symbol may refer to a number/quantity of OOK chips per symbol, a number/quantity of chips per OFDM symbol, a number/quantity of OOK chips per OFDM symbol, a number/quantity of OOK symbols per OFDM symbol, a number/quantity of modulated OOK symbols per OFDM symbol, and/or an M value. A chip duration may refer to an OOK chip duration, a OOK symbol duration, and/or a OOK modulated symbol duration.

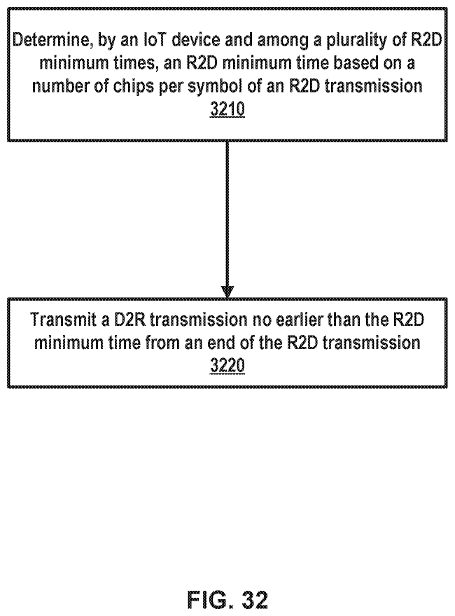

FIG. 32 shows an example method of an D2R transmission. The example of FIG. 32 may be used together with or independently from any of the previous examples (e.g., in FIGS. 1A-31).

At step 3210, an IoT device may determine, among a plurality of R2D minimum times (or time durations), an R2D minimum time (or time duration), for example, based on a number/quantity of chips per symbol of an R2D transmission. At step 3220, the IoT device may send (e.g., transmit) a D2R transmission no earlier than (e.g., at a time starting on/at or after) the R2D minimum time following an end of the R2D transmission. A reader may receive the D2R transmission from the IoT device (e.g., no earlier than the R2D minimum time from the end of the R2D transmission).

The IoT device may receive the R2D transmission. The reader may send (e.g., transmit) the R2D transmission to the IoT device. The R2D transmission may indicate (e.g., trigger) the D2R transmission. The R2D transmission may comprise a PRDCH payload and one or more padding chips.

A last chip of the PRDCH payload may be in a symbol (e.g., OFDM symbol). The one or more padding chips may be after the PRDCH payload and until the end of the symbol. The one or more padding chips may be referred to as padding or one or more padding bits.

The R2D minimum time may be larger than, or equal to, a time duration of the one or more padding chips. Each of the plurality of R2D minimum times may be a minimum time, supported by the IoT device for a respective number/quantity of chips per symbol (e.g., M value), between reception of R2D and transmission of D2R. The end of the R2D transmission may be an end of the last chip of the PRDCH payload.

The IoT device may determine the end of the R2D transmission, for example, based on a field of the R2D transmission. The field may indicate a size of the R2D transmission (e.g., size of the PRDCH payload). The field may indicate a transport block (TB) size of the R2D transmission (e.g., of the PRDCH payload and/or of the PRDCH). The IoT device may determine the end of the R2D transmission, for example, based on the TB size.

The IoT device may determine the end of the R2D transmission, for example, based on a violation of a coding rule (e.g., Manchester coding and/or line coding). The IoT device determining the violation of the coding rule may comprise not detecting the coding rule (e.g., the line code and/or the Manchester coding) for a time duration after a chip of the R2D transmission. The IoT device may determine the R2D transmission has ended (e.g., at the chip), for example, based on not detecting the coding rule (e.g., the line code and/or the Manchester code for the time duration after the chip.

The IoT device not detecting the coding rule for the time duration may comprise not detecting a rising edge or a falling edge during the time duration. For example, the IoT device may determine the violation, for example, based on not detecting a transition (e.g., voltage transition and/or change) during the time duration. A rising edge may comprise a transition from an off chip (which may also be referred to as an “OFF” chip) to an on chip (which may also be referred to as an “ON” chip) (e.g., as discussed with respect to FIG. 28). A falling edge may comprise a transition from an ON chip to an OFF chip (e.g., as discussed with respect to FIG. 28). The OFF chip may be a 0 OOK chip. The ON chip may be a 1 OOK chip.

The IoT device may determine the end of the R2D transmission, for example, based on a start of a last symbol (e.g., OFDM symbol) of the R2D transmission. The end of the PRDCH payload may be in the last symbol (e.g., after the start of the last symbol and prior to an end of the last symbol).

The end of the R2D transmission may be based on a falling edge of a last chip of the R2D transmission (e.g., last chip of the PRDCH payload). The end of the R2D transmission may be based on a rising edge of a last chip of the R2D transmission (e.g., last chip of the PRDCH payload).

The IoT device may start the R2D minimum time from the end of the R2D transmission, for example, based on determining the end of the R2D transmission. The reader may start the R2D minimum time from the end of the R2D transmission.

The D2R transmission may comprise a preamble transmission (of the D2R transmission) and a PDRCH transmission. The IoT device may send (e.g., transmit) a first (e.g., initial and/or starting) chip of the preamble transmission no earlier than (e.g., at a time starting on/at or after) the R2D minimum time from the end of the R2D transmission.

The R2D transmission may comprise a preamble transmission of the R2D transmission (e.g., R-TAS). The preamble transmission of the R2D transmission may comprise a SIP transmission and a CAP transmission. The R2D transmission may comprise a postamble transmission. The end of the R2D transmission may be an end of the postamble (e.g., ending/last/final chip of the postamble).

The CAP transmission may indicate the number/quantity of chips per symbol (e.g., the M value). The IoT device may determine the number/quantity of chips per symbol (e.g., the M value), for example, based on receiving the CAP transmission. The CAP transmission may indicate the chip duration. The IoT device may determine the chip duration, for example, based on receiving the CAP transmission. The IoT device may determine the chip duration, for example, based on the number/quantity of chips per symbol (e.g., M value). The IoT device may determine the number/quantity of chips per symbol (e.g., M value), for example, based on the chip duration.

The IoT device may receive a message indicating the number/quantity of chips per symbol (e.g., M value). The reader may send (e.g., transmit) the message to the IoT device. The message may comprise one or more fields indicating the number/quantity of chips per symbol. The message may comprise a parameter indicating the number/quantity of chips per symbol. The message may comprise a paging (e.g., A-IoT paging) message.

The number/quantity of chips per symbol may be among a plurality of number/quantity of chips per symbol. The number/quantity of chips per symbol may comprise a number/quantity of OOK chips (e.g., OOK modulated symbol) per symbol. The number/quantity of chips per symbol may be a number/quantity of chips per OFDM symbol. The number/quantity of chips may be based on a subcarrier spacing (SCS). The SCS may be for OFDM. The SCS may be for a BWP. The number/quantity of chips per symbol may be based on a length of the (OFDM) symbol.

The IoT device may determine the R2D minimum time, for example, (further) based on the presence of the one or more padding chips of the R2D transmission. The IoT device may receive a second R2D transmission indicating a second D2R transmission. The reader may send (e.g., transmit) the second R2D transmission to the IoT device. The second R2D transmission may not comprise one or more second padding chips (e.g., no padding after the second R2D transmission). The IoT device may determine a second R2D minimum time among the plurality of R2D minimum times. The IoT device may send (e.g., transmit) the second D2R transmission no earlier than the second minimum time from an end of the second R2D transmission. The reader may receive the second D2R transmission from the IoT device.

The reader may monitor for the second D2R transmission no earlier than the second R2D minimum time from the end of the second R2D transmission. The reader may start monitoring for the second D2R transmission the second R2D minimum time from the end of the second R2D transmission. The reader may not monitor (e.g., not attempt to receive) the second D2R transmission, for example, prior to the second R2D minimum time from the end of the second R2D transmission. The reader may determine the second R2D minimum time, for example, based on the number/quantity of chips per symbol of the second R2D transmission.

The reader may start to monitor for a preamble of the second D2R transmission, for example, at a time starting at the second R2D minimum time following the end of the second R2D transmission. The reader may monitor for the preamble of the second D2R transmission, for example, after the second minimum time following/from the end of the second R2D transmission. The reader may determine the end of the second R2D transmission, for example, based on a last chip of the second R2D transmission.

The reader may monitor for the D2R transmission no earlier than the R2D minimum time from the end of the R2D transmission. The reader may start monitoring for the D2R transmission at a time starting at the R2D minimum time following/from the end of the R2D transmission. The reader may start a monitoring window for the D2R transmission, for example, after the R2D minimum time from the end of the R2D transmission.

The second R2D minimum time may be based on a second number/quantity of chips per symbol (e.g., of the second R2D transmission) and the presence of the one or more second padding chips. The second R2D minimum time may be based on a second number/quantity of chips per symbol (e.g., of the second R2D transmission) and the absence of the one or more second padding chips.

The IoT device may determine the presence of the one or more padding chips, for example, based on receiving the R2D transmission. The R2D transmission may indicate the presence of the one or more padding chips. The R2D transmission may indicate a size of the R2D transmission. The IoT device may determine the presence of the one or more padding chips, for example, based on the size of the R2D transmission. For example, the size of the R2D transmission may indicate a total number/quantity of chips (or the IoT device may determine the total number/quantity of chips, for example, based on the size of the R2D transmission). The total number/quantity of chips may indicate the last chip of the R2D transmission (e.g., last chip of the PRDCH payload) ends prior to the end of the last (OFDM) symbol. The IoT device may determine the presence of the one or more padding chips, for example, based on the last chip of the R2D transmission ending prior to the end of the last (OFDM) symbol.

The IoT device may determine the absence of the one or more second padding chips, for example, based on receiving the R2D transmission. The R2D transmission may indicate the absence of the one or more second padding chips. The R2D transmission may indicate the size of the R2D transmission. The IoT device may determine the absence of the one or more second padding chips, for example, based on the size of the R2D transmission. For example, the size of the R2D transmission may indicate a total number/quantity of chips (or the IoT device may determine the total number/quantity of chips, for example, based on the size of the R2D transmission). The total number/quantity of chips may indicate the last chip of the R2D transmission (e.g., last chip of the PRDCH payload) ends at the same time as the end of the last (OFDM) symbol (e.g., may be aligned with the end of the last (OFDM) symbol). The IoT device may determine the absence of the one or more second padding chips, for example, based on the last chip of the R2D transmission being aligned with the end of the last (OFDM) symbol.

The second R2D minimum time may be less than the R2D minimum time. The second number/quantity of chips per symbol may be the same as the number/quantity of chips per symbol.

The one or more padding chips may indicate (e.g., comprise) one or more padding bits. A chip duration of the one or more padding chips may be equal to a chip duration of the PRDCH payload. The one or more padding chips may be one or more zero padding chips.

The IoT device may determine an aggregate (e.g., a maximum) time duration of the one or more padding chips, for example, based on the number/quantity of chips per symbol. The IoT device may determine the R2D minimum time, for example, based on the aggregate (e.g., maximum) time duration.

The IoT device may determine the R2D minimum time as a first value, for example, based on (e.g., in response to) the one or more padding chips being present. The IoT device may determine the R2D minimum time as a second value, for example, based on (e.g., in response to) the one or more padding chips being absent.

The IoT device may determine the R2D minimum time, for example, (further) based on a capability of the device. The capability of the device may comprise a device type. The device type may be a device type 1 (e.g., A-IoT device 1 and/or as discussed with respect to FIG. 18). The device type may be a device type 2a (e.g., A-IoT device 2a and/or as discussed with respect to FIG. 19). The device type may be a device type 2b (e.g., A-IoT device 2b and/or as discussed with respect to FIG. 20).

The IoT device may determine the R2D minimum time as a first value, for example, based on (e.g., in response to) the IoT device being a device type 1. The IoT device may determine the R2D minimum time as a second value, for example, based on (e.g., in response to) the IoT device being a device type 2a. The IoT device may determine the R2D minimum time as a third value, for example, based on (e.g., in response to) the IoT device being a device type 2b. The IoT device may determine the R2D minimum time as the first value, for example, based on (e.g., in response to) the IoT device being a device type 1 and the number/quantity of chips per symbol being a value. The IoT device may determine the R2D minimum time as the second value, for example, based on (e.g., in response to) the IoT device being a device type 2a and the number/quantity of chips per symbol being the value. The IoT device may determine the R2D minimum time as a third value, for example, based on (e.g., in response to) the IoT device being a device type 2b and the number/quantity of chips per symbol being the value.

The IoT device may determine the R2D minimum time, for example, (further) based on a message type of the R2D transmission. The message type may be a procedure type (e.g. inventory procedure and/or command procedure). The message type may be at least one of a first inventory message (e.g., Msg0), a second inventory message (e.g., Msg2), or a third inventory message (e.g., Msg4 and/or ACK/NACK).

The IoT device may be an A-IoT device. The reader may be a base station and/or an intermediate wireless device.

An IoT device may receive a PRDCH transmission indicating a PDRCH transmission. A reader may send (e.g., transmit) the PRDCH transmission to the IoT device. The PRDCH transmission may comprise a PRDCH payload and one or more padding chips. A last chip of the PRDCH payload may be in a symbol. The one or more padding chips may be after the last chip of the PRDCH payload until an end of the symbol.

The IoT device may determine an R2D minimum time, among a plurality of R2D minimum times, for example, based on a number/quantity of chips per symbol of the PRDCH transmission. The R2D minimum time may be larger than, or equal to a time duration of the one or more padding chips. Each of the plurality of R2D minimum times may be a minimum time, supported by the IoT device for a respective number/quantity of chips per symbol, between reception of R2D and transmission of D2R. The IoT device may send (e.g., transmit) a preamble of the PDRCH transmission no earlier than the R2D minimum time from an end of the last chip of the PRDCH payload. The reader may receive the preamble of the PDRDCH transmission from the IoT device.

A reader may send (e.g., transmit) one or more messages to a base station. The base station may receive the one or more messages from the reader. The one or more messages may indicate whether the reader supports transmitting and receiving A-IoT signals (e.g., R2D transmission and/or D2R transmission) on a same symbol (e.g., OFDM symbol). The one or more messages may comprise one or more fields indicating whether the reader supports transmitting and receiving A-IoT signals (e.g., R2D transmission and/or D2R transmission) on a same symbol (e.g., OFDM symbol). The reader may send (e.g., transmit) an R2D transmission and receive a D2R transmission on a symbol, for example, based on indicating support of transmitting and receiving A-IoT signals on the same symbol. An A-IoT device may send (e.g., transmit) the D2R transmission to the reader. The A-IoT device may receive the R2D transmission from the reader.

The reader may indicate to use a first R2D minimum value, for example, based on the reader supporting transmitting and receiving A-IoT signals on the same symbol. The reader may indicate to use a second R2D minimum value, for example, based on the reader not supporting transmitting and receiving A-IoT signals on the same symbol. The A-IoT device may use the first R2D minimum value (e.g., send/transmit the D2R transmission no earlier than the first R2D minimum value from the end of the R2D transmission), for example, based on the indication. The A-IoT device may use the second R2D minimum value (e.g., send/transmit the D2R transmission no earlier than the second R2D minimum value from the end of the R2D transmission), for example, based on the indication. The first R2D minimum value may be smaller (e.g., less) than the second R2D minimum value.

A reader may indicate a size of the R2D transmission to an A-IoT device. The A-IoT device may receive one or more messages indicating the size of the R2D transmission. The reader may send (e.g., transmit) the one or more messages to the A-IoT device. The size of the R2D transmission may be a size of the PRDCH payload (e.g., transport block size (TBS)). The one or more messages may comprise one or more fields indicating the size of the R2D transmission.

The reader may indicate an index (e.g., index of/for a table) to the A-IoT device. The index may indicate a row of a table. The index may indicate a column of the table.

The table may be a TBS table. The table may be a PRDCH payload size table. The table may indicate the size of the R2D transmission. The row of the table may indicate the size of the R2D transmission (e.g., based on the index). The column of the table may indicate the size of the R2D transmission (e.g., based on the index). The A-IoT device may determine the size of the R2D transmission, for example, based on the table. The A-IoT device may determine the size of the R2D transmission, for example, based on the row. The A-IoT device may determine the size of the R2D transmission, for example, based on the column.

The table may be associated with an M value (e.g., number/quantity of chips per symbol). The table may be associated with a chip duration.

The table may be associated with a type of CRC. The type of CRC may be a CRC-6 (e.g., 6 bit CRC), a CRC-16 (e.g., 16 bit CRC), or no CRC (e.g., zero bits for CRC). The table may be associated with the M value and the type of CRC.

The table may comprise one or more sizes of the R2D transmission (e.g., each of the one or more sizes of the R2D transmission may be a value of the size of the R2D transmission). Each of the one or more sizes of the R2D transmission (e.g., of the table) may be such that an end of the R2D transmission may be aligned with (e.g., may be the same as) an end of a symbol (e.g., OFDM symbol). For example, the one or more sizes of the R2D transmission may be such that there are no padding chips for aligning the R2D transmission with a symbol (e.g., OFDM symbol) boundary.

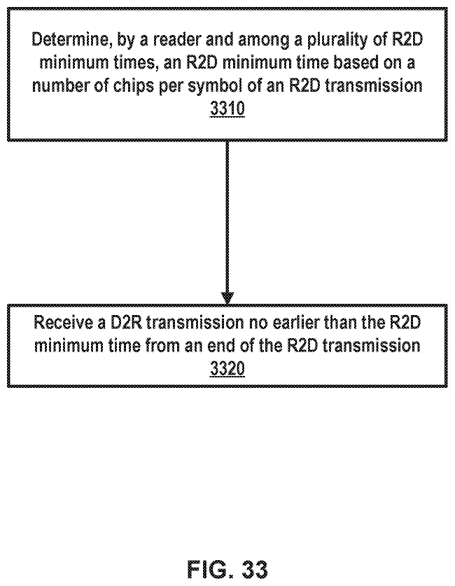

FIG. 33 shows an example method of an D2R reception. The example of FIG. 33 may be used together with or independently from any of the previous examples (e.g., in FIGS. 1A-32)

At step 3310, a reader (e.g., wireless device and/or base station) may determine, among a plurality of R2D minimum times (or time durations), an R2D minimum time (or time duration), for example, based on a number/quantity of chips per symbol of an R2D transmission. At step 3320, the reader may receive a D2R transmission no earlier than (e.g., at a time starting on/at or after) the R2D minimum time following an end of the R2D transmission. An A-IoT device may send (e.g., transmit) the D2R transmission to the reader.

The reader may send (e.g., transmit) the R2D transmission to the A-IoT device. The reader may monitor for the D2R transmission, for example, starting from the R2D minimum time after the end of the R2D transmission. The reader may not monitor for the D2R transmission, for example, prior to/before the R2D minimum time after the end of the R2D transmission. The reader may not receive for the D2R transmission, for example, prior to the R2D minimum time after the end of the R2D transmission.

The reader may start a monitoring window (e.g., monitoring time and/or monitoring period) for the D2R transmission. The reader may start the monitoring window, for example, at the R2D minimum time after the end of the R2D transmission. The reader may monitor for the D2R transmission inside (e.g., during) the monitoring window.

The end of the R2R transmission may be a last chip of a PRDCH payload. The R2D transmission may comprise the PRDCH payload. The end of the R2D transmission may be an end of a last symbol (e.g., OFDM symbol) of the R2D transmission.

The R2D transmission may comprise an R2D preamble (e.g., R-TAS) transmission and a PRDCH transmission. The D2R transmission may comprise a D2R preamble. The reader may monitor for a first (e.g., initial and/or starting) chip of the D2R preamble at a time starting at the R2D minimum time following the end of the R2D transmission. The reader may receive the first (e.g., initial and/or starting) chip of the D2R preamble at a time starting at the R2D minimum time following the end of the R2D transmission.

The R2D minimum time may comprise a time offset added to a first value (e.g., a pre-fixed and/or pre-determined value). The reader may add the time offset to the first value, for example, based on one or more padding chips being present after the R2D transmission. The one or more padding chips may be from the end of the R2D transmission until an end of a symbol (e.g., OFDM symbol).

The reader may send (e.g., transmit) one or more messages indicating the time offset. The A-IoT device may receive the one or more messages from the reader. The one or more messages may comprise one or more fields indicating the time offset.

The reader may not use a coding rule (e.g., line coding and/or Manchester coding) for a time duration after the end of the R2D transmission. The reader not using the coding rule for the time duration may indicate a violation of the coding rule (e.g., to the A-IoT device).

An A-IoT device may not expect (e.g., may assume, may not expect to be configured and/or may determine) an R2D transmission to contain (e.g., comprise and/or be associated with) a time duration of one or more padding chips greater than or equal to a threshold (e.g., threshold value and/or maximum padding value).

A reader may not expect (e.g., may assume, may not expect to be configured, and/or may determine) to send (e.g., transmit) an R2D transmission and receive a D2R transmission (e.g., corresponding D2R transmission) in a same symbol (e.g., same OFDM symbol).

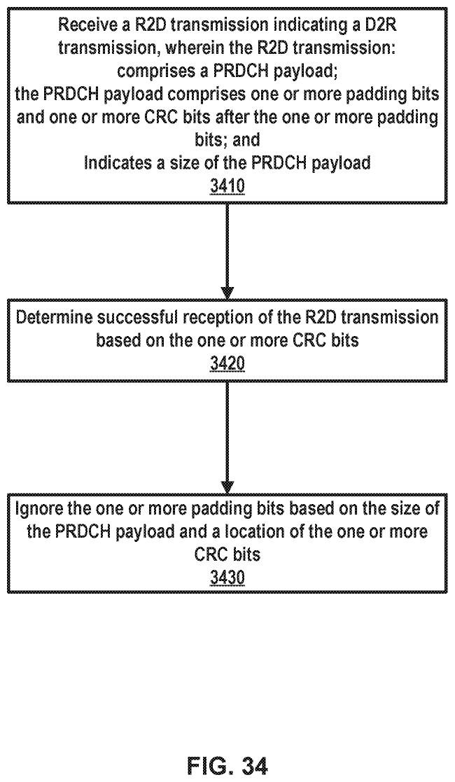

FIG. 34 shows an example method of an D2R transmission. The example of FIG. 34 may be used together with or independently from any of the previous examples (e.g., in FIGS. 1A-33).

At step 3410, an IoT device (e.g., A-IoT device) may receive an R2D transmission indicating a D2R transmission. The R2D transmission may comprise a PRDCH payload. The R2D transmission may indicate a size of the PRDCH payload. The PRDCH payload may comprise one or more padding bits and one or more CRC bits (e.g., after the one or more padding bits). A reader may send (e.g., transmit) the R2D transmission to the IoT device.

At step 3420, the IoT device may determine successful reception of the R2D transmission, for example, based on the one or more CRC bits. For example, the IoT device may determine (e.g., check) if a value of each of the one or more CRC bits is a value the IoT device may expect. The IoT device may determine successful reception of the R2D transmission, for example, based on each of the one or more CRC bits having a value. The IoT device may determine successful reception of the R2D transmission, for example, based on the R2D transmission passing a CRC check (e.g., determining the CRC may be as expected).

At step 3430, the IoT device may ignore the one or more padding bits, for example, based on the size of the PRDCH payload and a location of the one or more CRC bits. The IoT device may discard (e.g., remove and/or drop) the one or more padding bits (e.g., based on the size of the PRDCH payload and the location of the one or more CRC bits).

The one or more padding bits may be before (e.g., immediately prior to) the one or more CRC bits. The IoT device may ignore the one or more padding bits, for example, based on the size of the PRDCH payload and the one or more padding bits being immediately prior to the one or more CRC bits.

The IoT device may determine a number/quantity of the one or more padding bits (e.g., how many padding bits), for example, based on the size of the PRDCH payload. The IoT device may determine a number/quantity of the one or more padding bits (e.g., how many padding bits), for example, based on the size of the PRDCH payload and the location of the one or more CRC bits. The IoT device may determine a second location of the one or more padding bits, for example, based on the size of the PRDCH payload and the location of the one or more CRC bits. The IoT device may ignore the one or more padding bits, for example, based on the second location. The IoT device may discard (e.g., remove and/or drop) the one or more padding bits, for example, based on the size of the PRDCH payload and the second location.

The size of the PRDCH payload may be 60 bits. The CRC may be a CRC-16. The IoT device may receive 80 bits as part of the R2D transmission. The IoT device may check the last 16 bits of the 80 bits for the CRC check. The IoT device may determine four bits prior to the last 16 bits as padding bits (e.g., 80−16−60=4), for example, based on (e.g., after) passing the CRC check. The IoT device may discard the four bits (e.g., the padding bits). The IoT device may remove the four bits, for example, prior to passing the received bits to a higher layer (e.g., MAC layer).

In the present disclosure, it should be understood that any discussion of operations from the perspective of wireless device may also be applied to a base station. Reciprocal operations may not be stated explicitly for each and every operation, although it is implied and a part of the present disclosure. For example, when the present disclosure describes one or more examples in which a transmitter device (e.g., a wireless device, reader, or a base station) sends (e.g., transmits) a signal, a receiver device (e.g., a wireless device, reader, or a base station) receives the signal. Reciprocal determinations and/or timer operations may occur to ensure alignment between operations of the transmitter device and receiver device. Furthermore, as an example of reciprocal operations, a wireless device may determine a time to send (e.g., transmit) a signal, for example, based on a grant, and a base station may determine the time to receive the signal and/or determine the time to schedule the signal for the wireless device to send (e.g., transmit) via the grant. Similarly, as another reciprocal operation, if a receiver device (e.g., a wireless device, reader, or a base station) monitors for a signal or monitors a channel, a transmitter device (e.g., a wireless device, reader, or a base station) transmits the signal or transmits the channel.

An internet of things (IoT) device may perform a method comprising one or more operations. For example, the IoT device may receive a reader to device (R2D) transmission. The R2D transmission may comprise: a reader timing acquisition signal transmission; and a physical reader to device channel transmission. The IoT device may determine, based on a clock acquisition part of the reader timing acquisition signal transmission, a number of chips per symbol for the physical reader to device channel transmission. The IoT device may determine, an amount of time after an end of the R2D transmission for a device to reader (D2R) transmission, based on: the number of chips per symbol for the physical reader to device channel transmission; and whether a message type of the R2D transmission is a response message. The IoT device may transmit the D2R transmission based on the determined amount of time after the end of the R2D transmission. The IoT device may determine the amount of time based on determining, among a plurality of R2D time durations, a time duration. The R2D transmission may indicate the D2R transmission. The IoT device may determine the end of the R2D transmission based on a field of the R2D transmission. The field may indicate a size of the R2D transmission. The IoT device may transmit the D2R transmission based on transmitting a first chip of a preamble transmission of the D2R transmission at a time starting after the determined amount of time following the end of the R2D transmission. The IoT device may transmit the D2R transmission based on transmitting the D2R transmission at the determined time duration following the end of the R2D transmission. The R2D transmission may comprise a postamble of the R2D transmission, and the end of the R2D transmission may comprise an end of the postamble. The clock acquisition part may indicate the number of chips per symbol. The IoT device may comprise one or more processors; and memory storing instructions that, when executed by the one or more processors, cause the IoT device to perform the described method, additional operations, and/or include the additional elements. A system may comprise an IoT device configured to perform the described method, additional operations, and/or include the additional elements; and a reader configured to transmit the R2D transmission. A computer-readable medium may store instructions that, when executed, cause performance of the described method, additional operations, and/or include the additional elements.

An internet of things (IoT) device may perform a method comprising one or more operations. For example, the IoT device may determine an R2D time duration among a plurality of R2D time durations, based on a number of chips per symbol of a reader to device (R2D) transmission. The IoT device may transmit a device to reader (D2R) transmission no earlier than the R2D time duration after an end of the R2D transmission. The IoT device may receive the R2D transmission. The R2D transmission may comprise: a reader timing acquisition signal (R-TAS) transmission; and a physical reader to device channel (PRDCH) transmission, The IoT device may determine, based on a clock acquisition part of the R-TAS transmission, the number of chips per symbol for the PRDCH transmission. The IoT device may determine the R2D time duration further based on whether a message type of the R2D transmission is a response message. The R2D transmission may further comprise one or more padding chips, and the R2D time duration may be larger than, or equal to, an aggregate time duration of the one or more padding chips. The IoT device may determine the end of the R2D transmission based on a field of the R2D transmission, and the field may indicate a size of the R2D transmission. The IoT device may determine the end of the R2D transmission based on violation of a coding rule. The coding rule may be a Manchester coding rule. The IoT device may receive a message indicating the number of chips per symbol. The number of chips per symbol may satisfy one or more of: comprising a number of on-off keying (OOK) chips per symbol; being a number of chips per orthogonal frequency division multiplexing (OFDM) symbol; being based on a subcarrier spacing; being based on a length of the symbol; being based on a chip duration; or being an M value. The IoT device may comprise one or more processors; and memory storing instructions that, when executed by the one or more processors, cause the IoT device to perform the described method, additional operations, and/or include the additional elements. A system may comprise an IoT device configured to perform the described method, additional operations, and/or include the additional elements; and a reader configured to transmit the R2D transmission. A computer-readable medium may store instructions that, when executed, cause performance of the described method, additional operations, and/or include the additional elements.

A computing device may perform a method comprising one or more operations. For example, the computing device may transmit a reader to device (R2D) transmission comprising: a reader timing acquisition signal transmission; and a physical reader to device channel transmission. The computing device may determine an amount of time after an end of the R2D transmission for a device to reader (D2R) transmission, based on a number of chips per symbol for the physical reader to device channel transmission. The computing device may receive the D2R transmission based on the determined amount of time after the end of the R2D transmission. The computing device may monitor for the D2R transmission based on the determined amount of time after the end of the R2D transmission. The end of the R2D transmission may be an end of a last symbol of the R2D transmission. The computing device may transmit an indication of a time offset. The amount of time may be based on the time offset. The computing device may comprise one or more processors; and memory storing instructions that, when executed by the one or more processors, cause the computing device to perform the described method, additional operations, and/or include the additional elements. A system may comprise a computing device configured to perform the described method, additional operations, and/or include the additional elements; and an internet of things (IoT) device configured to receive the R2D transmission. A computer-readable medium may store instructions that, when executed, cause performance of the described method, additional operations, and/or include the additional elements.

A computing device may perform a method comprising one or more operations. For example, the computing device may transmit a reader to device (R2D) transmission. The R2D transmission may comprise: a reader timing acquisition signal transmission; and a physical reader to device channel transmission. The computing device may receive a device to reader (D2R) transmission based on a determined amount of time after an end of the R2D transmission. The determined amount of time may be based on: a number of chips per symbol for the physical reader to device channel transmission; and whether a message type of the R2D transmission is a response message. The computing device may monitor for the D2R transmission based on the determined amount of time after the end of the R2D transmission. The end of the R2D transmission may be an end of a last symbol of the R2D transmission. The computing device may transmit an indication of a time offset. The amount of time may be based on the time offset. The computing device may comprise one or more processors; and memory storing instructions that, when executed by the one or more processors, cause the computing device to perform the described method, additional operations, and/or include the additional elements. A system may comprise a computing device configured to perform the described method, additional operations, and/or include the additional elements; and an internet of things (IoT) device configured to receive the R2D transmission. A computer-readable medium may store instructions that, when executed, cause performance of the described method, additional operations, and/or include the additional elements.

An internet of things (IoT) device may perform a method comprising one or more operations. For example, the IoT device may receive a reader to device (R2D) transmission, indicating a device to reader (D2R) transmission, comprising: a reader timing acquisition signal (R-TAS) transmission; and a physical reader to device channel (PRDCH) transmission. The IoT device may determine a number of chips per symbol of the PRDCH transmission based on the R-TAS. The IoT device may determine, among a plurality of R2D time durations and for the D2R transmission, an R2D time duration based on: the number of chips per symbol; and whether a message type of the R2D transmission is Msg2. The IoT device may transmit the D2R transmission the R2D time duration from an end of the R2D transmission. The IoT device may determine the end of the R2D transmission based on a field of the R2D transmission. The field may indicate a size of the R2D transmission. The D2R transmission may comprise a preamble transmission of the D2R transmission and a physical device to reader channel (PDRCH) transmission. The IoT device may transmit the D2R transmission the R2D minimum time from the end of the R2D transmission based on transmitting a first chip of the preamble transmission of the D2R transmission the R2D minimum time from the end of the R2D transmission. The IoT device may transmit the D2R transmission the R2D time duration from the end of the R2D transmission based on transmitting the D2R transmission no earlier than the R2D time duration from the end of the R2D transmission. The R2D transmission may comprise a preamble transmission of the R2D transmission. The preamble transmission of the R2D transmission may comprise: a start indicator part (SIP) transmission; and a clock acquisition part (CAP) transmission. The R2D transmission may comprise a postamble of the R2D transmission. The end of the R2D transmission may comprise an end of the postamble. The CAP transmission may indicate the number of chips per symbol. The IoT device may determine the number of chips per symbol based on the CAP transmission. The IoT device may comprise one or more processors; and memory storing instructions that, when executed by the one or more processors, cause the IoT device to perform the described method, additional operations, and/or include the additional elements. A system may comprise an IoT device configured to perform the described method, additional operations, and/or include the additional elements; and a reader configured to transmit the R2D transmission. A computer-readable medium may store instructions that, when executed, cause performance of the described method, additional operations, and/or include the additional elements.

An internet of things (IoT) device may perform a method comprising one or more operations. For example, the IoT device may determine, among a plurality of reader to device (R2D) minimum times, an R2D minimum time based on a number of chips per symbol of a R2D transmission. The IoT device may transmit a device to reader transmission no earlier than the R2D minimum time from an end of the R2D transmission. The IoT device may receive the R2D transmission indicating the D2R transmission. The R2D transmission may comprise: a physical reader to device channel (PRDCH) payload; and one or more padding chips. A last chip of the PRDCH payload may be in a symbol. The one or more padding chips may be after the PRDCH payload and until the end of the symbol. The R2D minimum time may be larger than, or equal to, a time duration of the one or more padding chips. Each of the plurality of R2D time durations may be supported by the IoT device for a respective number of chips per symbol, between the R2D transmission and the D2R transmission. The end of the R2D transmission may be an end of the last chip of the PRDCH payload. The IoT device may determine the end of the R2D transmission based on a field of the R2D transmission. The field may indicate a size of the R2D transmission. The IoT device may start the R2D minimum time from the end of the R2D transmission based on determining the end of the R2D transmission. The IoT device may determine the end of the R2D transmission based on violation of a coding rule. The coding rule may be a Manchester coding rule. The IoT device may determine the violation of the coding rule based on not detecting the coding rule for a time duration after a chip of the R2D transmission. Not detecting the coding rule for the time duration may comprise not detecting a rising edge or a falling edge during the time duration. The end of the R2D transmission may be based on a rising edge or falling edge of a last chip of the R2D transmission. A rising edge may comprise a transition from an off chip to an on chip. A falling edge may comprise a transition from an on chip to an off chip. The end of the R2D transmission may be determined based on a start of a last symbol of the R2D transmission. The end of PRDCH payload may be at the start of the last symbol or after the start of the last symbol. The last symbol may be an OFDM symbol. The IoT device may start the R2D minimum time from the end of the R2D transmission based on determining the end of the R2D transmission. The end of the R2D transmission may be based on a falling edge of a last chip of the R2D transmission. The end of the R2D transmission may be based on a rising edge of a last chip of the R2D transmission. The D2R transmission may comprise a preamble transmission of the D2R transmission and a physical device to reader channel (PDRCH) transmission. The IoT device may transmit the D2R transmission no earlier than the R2D minimum time from the end of the R2D transmission based on transmitting a first chip of the preamble transmission of the D2R transmission no earlier than the R2D minimum time from the end of the R2D transmission. The R2D transmission may comprise a preamble transmission of the R2D transmission. The preamble transmission of the R2D transmission may comprise: a start indicator part (SIP) transmission; and a clock acquisition part (CAP) transmission. The R2D transmission may comprise a postamble of the R2D transmission. The end of the R2D transmission may comprise an end of the postamble. The CAP transmission may indicate the number of chips per symbol. The IoT device may determine the number of chips per symbol based on the CAP transmission. The IoT device may receive a message indicating the number of chips per symbol. The message may comprise a paging message. The number of chips per symbol may be among a plurality of number of chips per symbol. The determining the number of chips per symbol may be based on determining a number of chips per symbol of the CAP transmission. The number of chips per symbol may be the same as the number of chips per symbol of the CAP transmission. The number of chips per symbol may comprise a number of on-off keying (OOK) chips per symbol. The OOK chips may be modulated OOK symbols. The number of chips per symbols may be a number of chips per orthogonal frequency division multiplexing (OFDM) symbol. The number of chips per symbol may be based on a subcarrier spacing. The number of chips per symbol may be based on a length of the symbol. The number of chips per symbol may be based on a chip duration. The number of chips per symbol may be an M value. The determining the R2D minimum time may be further based on the presence of the one or more padding chips of the R2D transmission. The IoT device may receive a second R2D transmission indicating a second D2R transmission. The second R2D transmission does not comprise one or more second padding chips. The IoT device may determine a second R2D minimum time, among the plurality of R2D minimum times. The IoT device may transmit the second D2R transmission no earlier than the second R2D minimum time from an end of the second R2D transmission. The second R2D minimum time may be based on a second number of chips per symbol and the absence of the one or more second padding chips. The IoT device may determine the presence of the one or more padding chips based on receiving the R2D transmission. The R2D transmission may indicate the presence of one or more padding chips. The R2D transmission indicating the presence of the one or more padding chips may comprise the R2D transmission indicating a size of the R2D transmission. The IoT device may determine the presence of the one or more padding chips based on the size of the R2D transmission. The IoT device may determine the absence of the one or more second padding chips based on receiving the R2D transmission. The R2D transmission may indicate the absence of the one or more second padding chips. The R2D transmission indicating the absence of the one or more second padding chips may comprise indicating a size of the R2D transmission. The IoT device may determine the absence of the one or more second padding chips based on the size of the R2D transmission. The second R2D minimum time may be less than the R2D minimum time. The second number of chips per symbol may be of the second R2D transmission. The second number of chips per symbol may be the same as the number of chips per symbol. The one or more padding chips may indicate one or more padding bits. A chip duration of the one or more padding chips may be equal to a chip duration of the PRDCH payload. The one or more padding chips may be one or more zero padding chips. The IoT device may determine a maximum duration of the one or more padding chips based on the number of chips per symbol. The IoT device may determine the R2D minimum time based on the maximum duration. The R2D transmission may indicate whether one or more padding chips are present after the R2D transmission. The determining the R2D minimum time may be further based on whether the one or more padding chips are present. The IoT device may determine whether one or more padding chips are present based on the receiving of the R2D transmission. The R2D minimum time may be further based on whether the one or more padding chips are present. The R2D minimum time may be a first value based on (e.g., in response to) the one or more padding chips being present. The R2D minimum time may be a second value based on (e.g., in response to) the one or more padding chips being absent. The R2D minimum time may be further determined based on a capability of the device. The capability of the device may be a device type. The R2D minimum time may be: a first value based on the IoT device being a device type 1; and a second value based on the IoT device being a device type 2. The R2D minimum time may be further determined based on a message type of the R2D transmission. The message type may comprise a procedure type. The IoT device may comprise one or more processors; and memory storing instructions that, when executed by the one or more processors, cause the IoT device to perform the described method, additional operations, and/or include the additional elements. A system may comprise an IoT device configured to perform the described method, additional operations, and/or include the additional elements; and a reader configured to transmit the R2D transmission. A computer-readable medium may store instructions that, when executed, cause performance of the described method, additional operations, and/or include the additional elements.

A reader may perform a method comprising one or more operations. For example, the reader may determine, and among a plurality of reader to device (R2D) minimum times, an R2D minimum time based on a number of chips per symbol of a R2D transmission. The reader may receive a device to reader (D2R) transmission no earlier than the R2D minimum time from an end of the R2D transmission. The reader may monitor for the D2R transmission starting form the R2D minimum time after then end of the R2D transmission. The end of the R2D transmission may be a last chip of a PRDCH payload, and the R2D transmission may comprise the PRDCH payload. The end of the R2D transmission may be an end of a last symbol of the R2D transmission. The R2D minimum time may comprise a time offset added to a first value. The reader may transmit, to an IoT device, an indication of the time offset. The reader may not use a coding rule for a time duration after the end of the R2D transmission. The reader may comprise one or more processors; and memory storing instructions that, when executed by the one or more processors, cause the reader to perform the described method, additional operations, and/or include the additional elements. A system may comprise a reader configured to perform the described method, additional operations, and/or include the additional elements; and an internet of things (IoT) device configured to transmit the D2R transmission. A computer-readable medium may store instructions that, when executed, cause performance of the described method, additional operations, and/or include the additional elements.

One or more of the operations described herein may be conditional. For example, one or more operations may be performed if certain criteria are met, such as in a wireless device, a base station, a radio environment, a network, a combination of the above, and/or the like. Example criteria may be based on one or more conditions such as wireless device and/or network node configurations, traffic load, initial system set up, packet sizes, traffic characteristics, a combination of the above, and/or the like. If the one or more criteria are met, various examples may be used. It may be possible to implement any portion of the examples described herein in any order and based on any condition.

A base station may communicate with one or more of wireless devices. Wireless devices and/or base stations may support multiple technologies, and/or multiple releases of the same technology. Wireless devices may have some specific capability(ies) depending on wireless device category and/or capability(ies). A base station may comprise multiple sectors, cells, and/or portions of transmission entities. A base station communicating with a plurality of wireless devices may refer to a base station communicating with a subset of the total wireless devices in a coverage area. Wireless devices referred to herein may correspond to a plurality of wireless devices compatible with a given LTE, 5G, 6G, or other 3GPP or non-3GPP release with a given capability and in a given sector of a base station. A plurality of wireless devices may refer to a selected plurality of wireless devices, a subset of total wireless devices in a coverage area, and/or any group of wireless devices. Such devices may operate, function, and/or perform based on or according to drawings and/or descriptions herein, and/or the like. There may be a plurality of base stations and/or a plurality of wireless devices in a coverage area that may not comply with the disclosed methods, for example, because those wireless devices and/or base stations may perform based on older releases of LTE, 5G, 6G, or other 3GPP or non-3GPP technology.

One or more parameters, fields, and/or Information elements (IEs), may comprise one or more information objects, values, and/or any other information. An information object may comprise one or more other objects. At least some (or all) parameters, fields, IEs, and/or the like may be used and can be interchangeable depending on the context. If a meaning or definition is given, such meaning or definition controls.

One or more elements in examples described herein may be implemented as modules. A module may be an element that performs a defined function and/or that has a defined interface to other elements. The modules may be implemented in hardware, software in combination with hardware, firmware, wetware (e.g., hardware with a biological element) or a combination thereof, all of which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or Lab VIEWMathScript. Additionally or alternatively, it may be possible to implement modules using physical hardware that incorporates discrete or programmable analog, digital and/or quantum hardware. Examples of programmable hardware may comprise: computers, microcontrollers, microprocessors, application-specific integrated circuits (ASICs); field programmable gate arrays (FPGAs); and/or complex programmable logic devices (CPLDs). Computers, microcontrollers and/or microprocessors may be programmed using languages such as assembly, C, C++ or the like. FPGAs, ASICs and CPLDs are often programmed using hardware description languages (HDL), such as VHSIC hardware description language (VHDL) or Verilog, which may configure connections between internal hardware modules with lesser functionality on a programmable device. The above-mentioned technologies may be used in combination to achieve the result of a functional module.

One or more features described herein may be implemented in a computer-usable data and/or computer-executable instructions, such as in one or more program modules, executed by one or more computers or other devices. Generally, program modules include routines, programs, objects, components, data structures, etc. that perform particular tasks or implement particular abstract data types when executed by a processor in a computer or other data processing device. The computer executable instructions may be stored on one or more computer readable media such as a hard disk, optical disk, removable storage media, solid state memory, RAM, etc. The functionality of the program modules may be combined or distributed as desired. The functionality may be implemented in whole or in part in firmware or hardware equivalents such as integrated circuits, field programmable gate arrays (FPGA), and the like. Particular data structures may be used to more effectively implement one or more features described herein, and such data structures are contemplated within the scope of computer executable instructions and computer-usable data described herein.

A non-transitory tangible computer readable media may comprise instructions executable by one or more processors configured to cause operations of multi-carrier communications described herein. An article of manufacture may comprise a non-transitory tangible computer readable machine-accessible medium having instructions encoded thereon for enabling programmable hardware to cause a device (e.g., a wireless device, wireless communicator, a wireless device, a base station, and the like) to allow operation of multi-carrier communications described herein. The device, or one or more devices such as in a system, may include one or more processors, memory, interfaces, and/or the like. Other examples may comprise communication networks comprising devices such as base stations, wireless devices or user equipment (wireless device), servers, switches, antennas, and/or the like. A network may comprise any wireless technology, including but not limited to, cellular, wireless, WiFi, 4G, 5G, 6G, any generation of 3GPP or other cellular standard or recommendation, any non-3GPP network, wireless local area networks, wireless personal area networks, wireless ad hoc networks, wireless metropolitan area networks, wireless wide area networks, global area networks, satellite networks, space networks, and any other network using wireless communications. Any device (e.g., a wireless device, a base station, or any other device) or combination of devices may be used to perform any combination of one or more of steps described herein, including, for example, any complementary step or steps of one or more of the above steps.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the descriptions herein. Accordingly, the foregoing description is by way of example only, and is not limiting.

1. A method comprising:
receiving, by an internet of things (IoT) device, a reader to device (R2D) transmission comprising:
a reader timing acquisition signal transmission; and
a physical reader to device channel transmission;
determining, based on a clock acquisition part of the reader timing acquisition signal transmission, a number of chips per symbol for the physical reader to device channel transmission;
determining an amount of time after an end of the R2D transmission for a device to reader (D2R) transmission, wherein the determining is based on:
the number of chips per symbol for the physical reader to device channel transmission; and
whether a message type of the R2D transmission is a response message; and
transmitting the D2R transmission based on the determined amount of time after the end of the R2D transmission.

2. The method of claim 1, wherein the determining the amount of time further comprises determining, among a plurality of R2D time durations, a time duration.

3. The method of claim 1, wherein the R2D transmission indicates the D2R transmission.

4. The method of claim 1, further comprising determining the end of the R2D transmission based on a field of the R2D transmission, wherein the field indicates a size of the R2D transmission.

5. The method of claim 1, wherein the transmitting the D2R transmission further comprises transmitting a first chip of a preamble transmission of the D2R transmission at a time starting after the determined amount of time following the end of the R2D transmission.

6. The method of claim 2, wherein the transmitting the D2R transmission further comprises transmitting the D2R transmission at the determined time duration following the end of the R2D transmission.

7. The method of claim 1, wherein the R2D transmission comprises a postamble of the R2D transmission, and wherein the end of the R2D transmission comprises an end of the postamble.

8. The method of claim 1, wherein the clock acquisition part indicates the number of chips per symbol.

9. A method comprising:
determining, by an internet of things (IoT) device and based on a number of chips per symbol of a reader to device (R2D) transmission, an R2D time duration among a plurality of R2D time durations; and
transmitting a device to reader (D2R) transmission no earlier than the R2D time duration after an end of the R2D transmission.

10. The method of claim 9, further comprising:
receiving the R2D transmission, wherein the R2D transmission comprises:
a reader timing acquisition signal (R-TAS) transmission; and
a physical reader to device channel (PRDCH) transmission; and
determining, based on a clock acquisition part of the R-TAS transmission, the number of chips per symbol for the PRDCH transmission.

11. The method of claim 9, wherein the determining the R2D time duration is further based on whether a message type of the R2D transmission is a response message.

12. The method of claim 9, wherein the R2D transmission further comprises one or more padding chips, and wherein the R2D time duration is larger than, or equal to, an aggregate time duration of the one or more padding chips.

13. The method of claim 9, further comprising determining the end of the R2D transmission based on a field of the R2D transmission, and wherein the field indicates a size of the R2D transmission.

14. The method of claim 9, further comprising determining the end of the R2D transmission based on violation of a coding rule, wherein the coding rule is a Manchester coding rule.

15. The method of claim 9, further comprising receiving a message indicating the number of chips per symbol.

16. The method of claim 9, wherein the number of chips per symbol satisfies one or more of:
comprising a number of on-off keying (OOK) chips per symbol;
being a number of chips per orthogonal frequency division multiplexing (OFDM) symbol;
being based on a subcarrier spacing;
being based on a length of the symbol;
being based on a chip duration; or
being an M value.

17. A method comprising:
transmitting, by a computing device, a reader to device (R2D) transmission comprising:
a reader timing acquisition signal transmission; and
a physical reader to device channel transmission;
determining, based on a number of chips per symbol for the physical reader to device channel transmission, an amount of time after an end of the R2D transmission for a device to reader (D2R) transmission; and
receiving the D2R transmission based on the determined amount of time after the end of the R2D transmission.

18. The method of claim 17, further comprising monitoring for the D2R transmission based on the determined amount of time after the end of the R2D transmission.

19. The method of claim 17, wherein the end of the R2D transmission is an end of a last symbol of the R2D transmission.

20. The method of claim 17, further comprising transmitting an indication of a time offset, wherein the amount of time is based on the time offset.
